(19) United States
(12) Patent Application Publication
(10) Pub. No.: US 2010/0034097 A1
(43) Pub. Date: Feb. 11, 2010

(54) INFORMATION DISTRIBUTION APPARATUS AND COMMUNICATION SYSTEM

(75) Inventors: Daisuke Nitta, Kawasaki (JP); Tetsuo Tomita, Kawasaki (JP); Tomonori Kumagai, Kawasaki (JP); Yuki Shinada, Kawasaki (JP); Tatsuru Nakagaki, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/580,608

(22) Filed: Oct. 16, 2009

Related U.S. Application Data
(63) Continuation of application No. PCT/JP2007/073141, filed on Nov. 30, 2007.

(30) Foreign Application Priority Data
Apr. 16, 2007 (JP) PCT/JP2007/058282

(51) Int. Cl. H04L 12/26

(52) U.S. Cl. 370/241.1

(57) ABSTRACT

An information distribution apparatus which is connected to each of a plurality of communication systems for performing radio communication with a mobile terminal through a network by using each of a plurality of communication methods having a range in which available frequencies overlap and manages information on communication environments of the communication systems. The information distribution apparatus includes an OAM information collecting section for collecting OAM information from the communication systems, a database generating section for generating a database in which the communication environment information including the allocation state of a frequency band to each of the communication methods determined by using the OAM information and information on a variable frequency band and a fixed frequency band which are defined for each of the communication methods, and a distribution section for distributing the information included in the communication environment information to each of the communication systems.

### CROSS-REFERENCE TO RELATED APPLICATIONS

This is a continuation of Application PCT/JP2007/073141, filed on Nov. 30, 2007, now pending, the contents of which are herein wholly incorporated by reference.

### FIELD

The present invention relates to an information distribution apparatus that manages communication environment information for enabling preferable allocation of frequency bands among a plurality of communication methods having overlapping ranges in use frequency bands thereof.

### BACKGROUND

In recent years, various wireless systems, such as cell phones and wireless LANs, have become widespread, and therefore, there has been a fear of exhaustion of frequency resources. The trend is shifting toward more and more various wireless systems being mixed. In view of the exhaustion of frequency resources, a need is expected to arise for such an environment in which improvement in radio wave utilization efficiencies of wireless systems is needed.

Currently, attention has been given to a wireless communication technology called a cognitive radio technology. The cognitive radio technology, which is also referred to as a communication environment recognizing technology, is a technology for achieving the improvement in radio wave utilization efficiencies of the wireless systems by appropriately recognizing a surrounding radio wave utilization environment and flexibly selecting an optimal frequency band, radio channel bandwidth, modulation method, access method, and the like. The cognitive radio technology has been receiving attention as a technology that has a potential to become a core of new generation mobile communication systems.

In addition, in recent years, the technology for software-defined radio has been making progress, and devices capable of flexibly changing the frequency band, the modulation method, and the like are expected to emerge soon.

Though no actual implementation example of the cognitive radio technology exists so far, there are various kinds of research papers and the like suggesting a utilization method in which “a mobile terminal judges its surrounding radio wave environment by itself to select an appropriate frequency band”.

[Patent document 1] Japanese National Publication of International Patent Application No. JP 2005-523616

[Patent document 2] Japanese National Publication of International Patent Application No. JP 2006-515120

[Patent document 3] Japanese National Publication of International Patent Application No. JP 2005-512423

### SUMMARY

There are the following problems with a variety of the current wireless communication systems (communication methods), to which the cognitive radio technology is conceivably applied.

(1) Due to the status of traffic or occurrence of a fault/regulation etc., there is a case in which frequencies are not allocated efficiently. Originally, frequency bands are allocated to the respective communication systems in a fixed manner. Accordingly, it is impossible to change the allocation condition of frequencies according to the statuses of traffic of the respective communication systems. For example, even if the traffic of a given communication system is congested, it is impossible to allocate a frequency that is not originally allocated to that communication system. Further, it is also impossible to utilize the frequency band of a communication system that has become unavailable due to a regulation or a fault.

(2) With regard to frequency bands used for artificial satellites, airplanes, and public radio, there is a case in which the frequency bands are used in a limited manner in terms of time or location. Accordingly, at a location/time where the frequency band is not used, the frequency utilization efficiency is low on the whole, thus exhibiting inefficiency.

An embodiment of one aspect of the present invention is an information distribution apparatus that is connected, via a network, to each of a plurality of communication systems that perform wireless communication with a mobile terminal by using each of a plurality of communication methods having a ranges in which available frequency bands overlap and that manages communication environment information of the plurality of communication systems, the information distribution apparatus including: an OAM information collecting unit to collect operation, administration, and maintenance (OAM) information from the plurality of communication systems via the network; a database generating unit to generate a database storing therein the communication environment information including a frequency band allocation status of the each of the plurality of communication methods determined by using the OAM information collected by the OAM information collecting unit, and variable frequency band information and fixed frequency band information that are defined for the each of the plurality of communication methods; and a distribution unit to distribute information included in the communication environment information to the each of the plurality of communication systems.

An embodiment of one aspect of the present invention is a communication system that performs wireless communication with a mobile terminal by using at least one of a plurality of communication methods having a range in which available frequency bands overlap and that is connected, via a network, to an information distribution apparatus including a database generating unit to generate a database storing communication environment information regarding each of the plurality of communication methods and a distribution unit to distribute information included in the communication environment information, the communication system including: a hold unit to hold the information included in the communication environment information, which is distributed from the distribution unit of the information distribution apparatus; a distribution information generating unit to generate, when an information distribution request is received from the mobile terminal, distribution information corresponding to the information distribution request based on the information held by the hold unit; and an information transmitting unit to transmit the distribution information to the mobile terminal.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1A is a diagram illustrating a distribution view of frequency bands of communication methods applicable to a system according to the embodiment;

FIG. 1B is a diagram illustrating a distribution view of frequency bands after cognitive processing according to the embodiment;

FIG. 2 is a diagram illustrating an overall configuration example of a cognitive information distribution system according to the embodiment;

FIG. 3 is a diagram illustrating a processing block configuration example of a cognitive information management unit 200 illustrated in FIG. 2;

FIG. 4 is a diagram illustrating a processing block configuration example of each of communication systems 300 (communication methods) #1 to #n illustrated in FIG. 2.

FIG. 5 is a diagram illustrating a processing block configuration example of a mobile terminal illustrated in FIG. 2;

FIG. 6 is a diagram illustrating a processing block configuration example of a radio wave information providing unit illustrated in FIG. 2;

FIG. 7 is a sequence diagram illustrating processing of generating and transmitting information for generating a cognitive information table, which is performed in the cognitive information distribution system;

FIG. 8 is a table illustrating a data format example of OAM information transmitted from an OAM information transmitting unit 307;

FIG. 9 is a table illustrating a data format example of artificial-satellite-orbit-and-use-frequency-band information transmitted from an artificial satellite management unit 501;

FIG. 10 is a table illustrating a data format example of airplane-course-and-use-frequency-band information transmitted from an air traffic control unit 502;

FIG. 11 is a table illustrating a data format example of use-area-and-use-frequency-band information transmitted from a public radio management unit 503;

FIG. 12 is a table illustrating a data format example of variable frequency band information;

FIG. 13 is a table illustrating a data format example of fixed frequency band information;

FIG. 14 is a diagram illustrating a relation between frequency bands (Ka to Kb and K′a to K′b) in an example of frequency allocation calculation 1;

FIG. 15 is a diagram illustrating a relation between frequency bands adjusted through the frequency allocation calculation 1;

FIG. 16 is a flow chart illustrating an example of processing performed by a generating unit 209, which is related to the frequency allocation calculation 1;

FIG. 17 is a diagram illustrating a relation between frequency bands of a communication system and an artificial satellite (Ka to Kb and K′a to K′b) in an example of frequency allocation calculation 2;

FIG. 18 is a diagram illustrating a relation between main frequency bands adjusted through the frequency allocation calculation 2;

FIG. 19 is a flow chart illustrating a processing example of the cognitive information table generating unit, which is related to the frequency allocation calculation 2;

FIG. 20 is a table illustrating a data format example of a cognitive information table;

FIG. 21 is a sequence diagram illustrating an example of cognitive information table generation;

FIG. 22 is a flow chart illustrating an example of processing related to cognitive information generation;

FIG. 23 is a table illustrating a data format example of initial beacon information;

FIG. 24 is a table illustrating an example of an initial beacon to be transmitted toward the mobile terminal;

FIG. 25 is a sequence diagram illustrating an operational example of procedures related to initial beacon transmission;

FIG. 26 is a table illustrating a data format example of communication-method-and-frequency-band change information;

FIG. 27 is a sequence diagram illustrating an operational example of procedures related to changing of the frequency band and the like;

FIG. 28 is a table illustrating a data format example of a request list;

FIG. 29 is a table illustrating a data format example of a detailed list;

FIG. 30 is a sequence diagram illustrating an operational example related to transmission and reception of the request list and the detailed list;

FIG. 31 is a flow chart briefly illustrating two operation methods (method A and method B) operable on the mobile terminal;

FIG. 32 is a table illustrating an example of the initial beacon received by the mobile terminal 400;

FIG. 33 is a sequence diagram illustrating an operational example related to initial beacon reception performed by the mobile terminal;

FIG. 34 is a flow chart illustrating a procedural example of radio wave condition list generation that is carried out by a communication-method-and-frequency-band determining unit;

FIG. 35 is a table illustrating a data format example of a radio wave condition list indicating surrounding radio wave conditions listed by the communication-method-and-frequency-band determining unit;

FIG. 36 is a flow chart illustrating an example of processing of generating a priority list containing priorities (radio wave conditions), which is performed by the communication-method-and-frequency-band determining unit;

FIG. 37 is a table illustrating a data format example of the priority list;

FIG. 38 is a table illustrating an example of a terminal status;

FIG. 39 is a table illustrating an example of user action contents;

FIG. 40 is a flow chart illustrating an example of processing procedures of request list generation performed by a request list generating unit;

FIG. 41 is a table illustrating a data format example of the request list;

FIG. 42 is a table illustrating an example of the detailed list;

FIG. 43 is a flow chart illustrating an example of procedures of generating the priority list (processing of determining priorities (frequency and traffic)), which are executed by the communication-method-and-frequency-band determining unit;

FIG. 44 is a table illustrating a data format example of the priority list generated through the processing illustrated in FIG. 43;

FIG. 45 is a flow chart illustrating a processing example of the priority list generation performed by the communication-method-and-frequency-band determining unit based on the terminal status and the user action contents (service contents);

FIG. 46 is a table illustrating a data format example of the priority list that contains the priorities set based on remaining battery levels and the service contents;

FIG. 47 is a table illustrating a reference example for determining the communication method and frequency band, which is used by the communication-method-and-frequency-band determining unit in processing of determining the communication method and frequency band;

FIG. 48 is a sequence diagram illustrating an operational example related to an operation 6 of the mobile terminal;

FIG. 49 is a flow chart illustrating a processing example of a case in which the mobile terminal receives a service continuously;

FIG. 50 is a diagram illustrating a processing block configuration example of each of communication systems 300 (#1 to #n) according to a modification example;

FIG. 51 is a sequence diagram illustrating an “operation 6” of a cognitive information distribution system according to a first distribution type of this modification example;

FIG. 52 is a sequence diagram illustrating an “operation 5” of the cognitive information distribution system according to the first distribution type of this modification example;

FIG. 53 is a sequence diagram illustrating an “operation 5” of a cognitive information distribution system according to a second distribution type of this modification example;

FIG. 54 is a sequence diagram illustrating the “operation 5” of the cognitive information distribution system according to the second distribution type of this modification example; and

FIG. 55 is a sequence diagram illustrating the “operation 5” of the cognitive information distribution system according to the second distribution type of this modification example.

### DESCRIPTION OF EMBODIMENTS

Hereinbelow, referring to the drawings, description is given of the embodiment. The configuration of the embodiment is merely an example, and the present invention is not limited to the configuration of the embodiment.

### Outline of the Embodiment

According to the embodiment, there is generated a database that collectively manages, a large amount of radio wave utilization conditions ranging from a current condition to a future schedule. At the time of communication, a mobile terminal refers to the database to select a more appropriate frequency band. By employing this method, it becomes possible to manage the utilization conditions of artificial satellites and public radio (such as police radio), resulting in utilization of a broader frequency band.

Here, a cognitive radio technology originally means that “a mobile terminal judges its surrounding radio wave environment by itself to select an appropriate frequency band”. However, according to the embodiment, the current and future radio wave conditions around the terminal are transmitted as information (also referred to as communication environment information or cognitive information) to the terminal, to thereby enable the terminal to recognize and select a frequency.

In addition, the embodiment enables a hybrid system (a transmission of only information (such as a scheduled use frequency of an artificial satellite) impossible to recognize it) by also using the original cognitive radio technology.

The rough processes and operations of a system according to the embodiment of the embodiment are described in the following (I) and (II).

(I) Generation of information table (referred to as “cognitive information table”) desired for efficient allocation of frequencies and frequency band change of each communication system.

(1) From the communication systems controlling the respective communication methods, traffic information, fault information, and regulation information are acquired.

(2) Information regarding the frequencies and areas used by artificial satellites, airplanes, and public radio is acquired.

(3) Based on the information acquired in (1) and (2), an information table (cognitive information table) desired for the efficient allocation of frequencies and the frequency band change of a communication system is generated.

(4) Based on the information within the cognitive information table, each communication system changes the allocation of frequencies. Here, it is assumed that there are three types of frequency use, which are a fixed value, a variable value, and an initial beacon value (information containing frequencies that can be fixedly used by the mobile terminal in the respective communication methods in order to establish communication when the communication environment information is acquired).

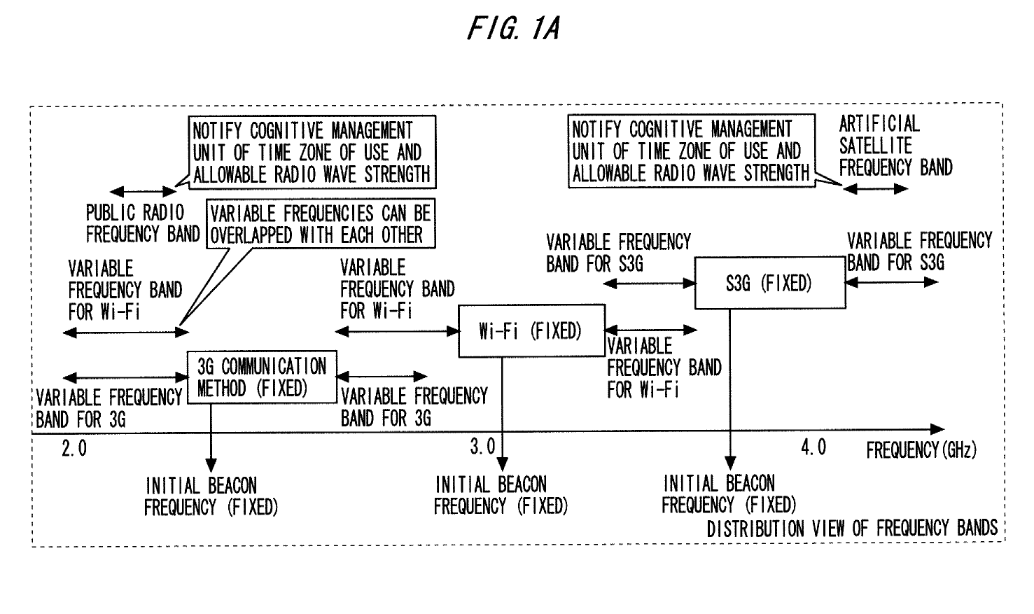

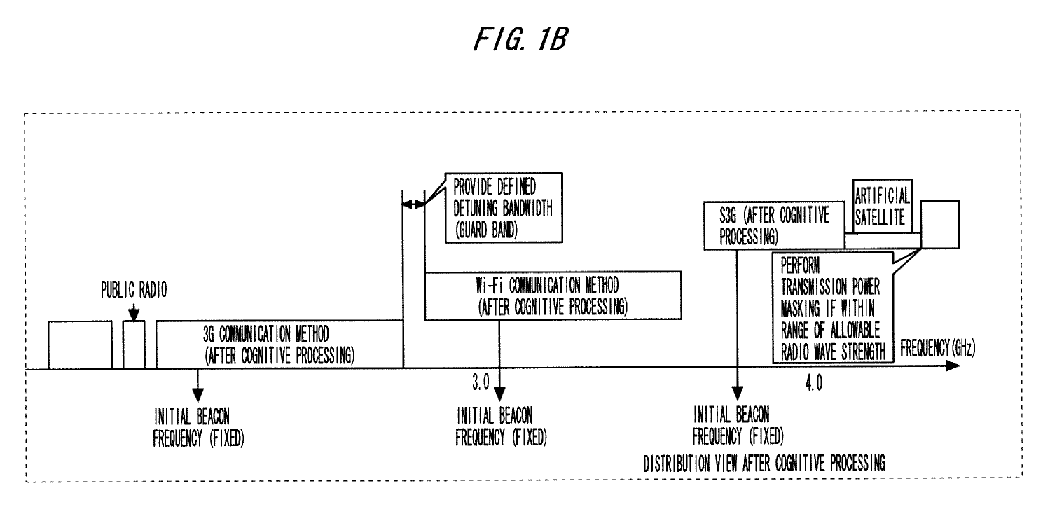

FIG. 1A is a diagram illustrating a distribution view of frequency bands that are defined by a plurality of communication methods applicable to the embodiment. FIG. 1B is a diagram illustrating a distribution view of frequency bands after cognitive processing (processing of allocating optimal frequencies to the respective communication methods based on the communication environment information of the respective communication methods) according to the embodiment.

In the example illustrated in FIG. 1A, as the communication methods, there are illustrated 3G, S3G, and wireless fidelity (Wi-Fi). Each of the communication methods has a fixed frequency band, a variable frequency band, and an initial beacon frequency (fixed). Further, in the example illustrated in FIG. 1A, the variable frequency bands of Wi-Fi and 3G overlap the use frequency band of the public radio, whereas the variable frequency band of S3G overlaps the usable frequencies of the artificial satellite.

According to the embodiment, the frequency allocation is performed based on the cognitive processing with respect to the distribution of frequency bands illustrated in FIG. 1A. As a result, as illustrated in FIG. 1B, each communication method can use an optimal frequency band, and also, it is possible to determine the use frequency band of each communication method so as not to overlap the use frequencies of the public radio or the artificial satellite.

(II) Information Acquisition by Mobile Terminal

The mobile terminal acquires basic information regarding frequencies from an initial beacon, and then acquires detailed cognitive information (communication environment information of each communication method). The procedures are as follows.

(1) The mobile terminal acquires the basic information from the initial beacon.

(2) Based on the basic information, the mobile terminal requests and acquires the detailed cognitive information.

(3) The mobile terminal compares the cognitive information with various information stored in the mobile terminal itself, and then determines a communication system to be used.

(4) The mobile terminal starts a communication by using the determined communication system.

In a cognitive information distribution system according to the embodiment, information on traffic, fault, regulation, and the like of the respective communication systems (communication methods) is collected and managed in an integrated manner. With this configuration, the frequency band to be used in each communication system can be optimized. For example, for a communication system that is suffering a fault or is under a maintenance regulation, the usable frequency band is made narrower, and other communication methods operating normally are allocated with broader frequency bands. In another case, when there is a communication system having a large amount of traffic, that communication system is allocated with a broader frequency band than the frequency bands of the other communication methods that have a less amount of traffic.

Further, according to the embodiment, in addition to the information described above, there is collected information on use radio bands of artificial satellites, airplanes, and public radio, on using areas thereof, and on passage of an artificial satellite or an airplane. With this configuration, it becomes possible to use such frequency bands that used to be unavailable for a mobile communication system, which therefore results in a further improvement in frequency utilization rate. For example, in an area where and at a time when no artificial satellite passes, the frequency band allocated to the artificial satellite can be made available for the mobile communication system.

[System Configuration]

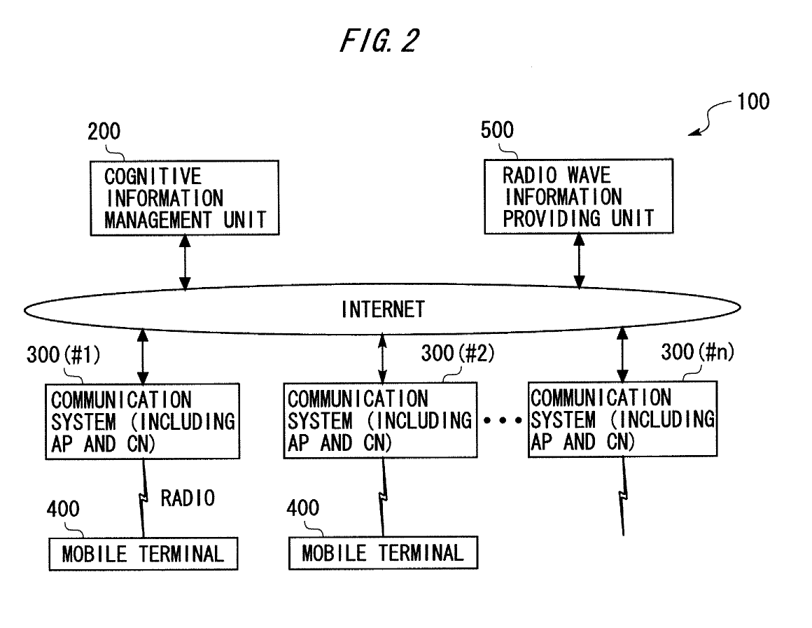

FIG. 2 is a diagram illustrating an overall configuration example of the cognitive information distribution system according to the embodiment. In FIG. 2, a cognitive information distribution system 100 is configured by four segments, which are a cognitive information management unit 200, a plurality of (n) communication systems (communication methods) 300 (#1 to #n), mobile terminals 400, and a radio wave information providing unit 500.

The cognitive information management unit 200, the communication systems 300, and the radio wave information providing unit 500 are connected to each other via the Internet. The communication system 300 is capable of communication with the mobile terminal 400 via a wireless link.

<Cognitive Information Management Unit>

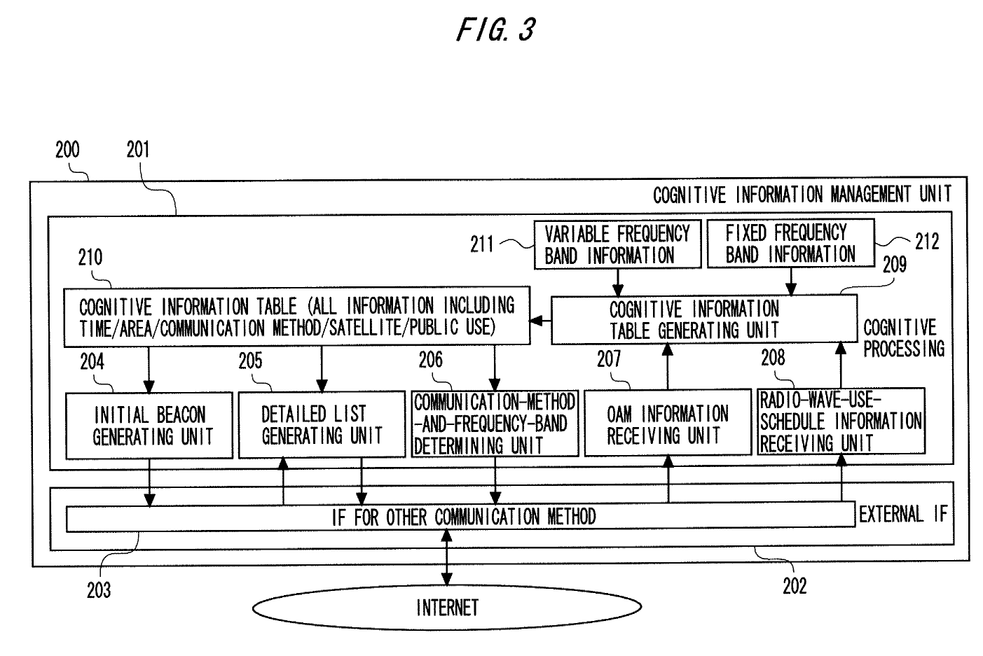

FIG. 3 is a diagram illustrating a processing block configuration example of the cognitive information management unit 200 illustrated in FIG. 2. The cognitive information management unit 200 receives operations, administration, and maintenance (OAM) information from each communication method, and receives the radio wave information from the radio wave information providing unit 500, to thereby generate a cognitive information table 210. Further, the cognitive information management unit 200 transmits, to each of the communication systems 300, an initial beacon and communication-method-and-frequency-band change information. Further, the cognitive information management unit 200 transmits a detailed list in response to a request from the mobile terminal. The cognitive information management unit 200 is implemented as a server device (cognitive information distribution apparatus) connected to the Internet.

The server device is an information processing device including a CPU (processor), a storage device (memory), an input-and-output device (I/O), and a communication IF. With the CPU executing a computer program stored in the storage device, a process as the cognitive information management unit 200 is executed.

The cognitive information management unit 200 includes an external interface (external IF) section 201 and a cognitive processing section 202. The external IF section 201 includes an interface-for-other-communication-method 203.

The cognitive processing section 202 includes an initial beacon generating unit 204, a detailed list generating unit 205, a communication-method-and-frequency-band determining unit 206, an OAM information receiving unit 207, a radio-wave-use-schedule information receiving unit 208, a cognitive information table generating unit 209, and the cognitive information table 210.

The IF-for-other-communication-method 203 controls an interface for performing, via an Internet network, communication with the communication systems 300 (#1 to #n), the mobile terminals 400, and the radio wave information providing unit 500.

The initial beacon generating unit 204 serving as a distribution unit generates, based on the contents stored in the cognitive information table 210, initial beacon information desired for the communication methods #1 to #n to perform transmission to the mobile terminals 400, and then, via the IF-for-other-communication-method 203, transmits the initial beacon information to the communication methods #1 to #n.

When a request (request list) for a detailed list desired for determining the communication method has been received from the mobile terminal 400, the detailed list generating unit 205 serving as a distribution unit generates a detailed list corresponding to the contents of the request list based on the cognitive information table 210, and then transmits the detailed list to the mobile terminal 400 via the IF-for-other-communication-method 203 and at least one of the communication methods #1 to #n.

In order to notify the communication methods #1 to #n of information on change in frequency bands, the communication-method-and-frequency-band determining unit 206 serving as a change information generating unit and a distribution unit uses the cognitive information table 210 to generate communication-method-and-frequency-band change information, and then transmits the communication-method-and-frequency-band change information to the communication methods #1 to #n.

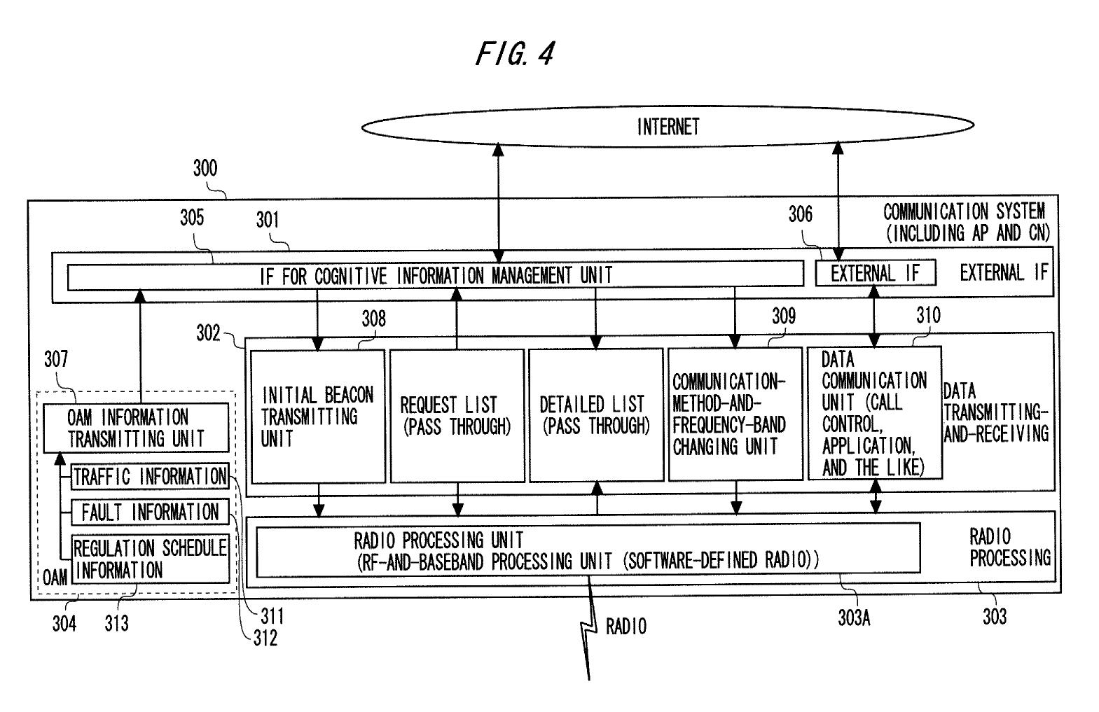

In order to acquire the OAM information from the communication methods #1 to #n, the OAM information receiving unit 207 serving as an OAM information collecting unit receives, via the IF-for-other-communication-method 203, the OAM information transmitted by an OAM information transmitting unit 307 (FIG. 4) of an OAM unit provided to each of the communication methods #1 to #n.

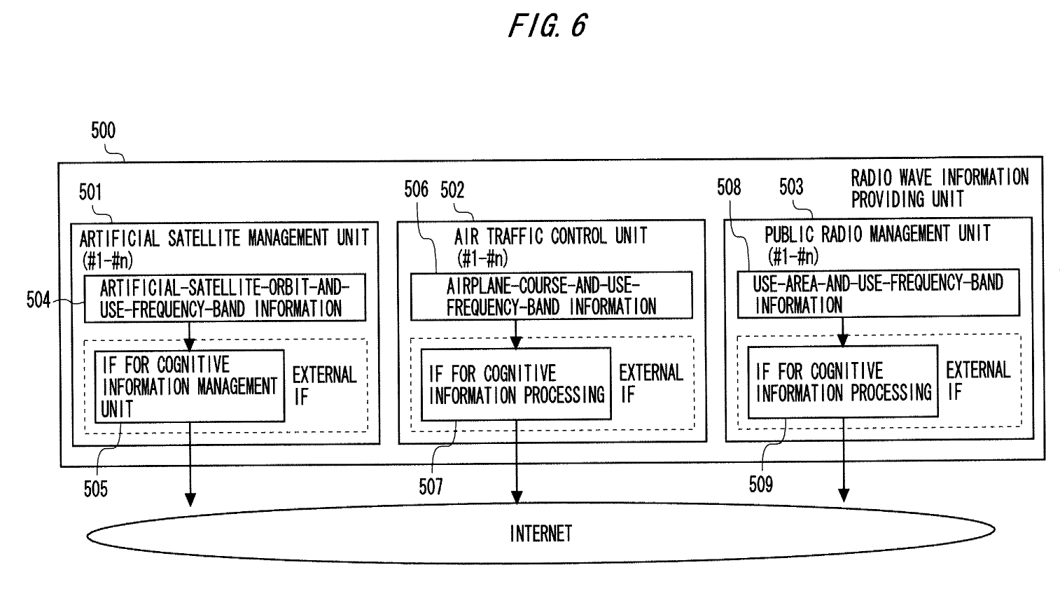

In order to collect the radio-wave-use-schedule information managed in respective management units 501, 502, and 503 (FIG. 6) configuring the radio wave information providing unit 500, the radio-wave-use-schedule information receiving unit 208 serving as a radio wave information collecting unit receives the radio-wave-use-schedule information via the IF-for-other-communication-method 203.

The cognitive information table generating unit 209 serving as a database generating unit and a reflecting unit generates the cognitive information table 210 (database) based on the OAM information received by the OAM information receiving unit 207, the radio-wave-use-schedule information received by the radio-wave-use-schedule information receiving unit 208, and a variable frequency information table 211 and a fixed frequency band information table 212 generated as data on a recording medium.

The cognitive information table 210 is generated in the storage device provided to the cognitive information management unit 200. The cognitive information table 210 is generated in order to provide the initial beacon information and the communication-method-and-frequency-band change information to the communication methods #1 to #n. Further, the cognitive information table 210 is generated in order to provide the detailed list to the mobile terminal 400.

The variable frequency band information table 211 is a table recorded with information on a frequency band that can be treated as a variable frequency band among frequency bands available for each of the communication methods #1 to #n.

The fixed frequency band information table 212 is a table recorded with information on a frequency band that is treated as a fixed frequency band among frequency bands available for each of the communication methods #1 to #n.

The OAM information is a collective term for the traffic information, the fault information, and the regulation schedule information managed in the OAM units of the communication methods #1 to #n. The OAM information is described later.

<Communication Method (Communication System)>

FIG. 4 is a diagram illustrating a processing block configuration example of each of the communication systems 300 (#1 to #n) illustrated in FIG. 2. The communication systems 300 represent infrastructures that process various communication methods such as S3G, WiMAX, 3G, 2G (PDC), PHS, and public wireless LAN. The communication systems 300 each function as a communication device or a communication system that controls processing on the network side in each communication method. For example, in a case where the communication method #1 is a communication system that handles 3G, a plurality of processes provided to the communication method #1 are executed on a radio network controller (RNC) and a base transceiver station (BTS).

Here, in FIG. 2, the communication system 300 (each of #1 to #n) is illustrated as a concept that includes an access point (AP) to the communication system 300 and a core network (CN) connecting between communication methods.

The communication system 300 performs processing of transmitting the OAM information to the cognitive information management unit 200, processing of transmitting the initial beacon to the mobile terminal 400, and other processing. In FIG. 4, the communication system 300 functions as a device including an external IF section 301, a data-transmitting-and-receiving section 302, a radio processing section 303, and an OAM section 304.

The external IF section 301 includes an IF-for-cognitive-information-management-unit 305 and an external IF 306. The IF-for-cognitive-information-management-unit 305 is an interface for performing, via the Internet network, communication with the IF for other communication method of the cognitive information management unit 200.

Further, the external IF 306 is an interface for performing transmission and reception of data related to call processing that corresponds to each communication method, U-PLANE data, an application, and the like. The external IF 306 is an interface for transmitting and receiving all data excluding data exchanged with the cognitive information management unit 200.

The data-transmitting-and-receiving section 302 includes an initial beacon transmitting unit 308, a communication-method-and-frequency-band changing unit 309, and a data communication unit 310. Further, the data-transmitting-and-receiving section 302 transfers, to the IF 305, a request list from a radio processing unit 303A (mobile terminal 400), and also relays, to the radio processing unit 303A, a detailed list from the IF 305 (cognitive information management unit 200).

Here, the initial beacon transmitting unit 308 transmits, to the radio processing unit 303A, the initial beacon information transmitted from the initial beacon generating unit 204 of the cognitive information management unit 200.

The communication-method-and-frequency-band changing unit 309 receives the communication-method-and-frequency-band change information from the communication-method-and-frequency-band determining unit 206 of the cognitive information management unit 200, and then carries out changing of a frequency band and an allowable radio wave strength for the radio processing unit 303A. The data communication unit 310 transmits/receives data such as data related to call processing that corresponds to each communication system 300, U-PLANE data, data related to an application, and the like.

The radio processing section 303 includes the radio processing unit (RF-and-baseband processing unit (software-defined radio)) 303A. The radio processing unit 303A is an air interface for the mobile terminal 400, and is capable of transmitting/receiving various data through wireless communication with the mobile terminal 400. Further, radio frequency (RF) processing, baseband processing, and the like performed by the radio processing unit 303A are implemented by the software-defined radio, and hence, according to an instruction determined by the communication-method-and-frequency-band changing unit 309, the radio processing unit 303A performs the changing of the frequency band and the allowable radio wave strength.

The OAM section (OAM information unit) 304 includes the OAM information transmitting unit 307. The OAM information transmitting unit 307 collects the traffic information, the fault information, the regulation schedule information, and the like corresponding to the communication method, and then, via the IF-for-cognitive-information-management-unit 305, transmits the traffic information, the fault information, the regulation schedule information, and the like to the OAM information receiving unit 207 of the cognitive information management unit 200.

The traffic information, the fault information, the regulation schedule information, and the like are stored in a table generated in the storage device provided to the communication system 300. In the example illustrated in FIG. 4, there are illustrated, as an example, a traffic information table 311 that stores the traffic information, a fault information table 312 that stores the fault information, and a regulation schedule information table 313 that stores the regulation schedule information.

Here, the table 311 is recorded with, as the traffic information, a measured value and/or a predicted value of a communication amount (number of users, band used by users) within the communication system 300. Further, the table 312 is recorded with, as the fault information, information on whether or not a fault (communication fault (link fault, device fault) etc.) has occurred (measured value) within the communication system 300. The table 313 is recorded with, as the regulation schedule information, information on whether or not there is any regulation (measured value or predicted value) within the communication system 300.

The OAM section 304 collects the OAM information regularly or irregularly to update the respective tables 311 to 313. The OAM information transmitting unit 307 is capable of transmitting the OAM information regularly or for each request made by the cognitive information management unit 200.

<Mobile Terminal>

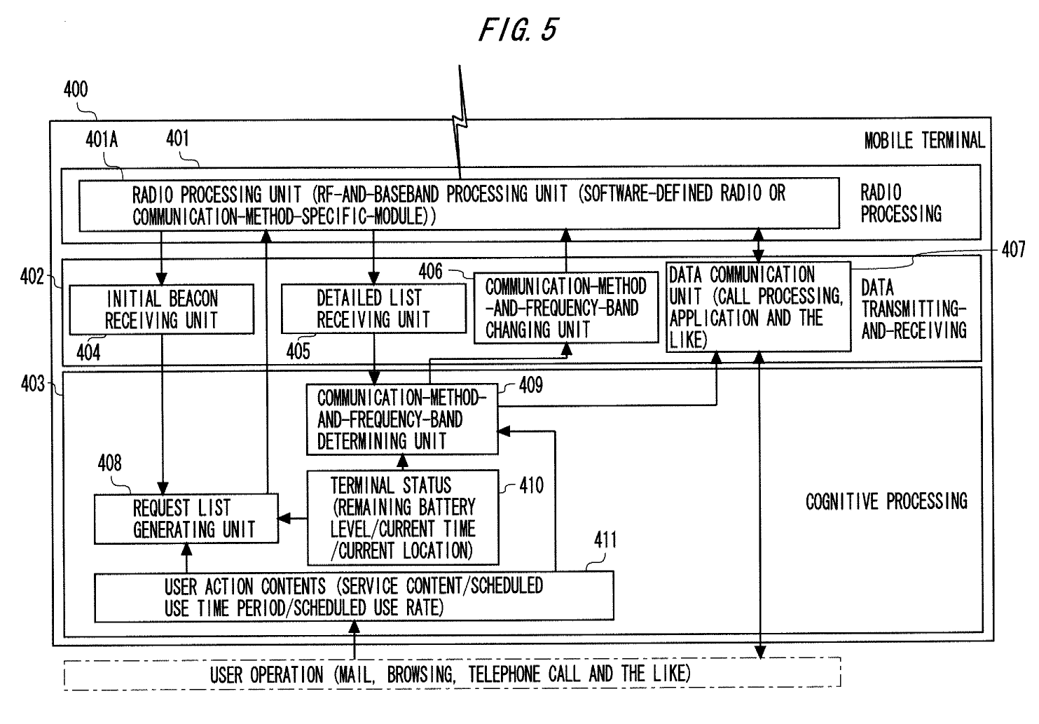

FIG. 5 is a diagram illustrating a processing block configuration example of the mobile terminal 400 illustrated in FIG. 2. In FIG. 5, the mobile terminal 400 is a terminal device capable of communication by using two or more of a plurality of the communication methods #1 to #n.

The mobile terminal 400 includes a radio processing section 401, a data-transmitting-and-receiving section 402, and a cognitive processing section 403, and implements communication with the communication system 300.

The radio processing section 401 includes a radio processing unit (RF-and-baseband processing unit (software-defined radio or communication method-specific module)) 401A.

The radio processing unit 401A is an air interface for the communication system 300, and is capable of transmitting/receiving various data through wireless communication with the communication system 300. Further, the RF processing, the baseband processing, and the like performed by the radio processing unit 401A are implemented by modules corresponding to the software-defined radio or the respective communication methods, and, according to an instruction from a communication-method-and-frequency-band changing unit 406, it is possible to change the frequency band and the allowable radio wave strength.

The data-transmitting-and-receiving section 402 includes an initial beacon receiving unit 404, a detailed list receiving unit 405, the communication-method-and-frequency-band changing unit 406, and a data communication unit 407.

The initial beacon receiving unit 404 receives the initial beacon transmitted from the initial beacon transmitting unit 308 of the communication system 300. Further, when an acquisition request for the initial beacon has been made by a request list generating unit 408, the initial beacon receiving unit 404 transfers, in response to the acquisition request, the initial beacon received by the radio processing unit 401A to the request list generating unit 408.

The detailed list receiving unit 405 receives the detailed list from the detailed list generating unit 205 (FIG. 3) of the cognitive information management unit 200, and then transmits the detailed list to a communication-method-and-frequency-band determining unit 409.

The data communication unit 407 transmits/receives various data, such as data related to call processing between the mobile terminal 400 and each of the communication systems 300, U-PLANE data, and data related to an application.

The cognitive processing section 403 includes the request list generating unit 408 and the communication-method-and-frequency-band determining unit 409. The request list generating unit 408 generates a request list that lists distribution requests for cognitive information, which are determined based on a terminal status 410 and user action contents 411, and then transmits the request list to the radio processing unit 401A. The request list is transmitted to the detailed list generating unit 205 of the cognitive information management unit 200.

The communication-method-and-frequency-band determining unit 409 determines the communication method and frequency band to be used by the mobile terminal 400 based on the detailed list transmitted from the detailed list receiving unit 405, the terminal status 410, and the user action contents 411. The determined communication method and frequency band are transmitted to the communication-method-and-frequency-band changing unit 409. Further, when it is determined to change the communication method, the communication-method-and-frequency-band determining unit 409 notifies the data communication unit 407 of the change contents of the communication method and frequency band.

The terminal status 410 is data in which a status related to the mobile terminal 400, such as a remaining battery level, a current time, and a current location of the mobile terminal 400, is described. The user action contents 411 are data in which actions (service contents, scheduled use time period, scheduled use rate, etc.) of the user are described, and generated through operational input made by the user on the mobile terminal 400. The terminal status 410 and the user action contents 411 are generated in the storage device provided to the mobile terminal 400.

<Radio Wave Information Providing Unit>

FIG. 6 is a diagram illustrating a processing block configuration example of the radio wave information providing unit 500 illustrated in FIG. 2. The radio wave information providing unit 500 includes n artificial satellite management units 501 (#1 to #n), n air traffic control units 502 (#1 to #n), and n public radio management units 503 (#1 to #n).

The artificial satellite management units 501 are servers that manage information acquired by an institution managing the orbits of artificial satellites, the radio wave use conditions thereof, etc. The air traffic control unit 502 is servers that manage information acquired by an institution managing the courses of airplanes, the radio wave use conditions thereof, etc. The public radio management units 503 are servers that manage information acquired by an institution managing the use location of the public radio and the radio wave use condition thereof.

Each of the artificial satellite management units 501, the air traffic control units 502, and the public radio management units 503 transmits (provides) a measured value and/or a predicted value of the radio wave use information managed therein to the cognitive information management unit 200 via the Internet.

Each of the artificial satellite management units 501 includes an IF-for-cognitive-information-management-unit 505 for transmitting artificial-satellite-orbit-and-use-frequency-band information 504 to the cognitive information management unit 200 via the Internet.

The artificial-satellite-orbit-and-use-frequency-band information 504 is data in which information on the orbit and the use frequency band of an artificial satellite that is under management of an artificial satellite management institution is recorded, and is stored in the storage device of the artificial satellite management unit 501.

Each of the air traffic control units 502 includes an IF-for-cognitive-information-management-unit 507 for transmitting airplane-course-and-use-frequency-band information 506 to the cognitive information management unit 200 via the Internet.

The airplane-course-and-use-frequency-band information 506 is data in which information on the course and the use frequency band of an airplane that is under management of an air traffic control institution is recorded, and is stored in the storage device of the air traffic control unit 502.

Each of the public radio management units 503 includes an IF-for-cognitive-information-management-unit 509 for transmitting use-area-and-use-frequency-band information 508 to the cognitive information management unit 200 via the Internet.

The use-area-and-use-frequency-band information 508 is data in which information on the using area and the use frequency band of public radio that is under management of a public radio management institution is recorded, and is stored in the storage device of the public radio management unit 503.

### Operational Example

### Processing Performed by Each Unit

Next, as an operational example (processing of each unit) of the cognitive information distribution system illustrated in FIG. 2, description is given of an operational example on the network side (cognitive information management unit 200, communication system 300, radio wave information providing unit 500) toward the mobile terminal 400. The operational example may be divided into the following five operations:

(operation 1) generation and transmission of information for generating a cognitive information table;

(operation 2) generation of a cognitive information table;

(operation 3) transmission of the initial beacon;

(operation 4) changing of the frequency band and the like based on the communication-method-and-frequency-band change information; and

(operation 5) provision of the detailed list to the mobile terminal.

Hereinbelow, description is given of details of the operations 1 to 5.

### Operation 1

### Generation and Transmission of Information for Generating Cognitive Information Table

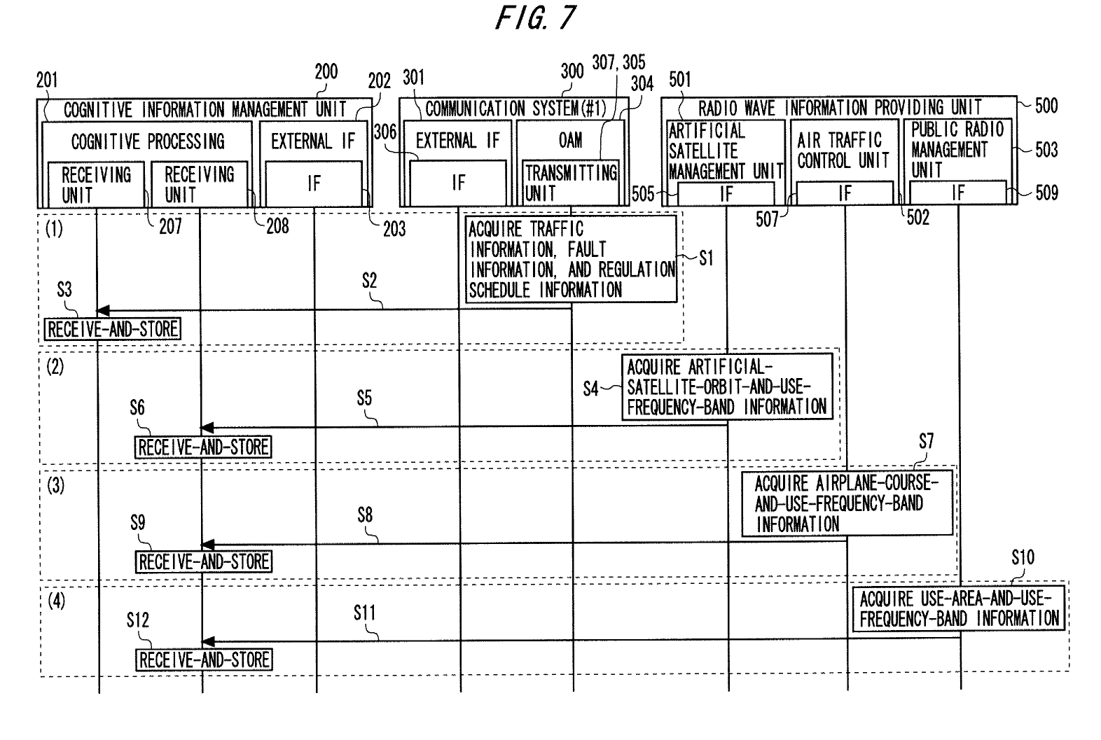

FIG. 7 is a sequence diagram illustrating processing of generating and transmitting information for generating a cognitive information table, which is performed in the cognitive information distribution system 100. In the processing, in order to generate the cognitive information table 210 (FIG. 3), the OAM information transmitting units 307 (FIGS. 2 and 4) of the communication systems 300 (#1 to #n) transmit the OAM information to the cognitive information management unit 200. Further, each of the artificial satellite management units 501, the air traffic control units 502, and the public radio management units 503 configuring the radio wave information providing unit 500 (FIG. 6) transmits information on the use frequency band thereof and the like to the cognitive information management unit 200. Details thereof are described in the following procedures (1) to (4).

(Procedure (1))

In each of the plurality of communication systems 300 (in FIG. 7, the communication method #1 is illustrated as an example), the OAM information transmitting unit 307 (FIG. 4) of the OAM section (OAM information unit) 304 acquires the traffic information, the fault information, and the regulation schedule information within the OAM information unit 304 (FIG. 7: S1), and then transmits the traffic information, the fault information, and the regulation schedule information to the OAM information receiving unit 207 (FIG. 3) of the cognitive information management unit 200 (FIG. 7: S2).

For the transmission of the OAM information, it is possible to make a selection between arbitrary time (timing) and regular time (timing: for example, once an hour) (in this example, regularly). The OAM information receiving unit 207 receives and stores the OAM information (FIG. 7: S3).

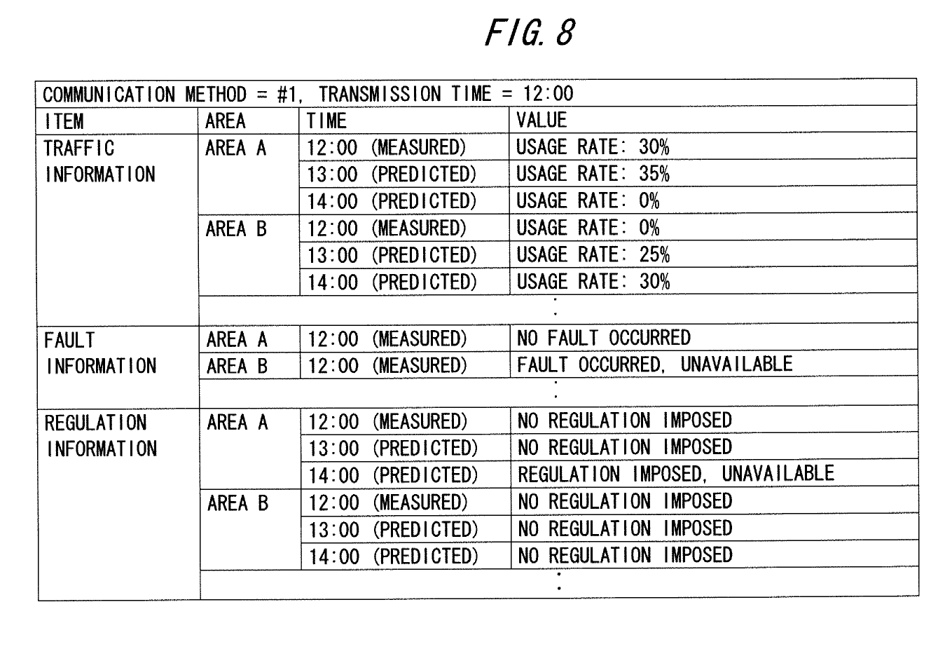

FIG. 8 is a table illustrating a data format example of the OAM information transmitted from the OAM information transmitting unit 307. In FIG. 8, there is illustrated the OAM information representing a case of the communication method #1 (for example, 3G), a transmission time of 12:00, and a prediction time of up to 14:00.

The OAM information contains the traffic information, the fault information, and the regulation information. The traffic information contains areas in which the communication method #1 can be used (areas A and B), and the measured value and the predicted value of the traffic usage rate at each time in each area.

Further, the fault information contains information indicating whether or not there is any fault occurrence in the areas A and B in which the communication method #1 can be used and whether or not the communication method can be used. Further, the regulation information contains the measured value and the predicted value that indicate, for each time, whether or not there is any regulation in each of the areas A and B.

(Procedure (2))

The artificial satellite management units 501 (#1 to #n: FIG. 6) of the radio wave information providing unit 500 acquire information on the orbits, the frequency bands of used radio waves, the requested detuning bandwidths (gaps), and the allowable radio wave strengths of the artificial satellites managed by the artificial satellite management unit 501 (FIG. 7: S4), and then transmits, as the artificial-satellite-orbit-and-use-frequency-band information, the acquired information to the radio-wave-use-schedule information receiving unit 208 of the cognitive information management unit 200 (FIG. 7: S5). For the transmission timing, it is possible to make a selection between arbitrary time (timing) and regular time (timing: for example, once an hour) (in this example, regularly). The radio-wave-use-schedule information receiving unit 208 receives and stores the artificial-satellite-orbit-and-use-frequency-band information (FIG. 7: S6).

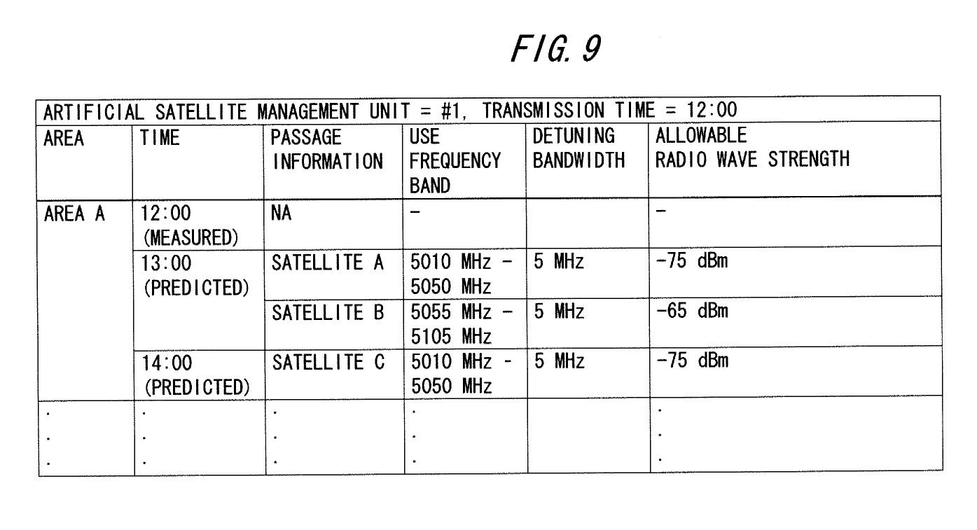

FIG. 9 is a table illustrating a data format example of the artificial-satellite-orbit-and-use-frequency-band information transmitted from the artificial satellite management unit 501. In FIG. 9, there is illustrated the artificial-satellite-orbit-and-use-frequency-band information representing a case of the artificial satellite management unit #1 as a transmission source, a transmission time of 12:00, and a prediction time of up to 14:00.

In the example illustrated in FIG. 9, the artificial-satellite-orbit-and-use-frequency-band information contains, for each of three time (time are expressed by the hour) with regard to one or more areas over which an artificial satellite managed by the artificial satellite management unit 501 of the transmission source passes, an identifier, a use frequency band, a detuning bandwidth, and an allowable radio wave strength of the artificial satellite passing in the sky.

(Procedure (3))

The air traffic control units 502 (#1 to #n) of the radio wave information providing unit 500 acquire information on the courses, the frequency bands of used radio waves, the requested detuning bandwidths (gaps), and the allowable radio wave strengths of the airplanes managed by the air traffic control unit 502 (FIG. 7: S7), and then transmits, as the airplane-course-and-use-frequency-band information, the acquired information to the radio-wave-use-schedule information receiving unit 208 of the cognitive information management unit 200 (FIG. 7: S8). For the transmission time (timing), it is possible to make a selection between arbitrary timing and regular timing (for example, once an hour) (in this example, regularly). The radio-wave-use-schedule information receiving unit 208 receives and stores the airplane-course-and-use-frequency-band information (FIG. 7: S9).

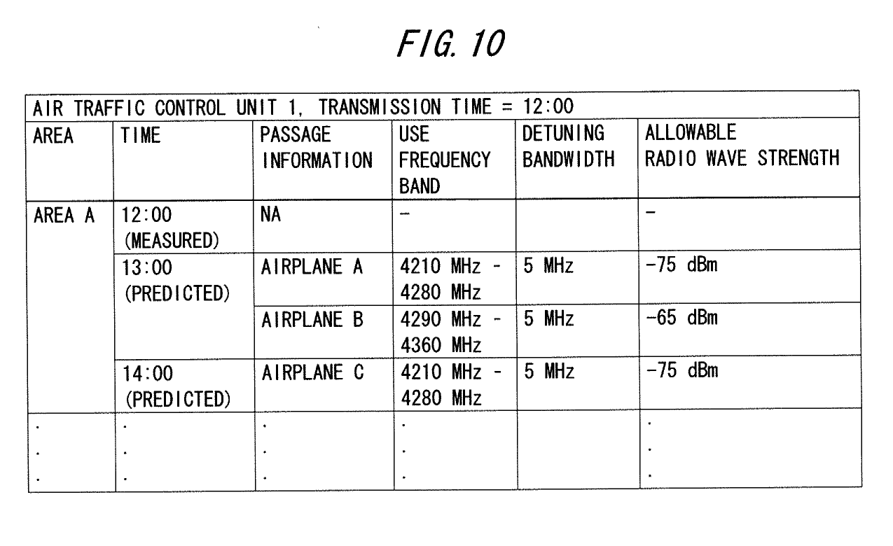

FIG. 10 is a table illustrating a data format example of the airplane-course-and-use-frequency-band information transmitted from the air traffic control unit 502. In FIG. 10, there is illustrated the airplane-course-and-use-frequency-band information representing a case of the air traffic control unit #1 as a transmission source, a transmission time of 12:00, and a prediction time of up to 14:00 (time are expressed by the hour).

As illustrated in FIG. 10, the parameters contained in the airplane-course-and-use-frequency-band information are similar to those of the artificial-satellite-orbit-and-use-frequency-information (FIG. 9) except for the identification information of the airplane.

(Procedure (4))

The public radio management units 503 (#1 to #n) of the radio wave information providing unit 500 acquire information on the areas, the frequency bands of used radio waves, the requested detuning bandwidths (gaps), and the allowable radio wave strengths of the public radio managed by the public radio management unit 503 (FIG. 7: S10), and then transmits, as the use-area-and-use-frequency-band information, the acquired information to the radio-wave-use-schedule information receiving unit 208 of the cognitive information management unit 200 (FIG. 7: S11). For the transmission time (transmission timing), it is possible to make a selection between arbitrary timing and regular timing (for example, once an hour) (in this example, regularly). The radio-wave-use-schedule information receiving unit 208 receives and stores the use-area-and-use-frequency-band information (FIG. 7: S12).

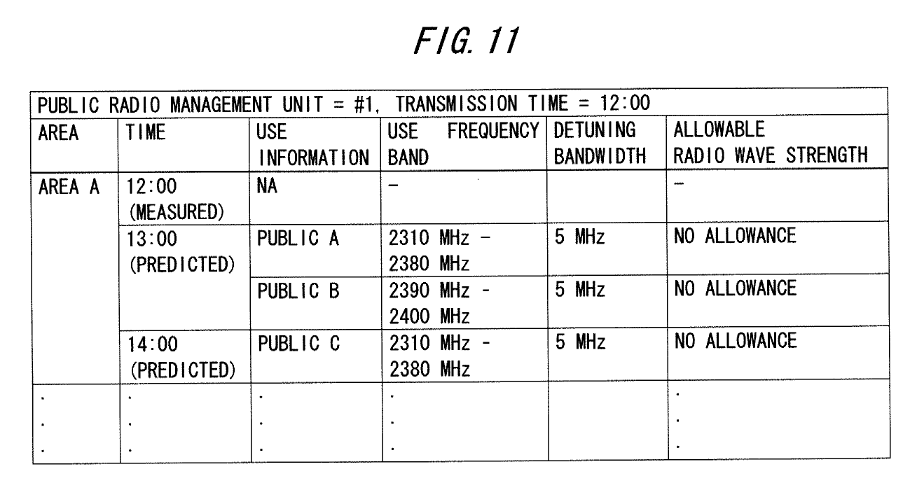

FIG. 11 is a table illustrating a data format example of the use-area-and-use-frequency-band information transmitted from the public radio management unit 503. In FIG. 11, there is illustrated the use-area-and-use-frequency-band information representing a case of the public radio management unit #1 as a transmission source, a transmission time of 12:00, and a prediction time of up to 14:00 (time are expressed by the hour).

As illustrated in FIG. 11, the parameters contained in the use-area-and-use-frequency-band information are similar to those of the artificial-satellite-orbit-and-use-frequency-information (FIG. 9) except for the use information (identifier of public radio).

### Operation 2

### Generation of Cognitive Information Table

The cognitive information table generating unit 209 (FIG. 3) of the cognitive information management unit 200 generates the cognitive information table 210 by using the information stored in the OAM information receiving unit 207 and the radio-wave-use-schedule information receiving unit 208, and the variable frequency band information and the fixed frequency band information previously stored in the tables 211 and 212. Specific processing is described in the following procedures (1) and (2).

(Procedure (1))

The cognitive information table generating unit 209 of the cognitive information management unit 200 acquires the artificial-satellite-orbit-and-use-frequency-band information, the airplane-course-and-use-frequency-band information, and the use-area-and-use-frequency-band information stored in the OAM information receiving unit 207 and the radio-wave-use-schedule information receiving unit 208, and the variable frequency band information and the fixed frequency band information previously stored in the tables 211 and 212. The acquisition time (timing) may be set arbitrarily or regularly. For example, the acquisition timing is set to occur once an hour.

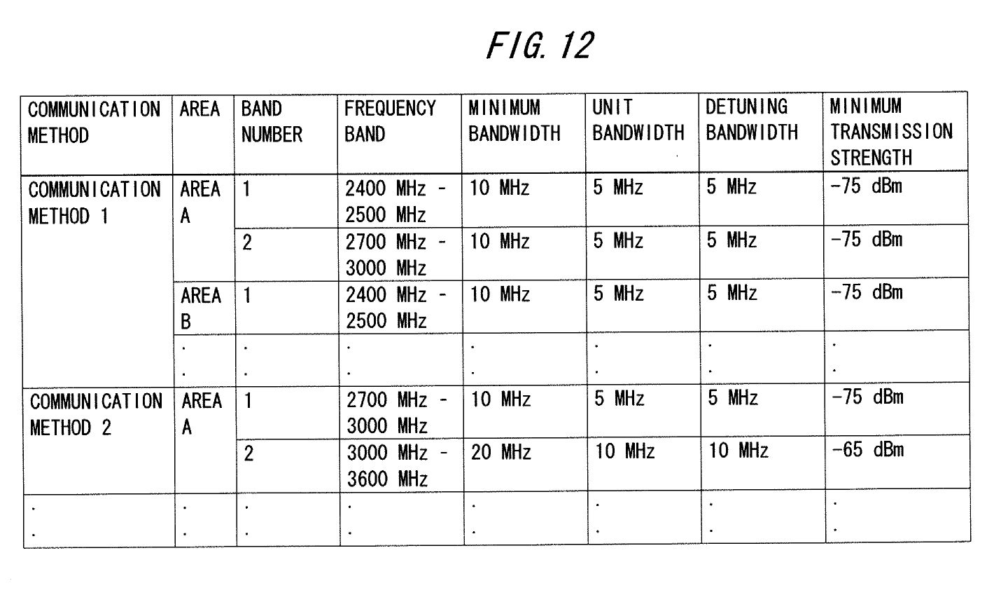

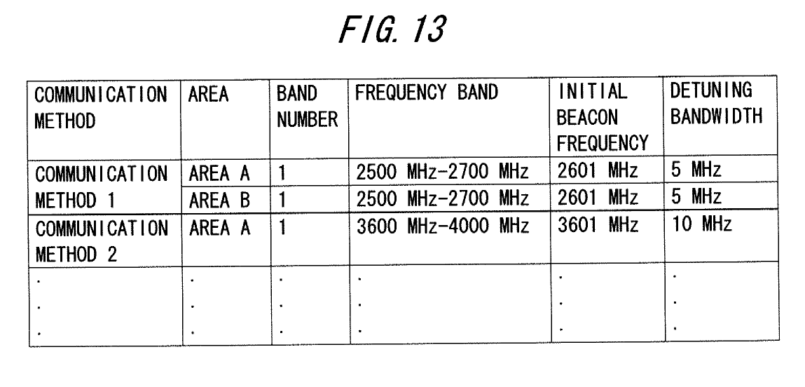

FIG. 12 is a table illustrating a data format example of the variable frequency band information (table 211), whereas FIG. 13 is a table illustrating a data format example of the fixed frequency band information (table 212).

As illustrated in FIG. 12, in the table 211, as the variable frequency band information for each of the communication methods #1 to #n, there is stored information indicating an available area, a band number, a frequency band corresponding to the band number, a minimum bandwidth, a unit bandwidth, a detuning bandwidth, and a minimum transmission strength.

Further, as illustrated in FIG. 13, in the table 212, as the fixed frequency band information for each of the communication methods #1 to #n, there is stored information indicating an available area, a band number, a frequency band corresponding to the band number, an initial beacon frequency, and a detuning bandwidth.

(Procedure (2))

The cognitive information table generating unit 209 of the cognitive information management unit 200 uses the data acquired in the procedure (1) described above to generate the cognitive information table 210. The generation time may be set arbitrarily or regularly. For example, a configuration in which the table 210 is generated once an hour may be employed.

An example of the procedures in which the cognitive information table 210 is generated by the cognitive information table generating unit 209 is described in the following steps <1> to <15>.

<1> First, the cognitive information table generating unit 209 generates an empty cognitive information table 210.

<2> Next, the cognitive information table generating unit 209 reads information on an initial time and an initial area of one of the plurality of communication methods (for example, communication method #1).

<3> Next, the cognitive information table generating unit 209 applies (writes) values of the fixed frequency band information to the cognitive information table 210.

<4> Next, the cognitive information table generating unit 209 applies (writes) values of the OAM information to the cognitive information table 210.

<5> In the step <4>, when the OAM information contains the fault information or the regulation information regarding the communication method in processing (communication method #1), the cognitive information table generating unit 209 generates the table 210 such that the communication method #1 is not allocated with a variable frequency band.

<6> Next, the cognitive information table generating unit 209 applies (writes) values of the variable frequency band information to the cognitive information table 210.

<7> The cognitive information table generating unit 209 carries out the processing of the steps <1> to <6> for all of the other communication methods #2 to #n.

<8> After the processing of the step <7> is finished, when there is a portion in which the frequency bands overlap each other among the communication methods, the cognitive information table generating unit 209 compares the values of the traffic information (contained in the OAM information) between the communication methods having the overlapping portion, and then allocates a broader frequency band to the communication method having the higher traffic usage rate.

On this occasion, the cognitive information table generating unit 209 performs such allocation that is compliant with a range defined by the minimum bandwidth, the unit bandwidth, and the detuning bandwidth (FIG. 12) previously stored in the table 211. When there occurs a surplus of band, the cognitive information table generating unit 209 treats the surplus band as the detuning bandwidth. The calculation related to such allocation is defined as “frequency allocation calculation 1”. The details of the frequency allocation calculation 1 are described later.

<9> The cognitive information table generating unit 209 checks whether or not the frequency band used in the artificial-satellite-orbit-and-use-frequency-band information is used in the cognitive information table 210.

<10> When it is judged in the step <9> that the frequency band is used, the cognitive information table generating unit 209 compares the minimum transmission strength (FIG. 12) and the allowable radio wave strength (FIG. 9) with regard to the portion in which the frequency bands overlap each other.

On this occasion, in a case of “minimum transmission strength<allowable radio wave strength”, the cognitive information table generating unit 209 enters the value of that allowable radio wave strength as the allowable radio wave strength of the cognitive information table 210.

On the other hand, in a case of “minimum transmission strength>allowable radio wave strength”, the cognitive information table generating unit 209 deletes the frequency band from the cognitive information table 210.

On this occasion, the cognitive information table generating unit 209 performs such allocation that is compliant with a range previously defined with regard to the values of the minimum bandwidth, the unit bandwidth, and the detuning bandwidth. The calculation related to such allocation is defined as “frequency allocation calculation 2”. The details of the frequency allocation calculation 2 are described later.

<11> Next, the cognitive information table generating unit 209 checks whether or not the frequency band used in the airplane-course-and-use-frequency-band information is used in the cognitive information table 210.

<12> When it is judged in the step <11> that the frequency band is used, the cognitive information table generating unit 209 compares the minimum transmission strength (FIG. 12) and the allowable radio wave strength (FIG. 10) with regard to the portion of overlapping.

On this occasion, in a case of “minimum transmission strength<allowable radio wave strength”, the cognitive information table generating unit 209 enters the value of that allowable radio wave strength as the allowable radio wave strength of the cognitive information table 210. On the other hand, in a case of “minimum transmission strength>allowable radio wave strength”, the cognitive information table generating unit 209 deletes the frequency band from the cognitive information table 210. On this occasion, the cognitive information table generating unit 209 performs such allocation in a previously defined range that is compliant with the values of the minimum bandwidth, the unit bandwidth, and the detuning bandwidth (frequency allocation calculation 2).

<13> Next, the cognitive information table generating unit 209 checks whether or not the frequency band used in the use-area-and-use-frequency-band information is used in the cognitive information table 210.

<14> When it is judged in the step <13> that the frequency band is used, the cognitive information table generating unit 209 compares the minimum transmission strength (FIG. 12) and the allowable radio wave strength (FIG. 11) with regard to the portion of overlapping.

On this occasion, in a case of “minimum transmission strength<allowable radio wave strength”, the cognitive information table generating unit 209 enters the value of that allowable radio wave strength as the allowable radio wave strength of the cognitive information table 210.

On the other hand, in a case of “minimum transmission strength>allowable radio wave strength”, the cognitive information table generating unit 209 deletes the frequency band from the cognitive information table 210.

On this occasion, the cognitive information table generating unit 209 performs such allocation in a previously defined range that is compliant with the values of the minimum bandwidth, the unit bandwidth, and the detuning bandwidth (frequency allocation calculation 2).

<15> The cognitive information table generating unit 209 performs the processing of <2> to <14> described above for each area and each time (time point).

<<Details of Frequency Allocation Calculation 1>>

The frequency allocation calculation 1 is calculation performed in a case where two or more frequency bands overlap each other. As an example, description is given of a calculation method used in a case where the frequency bands of two different communication methods (communication methods A and B) overlap each other.

For example, parameters of the communication method A are defined as follows:

variable frequency band: Ka to Kb (Hz);

minimum bandwidth: S (Hz);

unit bandwidth: T (Hz);

detuning bandwidth: R (Hz); and

traffic usage rate: F (%).

Further, parameters of the communication method B are defined as follows:

variable frequency band: K′a to K′b (Hz);

minimum bandwidth: S′ (Hz);

unit bandwidth: T′ (Hz);

detuning bandwidth: R′ (Hz); and

traffic usage rate: F′ (%).

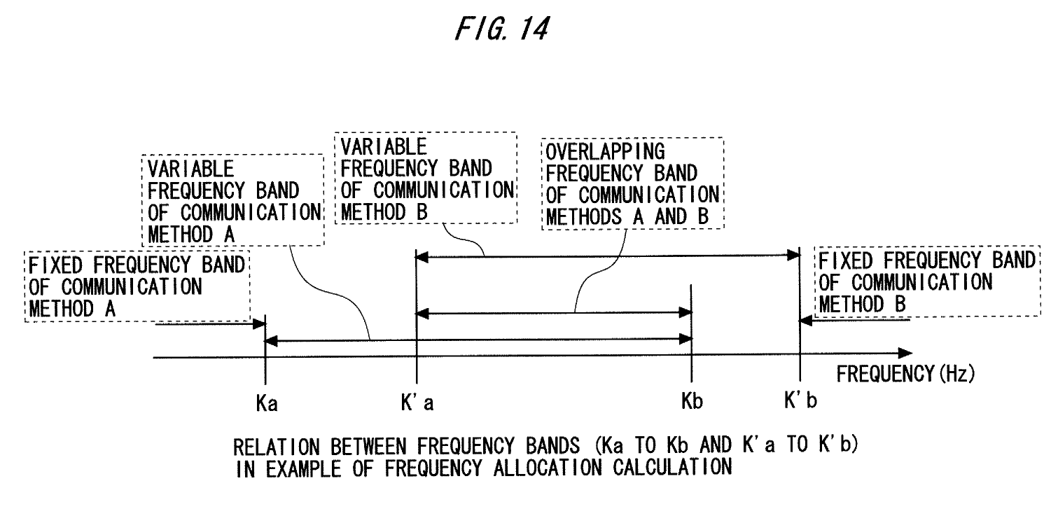

The relation between the frequency bands (Ka to Kb and K′a to K′b) is assumed to have such a relation as illustrated in FIG. 14. In the example illustrated in FIG. 14, the overlapping frequency band is Kb−K′a. Here, a definition of Kb−K′a=I is given.

A detuning bandwidth to be used here is R in a case of R>R′, and R′ in a case of R<R′. Further, in a case of R=R′, R is defined as the detuning bandwidth. In this example, the detuning bandwidth is set to R.

In the frequency allocation calculation 1, a communication method having the higher traffic usage rate is allocated with a broader frequency band. Thus, after the detuning bandwidth is secured from the overlapping frequencies, by using the ratios of the respective traffic usage rates, the respective frequency bands are set as follows.

Frequency band of communication method A: (I−R)*F/(F+F′)

Frequency band of communication method B: (I−R)*F′/(F+F′)

On this occasion, (I−R)*F/(F+F′)>S and (I−R)*F′/(F+F′)>S′ need to be satisfied as the requirements.

Further, the frequency band is expressed by “minimum band+integral multiple of unit band”, and hence, by defining ((I−R)*F/(F+F′)−S)÷T as an integer J, the end point of the variable frequency band of the communication method A is expressed by K′a+S+JT.

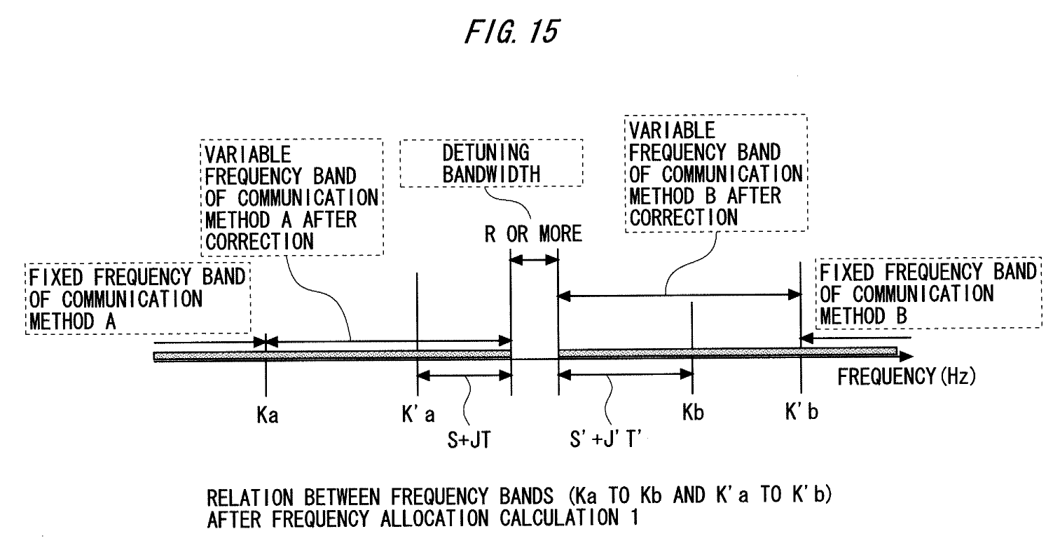

Similarly, with regard to the communication method B, by defining ((I−R)*F/(F+F′)−S′)÷T′ as an integer J′, the start point of the variable frequency band of the communication method B is expressed by Kb−(S′+J′T′). Accordingly, the respective frequency bands of the communication methods A and B can be illustrated as in FIG. 15.

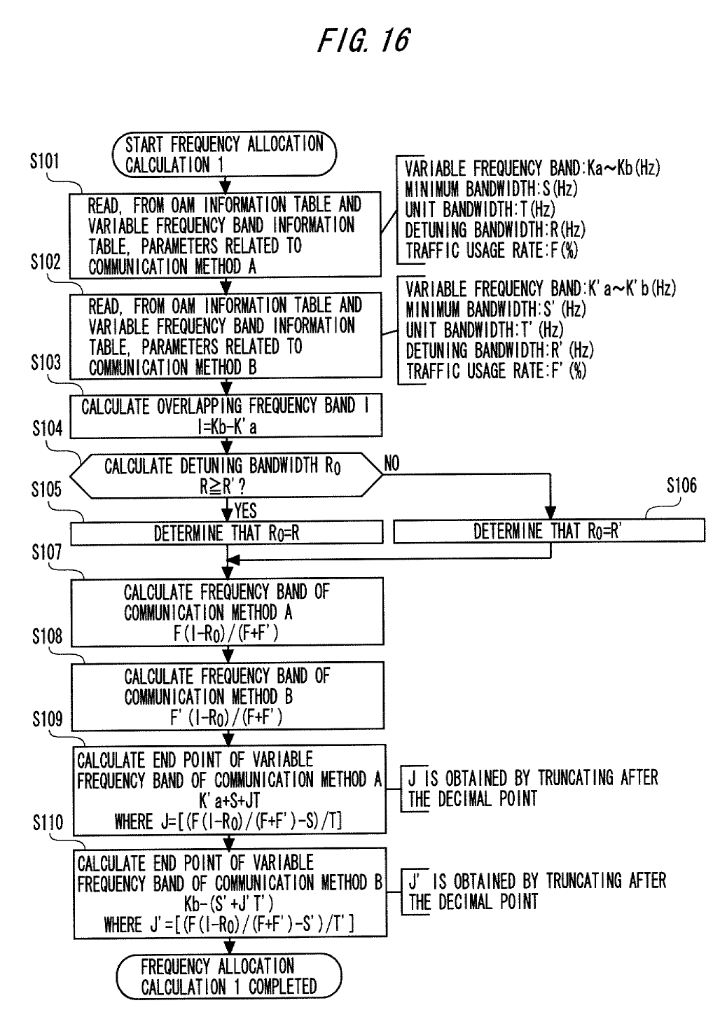

FIG. 16 is a flow chart illustrating an example of processing performed by the cognitive information table generating unit 209, which is related to the frequency allocation calculation 1. In FIG. 16, when the frequency allocation calculation 1 is started, first, the cognitive information table generating unit 209 reads parameters related to the communication method A from the OAM information table (OAM information stored in the receiving unit 207) and the variable frequency band information table 211 (Step S101).

Next, the cognitive information table generating unit 209 reads parameters related to the communication method B from the OAM information table and the variable frequency band information table 211 (Step S102).

Next, the cognitive information table generating unit 209 calculates the overlapping frequency band I of the communication methods A and B (I=Kb−K′a) (Step S103).

Next, the cognitive information table generating unit 209 calculates a detuning bandwidth R0 to judge whether or not R≧R′ (Step S104). On this occasion, when R≧R′ is satisfied (S104: YES), the cognitive information table generating unit 209 determines that R0=R (Step S105). On the other hand, when R≧R′ is not satisfied (S104: NO), the cognitive information table generating unit 209 determines that R0=R′ (Step S106).

Next, the cognitive information table generating unit 209 calculates F(I−R0)/(F+F′) as the frequency band of the communication method A (Step S107). Subsequently, the cognitive information table generating unit 209 calculates F′(I−R0)/(F+F′) as the frequency band of the communication method B (Step S108).

Next, the cognitive information table generating unit 209 calculates K′a+S+JT (where J=[F(I−R0)/(F+F′)−S/T] and J is obtained by truncating after the decimal point) as the end point of the variable frequency band of the communication method A (Step S109).

Next, the cognitive information table generating unit 209 calculates Kb−(S′+J′T′) (where J′=[(F(I−R0)/(F+F′)−S′)/T′] and J′ is obtained by truncating after the decimal point) as the end point of the variable frequency band of the communication method B (Step S110), and finishes the frequency allocation calculation 1.

<<Details of Frequency Allocation Calculation 2>>

The frequency allocation calculation 2 is a calculation method used in a case where the use frequency bands of the artificial satellite, the airplane, and the public radio overlap the frequency band of a given communication method, resulting in the necessity to delete the frequency band on the communication method side.

As an example, description is given of a calculation example used when the frequencies of the artificial satellite (may be airplane or public radio) overlap the frequency band of one of the communication methods (communication method A).

Parameters of the communication method A are defined as follows:

variable frequency band: Ka to Kb (Hz);

minimum bandwidth: S (Hz);

unit bandwidth: T (Hz); and

detuning bandwidth: R (Hz).

Parameters related to the artificial satellite are defined as follows:

use frequency band: K′a to K′b (Hz); and

detuning bandwidth: R′ (Hz).

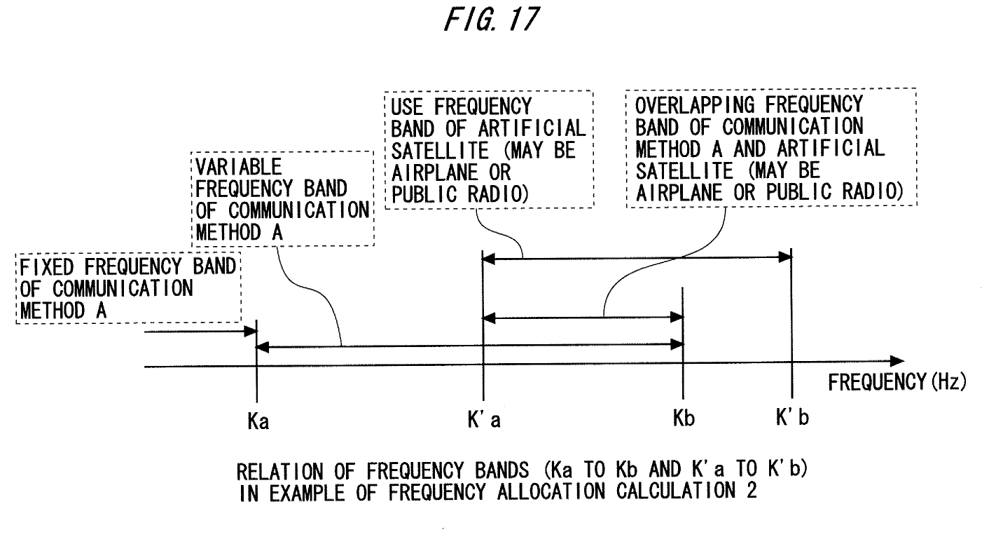

The relation of the frequencies between the communication method A and the artificial satellite (Ka to Kb and K′a to K′b) is assumed to be as illustrated in FIG. 17. In this case, in consideration of a desired detuning bandwidth R, the frequency band available for the communication method A is K′a−Ka−R. On this occasion, it is assumed that K′a−Ka−R=L. The detuning bandwidth is R in the case of R>R′, and R′ in the case of R<R′. Further, in the case of R=R′, R is defined as the detuning bandwidth. Here, the detuning bandwidth is set to R.

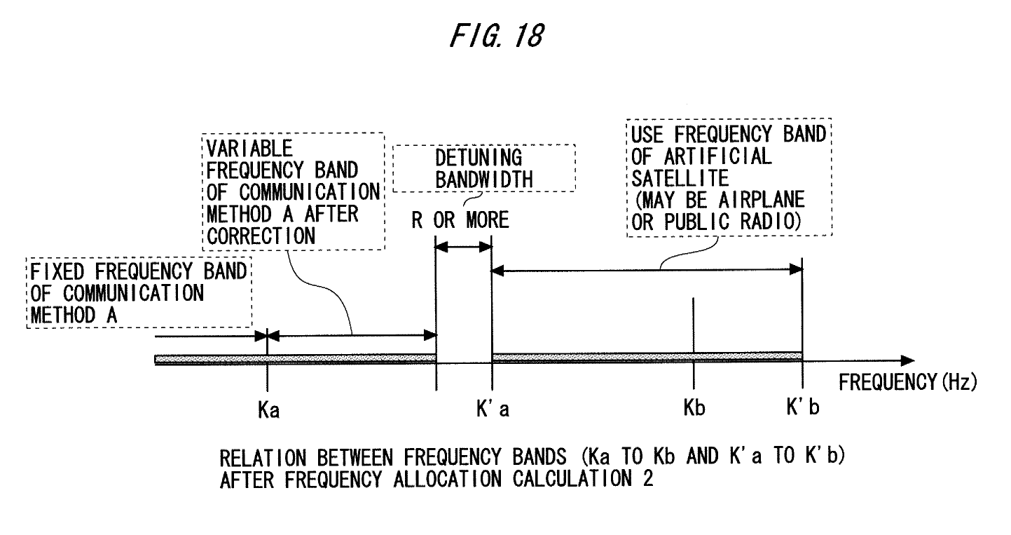

In this case, there is a need to take into account the minimum bandwidth and the unit bandwidth of the communication method A and the detuning bandwidth between the communication method A and the artificial satellite. Accordingly, “L>S” needs to be satisfied as the requirement. Further, in this case, “(L−S)÷T” is defined as an integer M. The end point of the variable frequency band of the communication method A in this case is expressed as “Ka+S+MT”. Thus, the respective frequency bands of the communication method A and the artificial satellite can be illustrated as in FIG. 18.

As described above, the frequency allocation calculation 2 is also applicable to a case in which the use frequency band of the airplane or the use frequency band of the public radio overlaps the use frequency band of a given communication method.

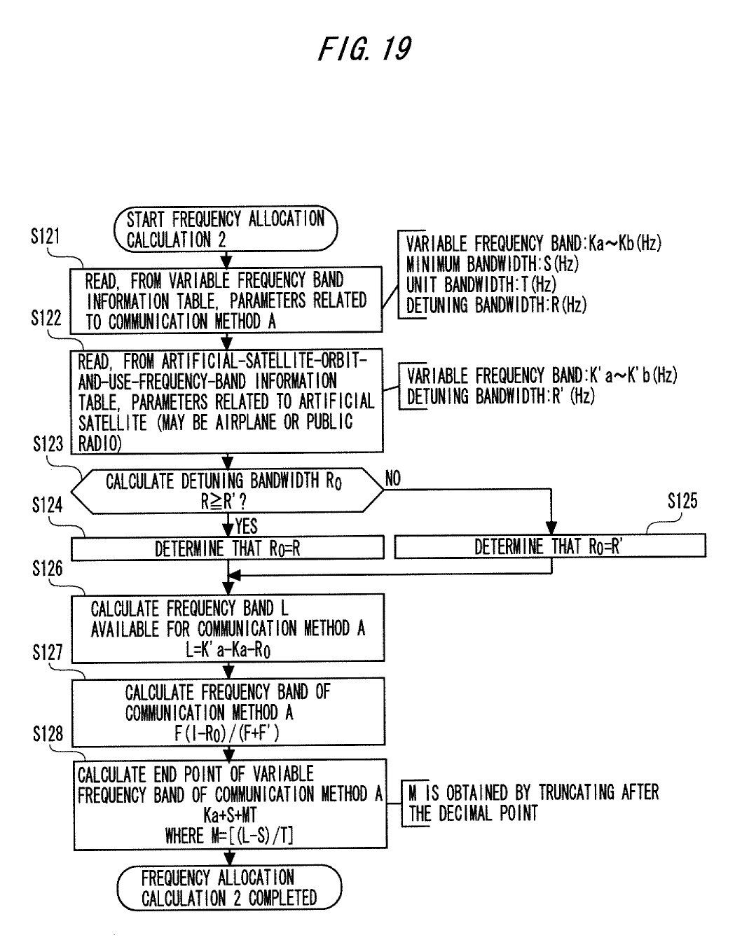

FIG. 19 is a flow chart illustrating an example of processing performed by the cognitive information table generating unit 209, which is related to the frequency allocation calculation 2. In FIG. 19, when the frequency allocation calculation 2 is started, the cognitive information table generating unit 209 reads parameters related to the communication method A from the variable frequency band information table 211 (Step S121).

Next, the cognitive information table generating unit 209 reads the parameters related to the artificial satellite from the artificial-satellite-orbit-and-use-frequency-band information table (artificial-satellite-orbit-and-use-frequency-band information stored in the receiving unit 207) (Step S122). In this example, there is illustrated an example in which the use frequency bands are adjusted between the artificial satellite and the communication method. In a case of the airplane or the public radio as an adjustment target, the parameters of the airplane or the public radio, which are related to the adjustment target, are read in Step S122.

Next, the cognitive information table generating unit 209 calculates a detuning bandwidth R0 to judge whether or not R≧R′ (Step S123). On this occasion, when R≧R′ is satisfied (S123: YES), the cognitive information table generating unit 209 determines that R0=R (Step S124). On the other hand, when R≧R′ is not satisfied (S123: NO), the cognitive information table generating unit 209 determines that R0=R′ (Step S125).

Next, the cognitive information table generating unit 209 calculates L=K′a−Ka−R0 as the frequency band L available for the communication method A (Step S126). Subsequently, the cognitive information table generating unit 209 calculates F(I−R0)/(F+F′) as the frequency band of the communication method A (Step S127).

Next, the cognitive information table generating unit 209 calculates Ka+S+MT (where M=[(L−S)/T] and M is obtained by truncating after the decimal point) as the end point of the variable frequency band of the communication method A (Step S128), and finishes the frequency allocation calculation 2.

<<Example of Cognitive Information Table>>

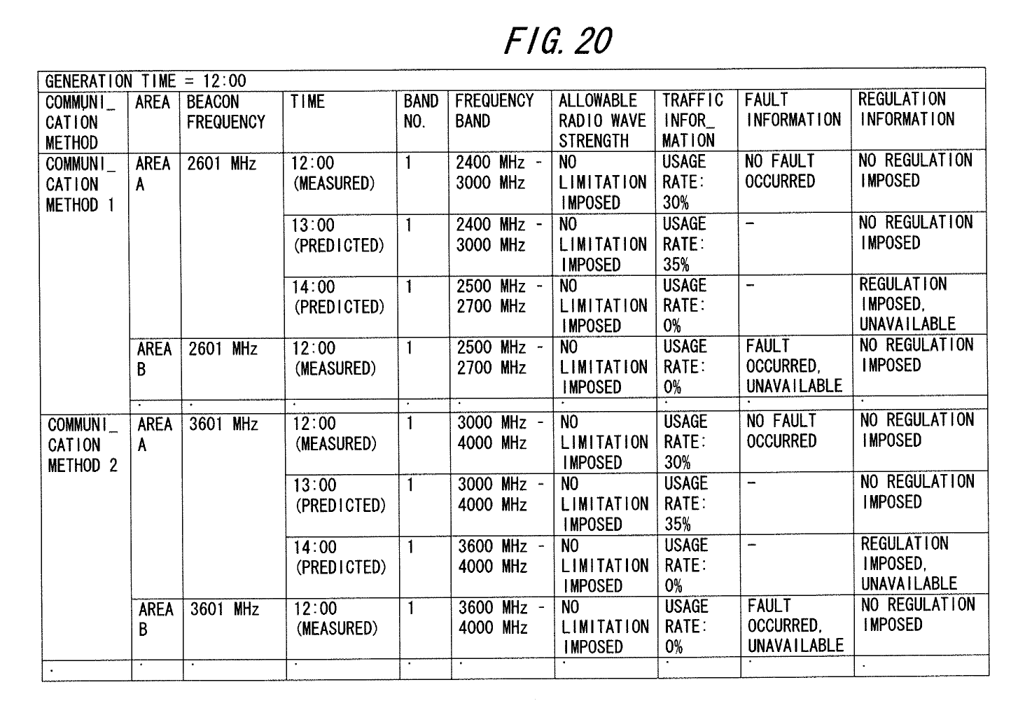

FIG. 20 is a table illustrating a data format example of the cognitive information table 210. The example illustrated in FIG. 20 shows a case in which the generation time is 12:00 and the prediction time is up to 14:00 (unit time is one hour).

In the cognitive information table 210, with regard to each of the communication methods #1 to #n, there is registered cognitive information including an available area, a beacon frequency, a time (measured and predicted), a band number, a frequency band, an allowable radio wave strength, traffic information, fault information, and regulation information.

<<Sequence and Flow Chart of Cognitive Information Table Generation>>

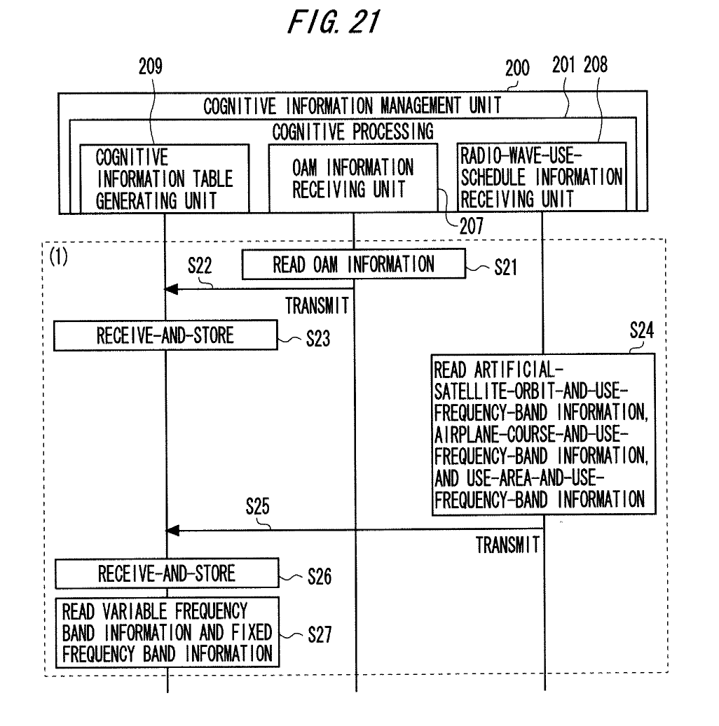

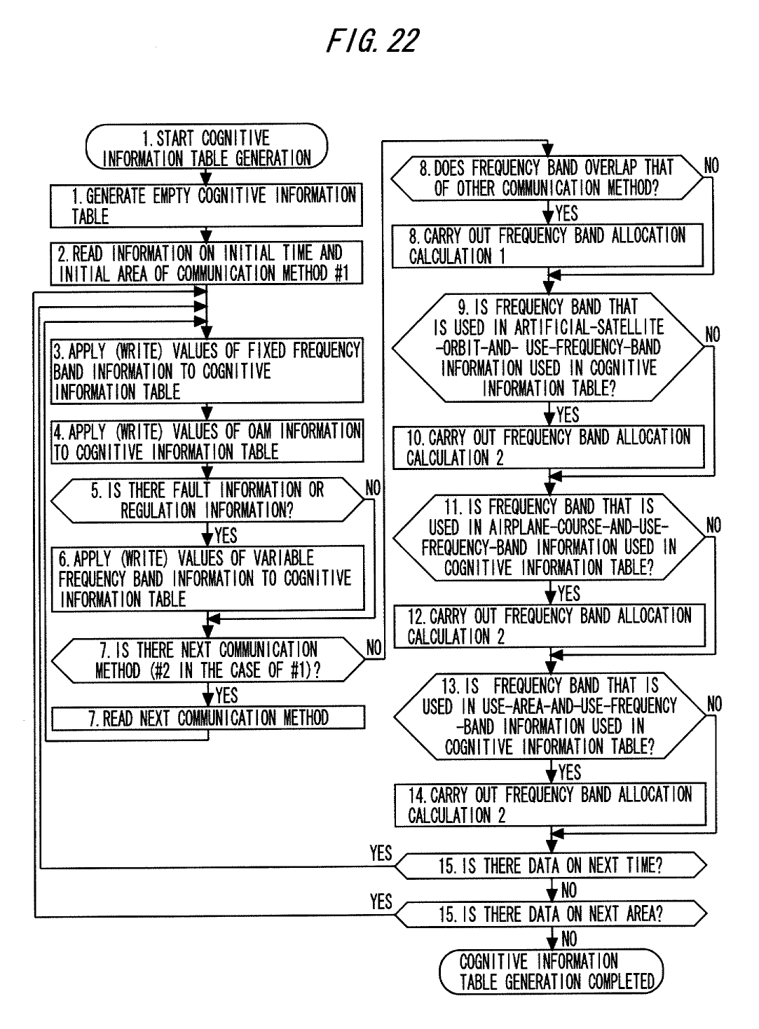

FIG. 21 is a sequence diagram illustrating an example of cognitive information table generation, and FIG. 22 is a flow chart illustrating an example of processing related to the cognitive information generation.

In FIG. 21, the OAM information receiving unit 207 of the cognitive information management unit 200 reads the OAM information that has been stored after being received from the respective communication methods #1 to #n (S21), and then transmits the OAM information to the cognitive information table generating unit 209 (S22). The cognitive information table generating unit 209 receives the OAM information and stores the OAM information therein (S23).

Further, the radio-wave-use-schedule information receiving unit 208 reads the radio wave information (artificial-satellite-orbit-and-use-frequency-band information, airplane-course-and-use-frequency-band information, and use-area-and-use-frequency-band information) that has been stored after being received from the radio wave information providing unit 500 (S24), and then transmits the radio wave information to the cognitive information table generating unit 209 (S25). The cognitive information table generating unit 209 receives the radio wave information and stores the radio wave information therein (S26).

Subsequently, the cognitive information table generating unit 209 reads the variable frequency band information and the fixed frequency band information stored in the tables 211 and 212, respectively (S27). After that, the processing of the flow chart illustrated in FIG. 22 is started. The numbers assigned to the respective blocks of the flow chart illustrated in FIG. 22 correspond to the steps <1> to <15>. Hence, detailed description of the flow chart is omitted.

As the frequency allocation calculation 1 (step <8>), the processing illustrated in FIG. 16 is executed. Further, as the frequency allocation calculation 2 (steps <10>, <12>, and <14>), the processing illustrated in FIG. 19 is executed.

### Operation 3

### Initial Beacon Transmission by Communication Methods #1 to #n

When the cognitive information table 210 has been generated, each of the communication systems 300 (#1 to #n) transmits the initial beacon to a communication area of its own management.

Specifically, the initial beacon generating unit 204 of the cognitive information management unit 200 generates the initial beacon information based on the registered contents of the cognitive information table 210, and then transmits the initial beacon information to each of the communication systems 300 (#1 to #n).

Each of the communication systems 300 determines an initial beacon transmitting frequency based on the initial beacon information received from the cognitive information management unit 200, and then transmits this initial beacon information with the frequency determined for the mobile terminal 400. To give more details, the following procedures (1) and (2) are performed.

(Procedure (1))

The initial beacon generating unit 204 (FIG. 3) of the cognitive information management unit 200 generates the initial beacon information based on the cognitive information table 210, and then transmits the initial beacon information to the communication systems 300 (#1 to #n).

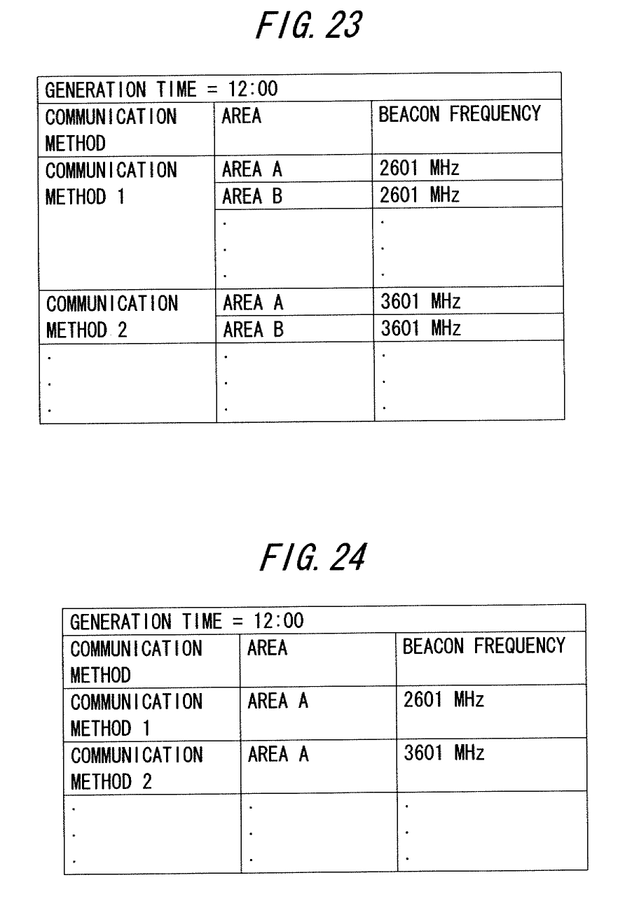

FIG. 23 is a table illustrating a data format example of the initial beacon information. The generation time of the initial beacon information illustrated in FIG. 23 indicates, as an example, a case of 12:00. The initial beacon information contains an available area and a beacon frequency with regard to each of the communication methods #1 to #n.

(Procedure (2))

In each of the communication systems 300 (FIG. 4) that have received the initial beacon information, the initial beacon transmitting unit 308 extracts an area, to which the initial beacon transmitting unit 308 desires to transmit the initial beacon, from entries corresponding to its own communication method in the initial beacon information (FIG. 23), and then transmits the initial beacon toward the mobile terminal 400 with a beacon frequency corresponding to that area.

To give an example of the frequency for the initial beacon transmission, in a case of the generation time of 12:00, the communication method #1, and the area A, the initial beacon frequency is set to 2601 MHz (see FIG. 23).

FIG. 24 is a table illustrating an example of an initial beacon to be transmitted toward the mobile terminal 400 located in the area A. The generation time of the initial beacon illustrated in FIG. 24 is 12:00.

<<Sequence of Initial Beacon Transmission>>

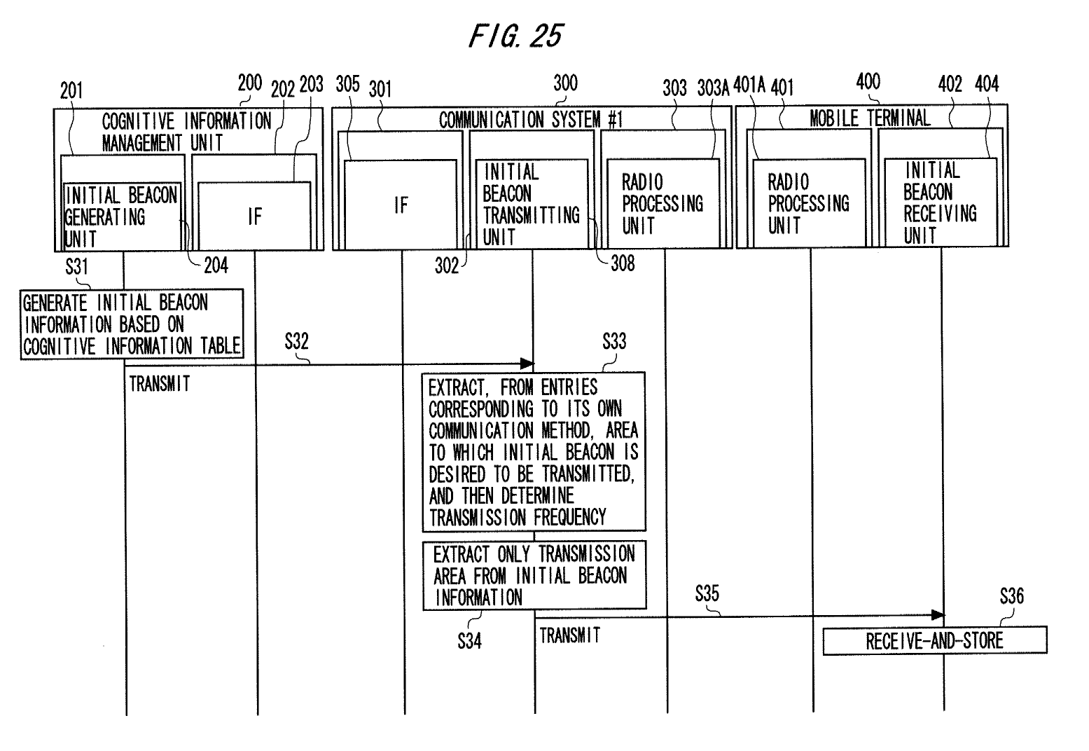

FIG. 25 is a sequence diagram illustrating an operational example of the procedures (1) and (2) related to the initial beacon transmission. In FIG. 25, the initial beacon generating unit 204 of the cognitive information management unit 200 generates the initial beacon information based on the cognitive information table 210 (S31), and then transmits the initial beacon information to the respective communication systems 300 (#1 to #n) (S32).

Upon reception of the initial beacon information, the initial beacon transmitting unit 308 of the communication system 300 (for example, #1) extracts a beacon frequency of the area to which the initial beacon is to be transmitted (for example, area A) from entries corresponding to its own communication method (communication method #1) in the initial beacon information (FIG. 23), and then determines the transmission frequency for the initial beacon (S33).

Subsequently, the initial beacon transmitting unit 308 extracts, from the initial beacon information, only information on the transmission area (area A) (S34), and then transmits the initial beacon to the mobile terminal 400 with the determined transmission frequency (S35).

In the mobile terminal 400, the initial beacon receiving unit 404 receives the initial beacon via the radio processing unit 401A and stores the initial beacon therein (S36).

### Operation 4

### Changing of Frequency Band and the Like Based on Communication-Method-and-Frequency-Band Change Information

In an operation 4, the communication-method-and-frequency-band determining unit 206 of the cognitive information management unit 200 generates the communication-method-and-frequency-band change information for the communication systems 300 (#1 to #n) based on the cognitive information table 210, and then transmits the communication-method-and-frequency-band change information to the communication-method-and-frequency-band changing unit 309 of each of the communication systems 300.

The communication-method-and-frequency-band changing unit 309 that has received the communication-method-and-frequency-band change information sets, based on the communication-method-and-frequency-band change information, the frequency band and the allowable radio wave strength determined for each area for the radio processing unit 303A. Detailed procedures are described in the following (1) and (2).

(Procedure (1))

The communication-method-and-frequency-band determining unit 206 (FIG. 3) of the cognitive information management unit 200 refers to the cognitive information table 210 to generate the communication-method-and-frequency-band change information for the respective communication systems 300 (#1 to #n).

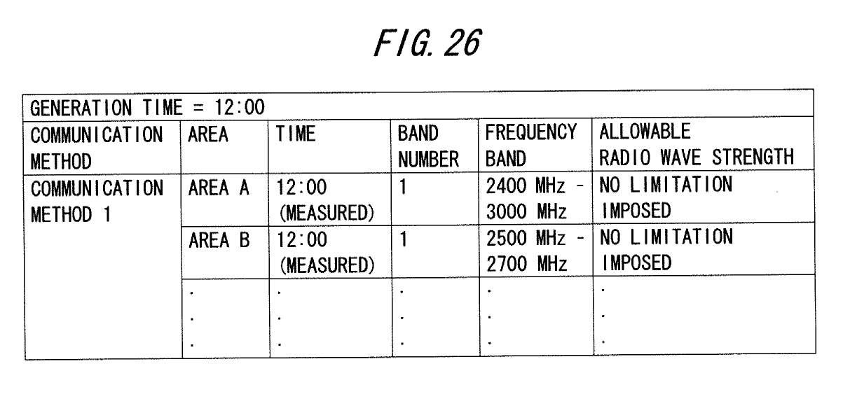

FIG. 26 illustrates a data format example of the communication-method-and-frequency-band change information. The example illustrated in FIG. 26 represents a case of the communication method #1, and the generation time of 12:00.

The communication-method-and-frequency-band change information contains, with regard to each of the available areas of the communication method, a designated time, a band number, a frequency band, and an allowable radio wave strength. Those pieces of information can be generated by extracting information from the cognitive information table 210.

(Procedure (2))

The communication-method-and-frequency-band changing unit 309 of each of the communication systems 300 (#1 to #n) that have received the communication-method-and-frequency-band change information sets, based on the communication-method-and-frequency-band change information, the frequency band and the allowable radio wave strength determined for each area for the radio processing unit 303A.

<<Sequence>>

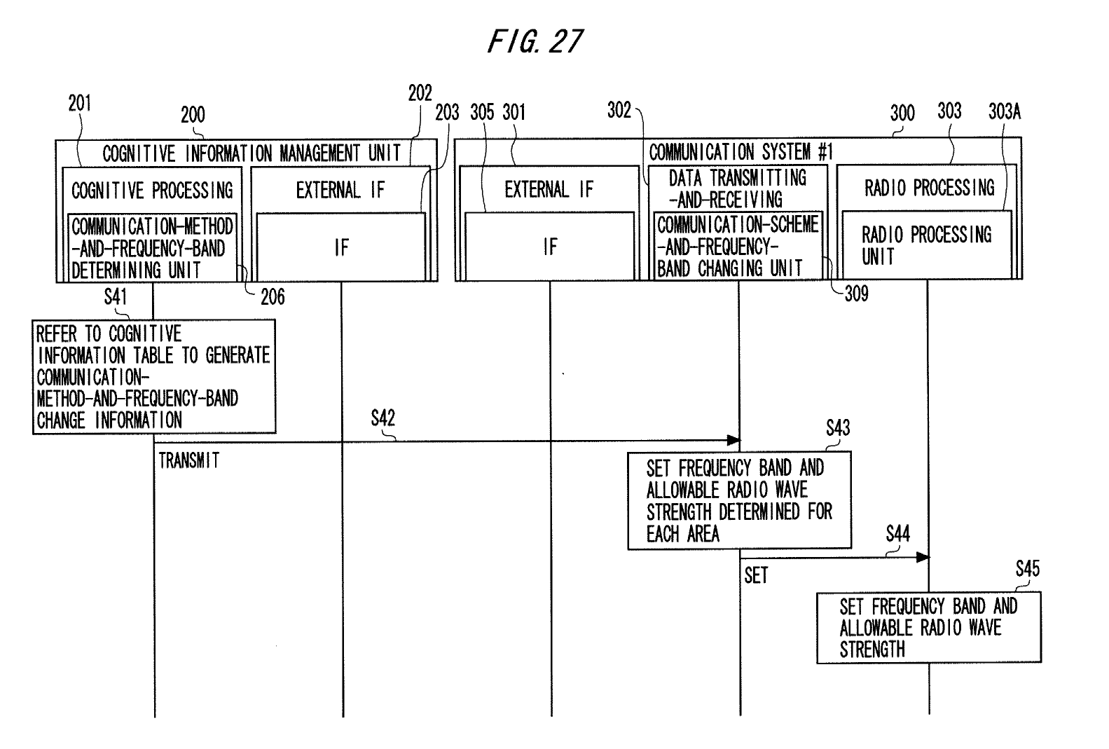

FIG. 27 is a sequence diagram illustrating an operational example of the procedures (1) and (2) related to the communication-method-and-frequency-band changing. In FIG. 27, the communication-method-and-frequency-band determining unit 206 of the cognitive information management unit 200 refers to the cognitive information table 210 to generate the communication-method-and-frequency-band change information (FIG. 26) (S41), and then transmits the communication-method-and-frequency-band change information to each of the communication systems 300 (#1 to #n) (S42).

The communication-method-and-frequency-band changing unit 309 of the communication system 300 (for example, #1) sets, based on the communication-method-and-frequency-band change information, the frequency band and the allowable radio wave strength determined for each area for the radio processing unit 303A (S43, S44, and S45).

### Operation 5

### Transmission of Detailed List in Response to Request from Mobile Terminal

When a request (request list) for a detailed list has been made from the request list generating unit 408 (FIG. 5) of the mobile terminal 400, the detailed list generating unit 205 (FIG. 3) of the cognitive information management unit 200 receives the request list.

The detailed list generating unit 205 refers to the cognitive information table 210 to generate a detailed list, and then transmits the detailed list toward the detailed list receiving unit 405 of the mobile terminal 400. Detailed procedures are described in the following procedures (1) and (2).

(Procedure (1))

After a request list is generated by the request list generating unit 408 of the mobile terminal 400, the request list is transmitted from the radio processing unit 401A, and is then received, via the communication system 300 in communication, by the detailed list generating unit 205 of the cognitive information management unit 200.

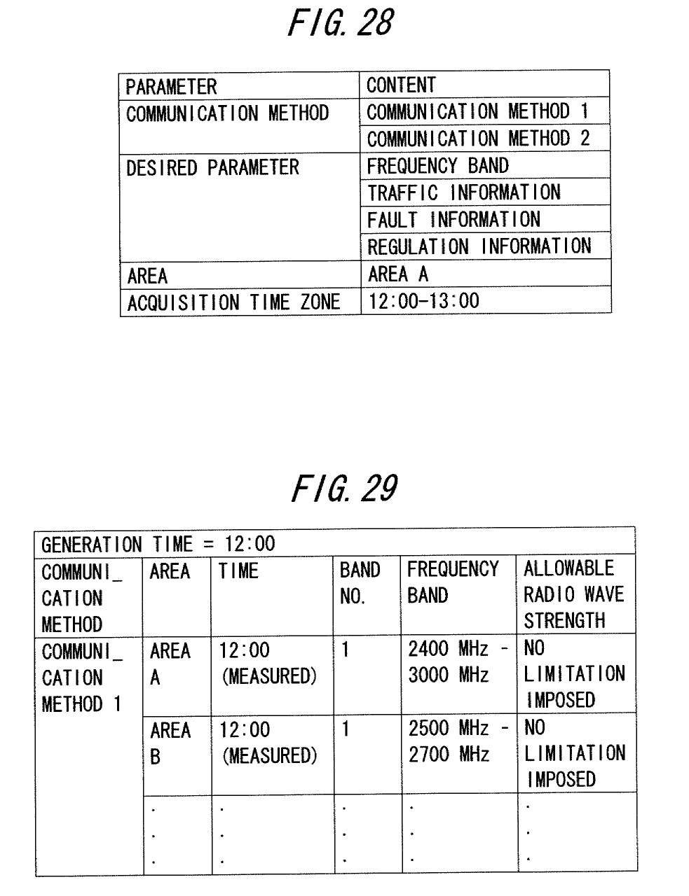

FIG. 28 is a table illustrating a data format example of the request list. In the example illustrated in FIG. 28, the communication methods #1 and #2 are involved in the request for a detailed list. Parameters required to be contained in the detailed list are the frequency band, the traffic information, the fault information, and the regulation information. Further, the required area is the area A, and the acquisition time zone is between 12:00 and 13:00.

(Procedure (2))

In the cognitive information management unit 200 (FIG. 3), the request list received by the IF 203 is transferred to the detailed list generating unit 205. Based on the request list, the detailed list generating unit 205 generates a detailed list by referring to the cognitive information table 210.

The detailed list is generated, for example, with the use of such a method of generating a detailed list, in which only the desired parameters contained in the request list are extracted from the cognitive information table 210, and then the extracted information is arranged in a table format.

The detailed list is transmitted from the detailed list generating unit 205 toward the detailed list receiving unit 405 of the mobile terminal 400. The detailed list is received, via the IF 203 and the communication system 300, by the radio processing unit 401A of the mobile terminal 400, and then transferred to the detailed list receiving unit 405.

FIG. 29 is a table illustrating a data format example of the detailed list. The detailed list of FIG. 27 is generated by extracting, from the cognitive information table 210 (FIG. 20), the desired parameters contained in the request list illustrated in FIG. 26.

<<Sequence>>

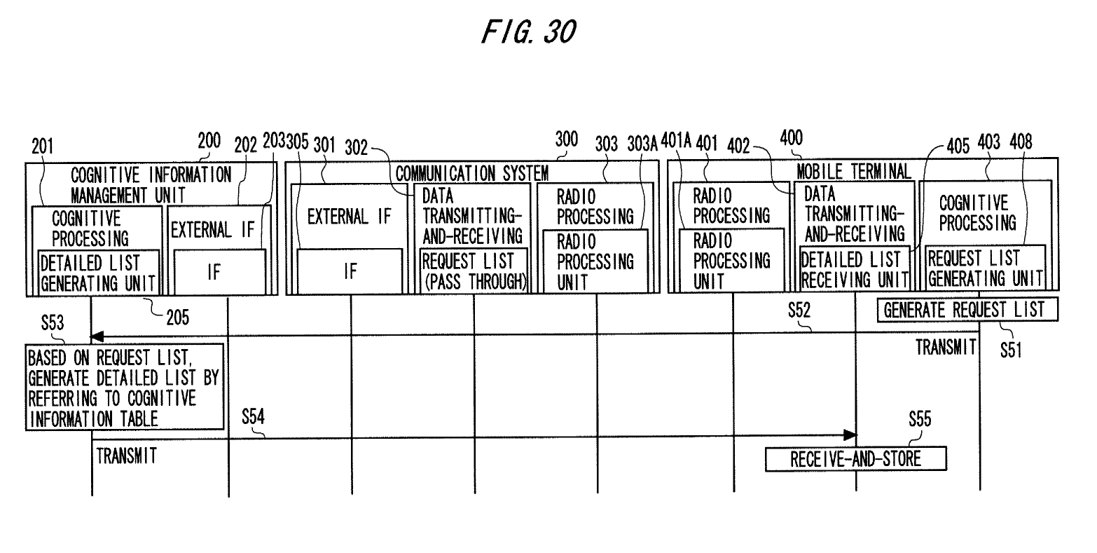

FIG. 30 is a sequence diagram illustrating an operational example of the procedures (1) and (2) related to the transmission/reception of the request list and the detailed list described above. In FIG. 30, the request list generating unit 408 of the mobile terminal 400 generates a request list (S51), and then transmits the request list toward the detailed list generating unit 205 of the cognitive information management unit 200 (S52).

The request list is transmitted from the radio processing unit 401A, relayed by the communication system 300, and received by the IF-for-other-communication-method 203, to thereby reach the detailed list generating unit 205.

Based on the request list, the detailed list generating unit 205 generates a detailed list by referring to the cognitive information table 210 (S53). The detailed list is transmitted from the IF-for-other-communication-method 203, passed through the communication system 300, and received by the radio processing unit 401A, to thereby reach the detailed list receiving unit 405 (S54). The detailed list receiving unit 405 receives the detailed list and stores the detailed list therein (S55). After that, in the mobile terminal 400, based on the detailed list, the communication method and frequency band are determined.

### Effects of Embodiment

According to the cognitive information distribution system of the embodiment, the cognitive information management unit 200 collects, from each of the communication systems (communication methods) #1 to #n, information on traffic, fault, regulation, and the like (OAM information). Further, the cognitive information management unit 200 collects, from the radio wave information providing unit 500, information regarding the artificial satellite, the airplane, and the public radio.

Further, the cognitive information management unit 200 generates the cognitive information table 210 by combining the collected information, the variable frequency band information, and the fixed frequency information.

The cognitive information management unit 200 generates the initial beacon information based on the cognitive information table 210, and the initial beacon information is distributed to each of the communication methods #1 to #n. The respective communication methods #1 to #n distribute the initial beacons based on the initial beacon information to the mobile terminals 400 under management thereof.

Further, the cognitive information management unit 200 determines the use frequency band of each of the communication methods #1 to #n based on the cognitive information table 210, and then distributes the communication-method-and-use-frequency-band information to the respective communication methods #1 to #n. With this, each of the communication methods #1 to #n changes the frequency band so as to perform wireless communication with a frequency band determined based on the cognitive information table 210.

Further, the cognitive information management unit 200 generates the detailed list corresponding to the request list received via the communication system 300 from the mobile terminal 400, and then provides the detailed list to the mobile terminal 400. By doing so, in the respective communication methods #1 to #n, it becomes possible to perform optimal allocation of frequency bands. In other words, it becomes possible to efficiently utilize frequencies among a plurality of communication methods.

Detailed Description of Mobile Terminal

Next, detailed description is added with regard to the processing and operation of the mobile terminal 400. The processing and operation of the mobile terminal 400 are classified into the following six operations:

(operation 1) reception of the initial beacon;

(operation 2) recognition of the surrounding radio wave condition and prioritization;

(operation 3) generation and transmission of the request list for making a request to the cognitive information management unit;

(operation 4) reception of the detailed list from the cognitive information management unit, and prioritization based thereon;

(operation 5) prioritization based on the terminal side status and user actions; and

(operation 6) determination of the communication method and the frequency band, and changing of the communication method.

Further, the flow of the processing (processing method) performed by the mobile terminal 400 is largely divided into the following two methods of a method A and a method B:

(method A) a method in which, instead of the terminal itself collecting information desired for the recognition, the network side collects and collectively manages the information, and the terminal performs the recognition by using that information; and

(method B) a hybrid method in which as the technology corresponding to the original cognitive radio technology, the terminal side also collects the information.

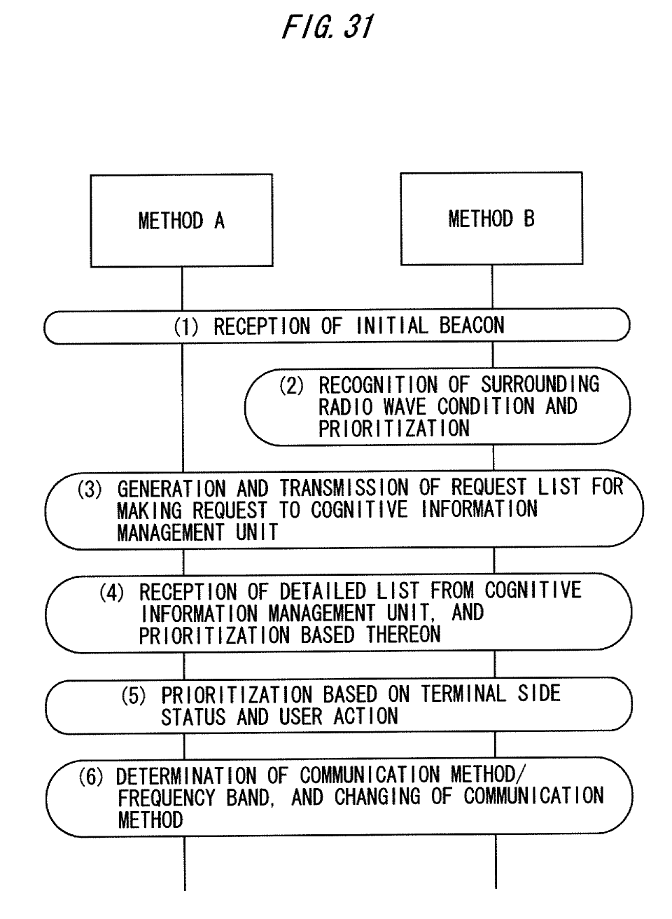

FIG. 31 is a flow chart briefly illustrating operations of the method A and method B. As illustrated in FIG. 31, the method B is different from the method A in that the operation 2 “recognition of the surrounding radio wave condition and prioritization” is added. Hereinbelow, detailed description is given of the operations 1 to 6 according to the embodiment.

### Operation 1

### Reception of Initial Beacon

The initial beacon receiving unit 404 (FIG. 5) regularly receives the initial beacon transmitted by the initial beacon transmitting unit 308 of the communication system 300. Further, at the time of communication start and communication switching of the mobile terminal 400, when an acquisition request for the initial beacon is made from the request list generating unit 408, the initial beacon receiving unit 404 receives the initial beacon transmitted from the communication system 300 in response to the acquisition request, and then transmits the contents of the initial beacon to the request list generating unit 408. The detailed procedures are described in the following procedures (1) to (3).

(Procedure (1))

The initial beacon receiving unit 404 regularly (for example, once an hour) receives the initial beacon from each of the communication systems 300 (#1 to #n). The initial beacon is transmitted with a fixed frequency corresponding to each of the communication methods #1 to #n.

(Procedure (2))

Further, in the mobile terminal 400, when a communication is started or switched, the request list generating unit 408 makes an initial beacon acquisition request to the initial beacon receiving unit 404.

(Procedure (3))

The initial beacon receiving unit 404 that has received the initial beacon acquisition request from the request list generating unit 408 receives the initial beacon transmitted from the initial beacon transmitting unit 308 of the communication system 300.

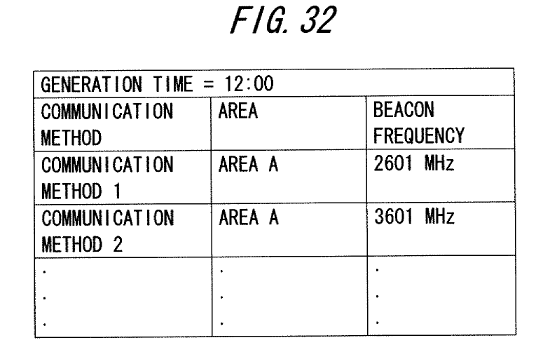

FIG. 32 is a table illustrating an example of the initial beacon received by the mobile terminal 400. FIG. 32 illustrates an initial beacon for the area A, which has an initial beacon generation time of 12:00.

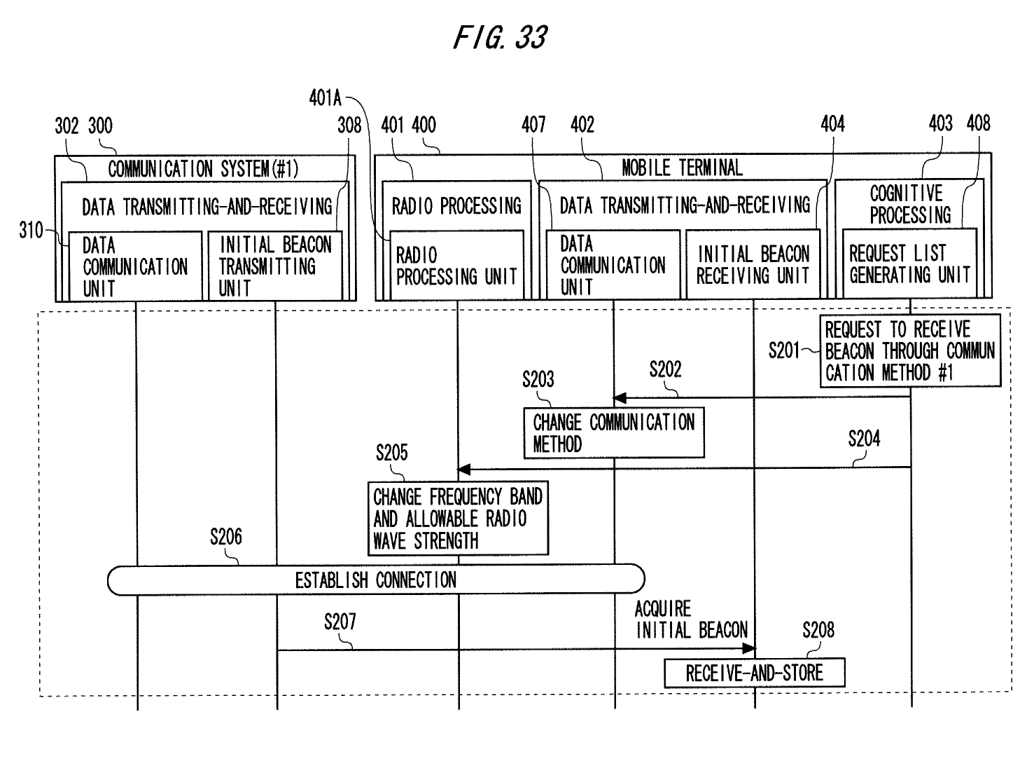

FIG. 33 is a sequence diagram illustrating an operational example of the procedures (1) to (3) related to the initial beacon reception. In FIG. 33, the request list generating unit 408 of the mobile terminal 400 generates a request to receive the initial beacon through the communication method #1 (S201), and then requests the data communication unit 407 to change the communication method to be used to the communication method #1 (S202). The data communication unit 407 changes the communication method to the communication method #1 in response to the request from the request list generating unit 408 (S203).

Further, the request list generating unit 408 requests the radio processing unit 401A to set the frequency band and the allowable radio wave strength according to the communication method #1 (S204). The radio processing unit 401A changes the settings of the frequency band and the allowable radio wave strength in response to the request (S205).

After that, a connection for communication is established between the data communication unit 407 and the data communication unit 310 of the communication system 300 (#1) (S206). Subsequently, the initial beacon is transmitted from the initial beacon transmitting unit 308 of the communication system 300 (#1) (S207). The initial beacon is received and stored by the initial beacon receiving unit 404 of the mobile terminal 400 (S208).

The procedures S201 to S208 are repeatedly executed for the other communication methods #2 to #n. With this, the mobile terminal 400 can receive the initial beacons corresponding to the communication methods #1 to #n.

### Operation 2

### Recognition of Surrounding Radio Wave Condition and Prioritization

The mobile terminal 400 observes the surrounding radio wave condition by itself. Based on the radio wave strengths, priorities to be used in selecting the communication method and the frequency band are provided to the respective communication systems 300 (#1 to #n). Here, in the case of the method A in which the network side collects and manages the information desired for the recognition of the frequency band in an integrated manner, and the terminal performs the recognition by using that information, which is different from the method B in which the terminal itself collects the information, the operation 2 is not performed (FIG. 31). To give more details, the following procedures (1) and (2) are performed.

(Procedure (1))

The radio processing unit 401A of the mobile terminal 400 measures the radio wave conditions around the mobile terminal 400, which correspond to the respective communication methods #1 to #n. The radio wave conditions are listed by the communication-method-and-frequency-band determining unit 409 of the mobile terminal 400. In other words, a radio wave condition list is generated.

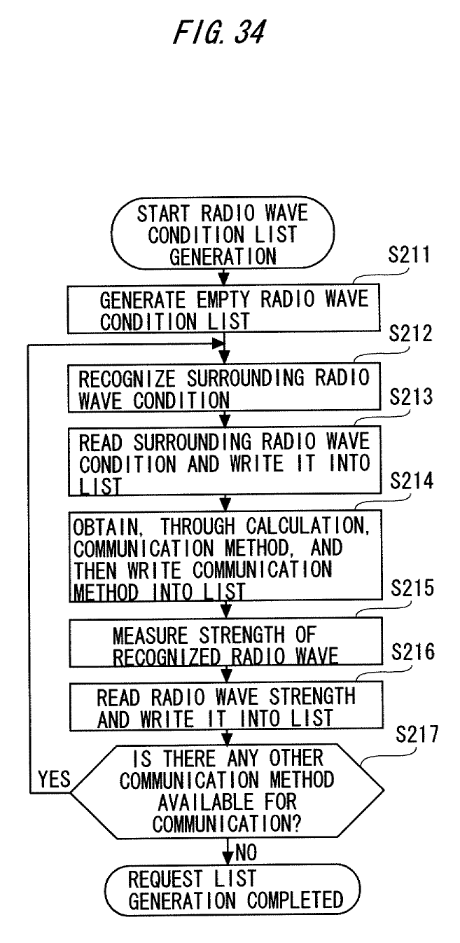

FIG. 34 is a flow chart illustrating a procedural example of radio wave condition list generation that is carried out by the communication-method-and-frequency-band determining unit 409. The radio wave condition list is generated through Steps S211 to S217 described below.

<Step S211> The communication-method-and-frequency-band determining unit 409 generates an empty radio wave condition list.

<Step S212> The radio processing unit 401A transmits the recognized frequency band to the communication-method-and-frequency-band determining unit 409. The recognition of the frequency band is performed by the radio processing unit 401A receiving and measuring the radio wave.

<Step S213> Next, the communication-method-and-frequency-band determining unit 409 writes the surrounding radio wave condition (frequency band) measured by the radio processing unit 401A into the radio wave condition list.

<Step S214> Next, the communication-method-and-frequency-band determining unit 409 obtains, through calculation, a communication method of the frequency band received by the radio processing unit 401A, and then writes the communication method into the radio wave condition list.

<Step S215> The radio processing unit 401A measures the radio wave strength of the recognized frequency band, and then transmits the radio wave strength to the communication-method-and-frequency-band determining unit 409.

<Step S216> The communication-method-and-frequency-band determining unit 409 writes the radio wave strength of the frequency band into the radio wave condition list.

<Step S217> The processing of Steps S211 to S216 is executed repeatedly for all the frequencies (communication methods available for communication) recognizable by the radio processing unit 401A.

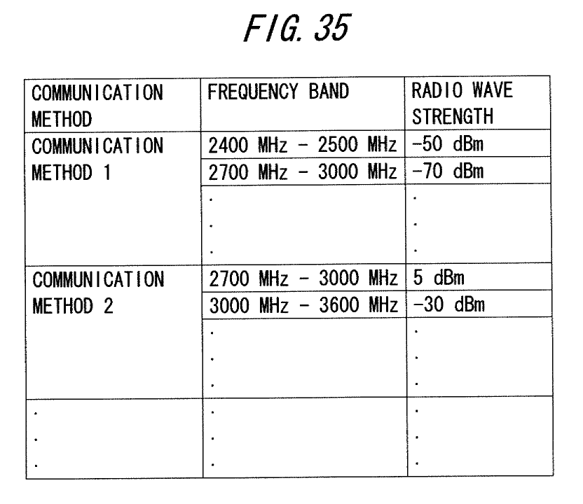

FIG. 35 is a table illustrating a data format example of the radio wave condition list indicating the surrounding radio wave conditions listed by the communication-method-and-frequency-band determining unit 409. The radio wave condition list stores frequency bands and radio wave strengths with regard to the received (communicably available) communication methods.

(Procedure (2))

Based on the radio wave conditions stored in the communication-method-and-frequency-band determining unit 409, the priorities to be used in selecting the communication method and the frequency band are determined for the respective communication methods/frequency bands, and then written into a priority list.

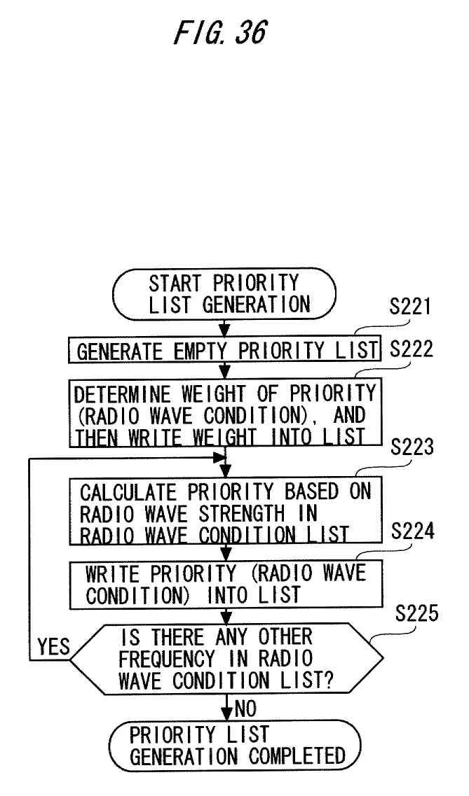

FIG. 36 is a flow chart illustrating an example of processing of generating a priority list, which is performed by the communication-method-and-frequency-band determining unit 409. The priority list is generated through Steps S221 to S225 of FIG. 36 described below.

<Step S221> The communication-method-and-frequency-band determining unit 209 generates an empty priority list.

<Step S222> Next, the communication-method-and-frequency-band determining unit 209 determines the weight of the priority (radio wave condition), and then writes the weight into the priority list.

<Step S223> Next, the communication-method-and-frequency-band determining unit 209 calculates the priority based on the radio wave strength in the radio wave condition list (an example of the calculation method is described later).

<Step S224> Next, the communication-method-and-frequency-band determining unit 209 writes the priority (radio wave condition) into the list.

<Step S225> The processing of Steps S223 and S224 is executed repeatedly for all the frequency bands in the radio wave condition list.

The priority is determined by using, for example, the following calculation expression.

(Priority(radio wave condition))=(radio wave strength(%))×0.1 <calculation expression>

The radio wave strength (%) is obtained by using the ratios with respect to a maximum strength and a minimum strength of each communication method. For example, when the communication method #1 has a maximum strength of “X1 dBm” and a minimum strength of “X2 dBm”, and the measured radio wave strength is “X3 dBm”, the radio wave strength is calculated as follows. Specifically, when the minimum strength is assumed to be 0, the maximum strength is X1-X2 and the measured strength is X3-X2. Accordingly, the following holds: (radio wave strength (%))=100×(X3−X2/X1−X2).

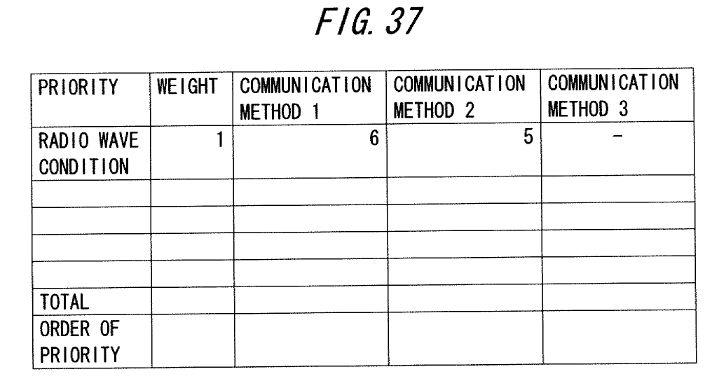

FIG. 37 illustrates a data format example of the priority list. In the example illustrated in FIG. 37, there are indicated the priorities for the communication methods #1 to #3 in a case where it is assumed that the mobile terminal 300 can use the communication methods #1 to #3. The example illustrated in FIG. 37 shows a case in which the mobile terminal 400 has not carried out the recognition (radio wave reception) of the communication method #3. In this case, the priority (radio wave condition) of the communication method #3 is assigned with no value.

### Operation 3

### Generation and Transmission of Request List for Making a Request to Cognitive Information Management Unit

Based on the communication methods available for the mobile terminal 400, and the status (terminal status) of the mobile terminal, the request list generating unit 408 lists parameters desired in selecting the communication method/frequencies, and then transmits a request list for the parameters to the cognitive information management unit 200. Details include the following procedures (1) and (2).

(Procedure (1))

Based on the communication methods available for the mobile terminal 400, the terminal status, and the user action contents, the request list generating unit 408 generates parameters desired in selecting the communication method/frequencies as a request list. Hereinbelow, examples of the terminal status and the user action contents are described.

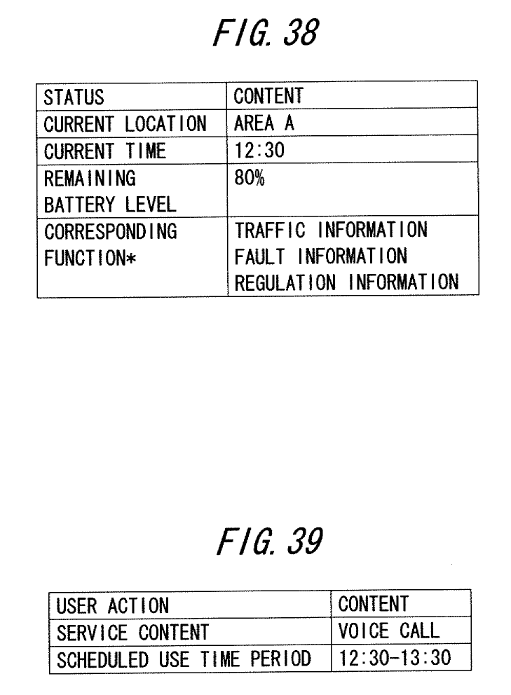

For example, description is given of a case in which a voice call is performed for an hour from a time of 12:30 in the area A. FIG. 38 is a table illustrating an example of the terminal status. In the example illustrated in FIG. 38, the terminal status contains a current location, a current time, a remaining battery level, and a corresponding function. The corresponding function indicates radio wave information that can be referred to in selecting the communication method/frequencies. Here, the corresponding function contains the traffic information, the fault information, and the regulation information.

FIG. 39 is a table illustrating an example of the user action contents. In the example illustrated in FIG. 39, as the user action contents, there are contained a service content and a scheduled use time period. The terminal status and the user action contents illustrated in FIG. 38 and FIG. 39 correspond to the terminal status 410 and the user action contents 411 illustrated in FIG. 5, respectively, and are collected by the request list generating unit 408 for generating a request list.

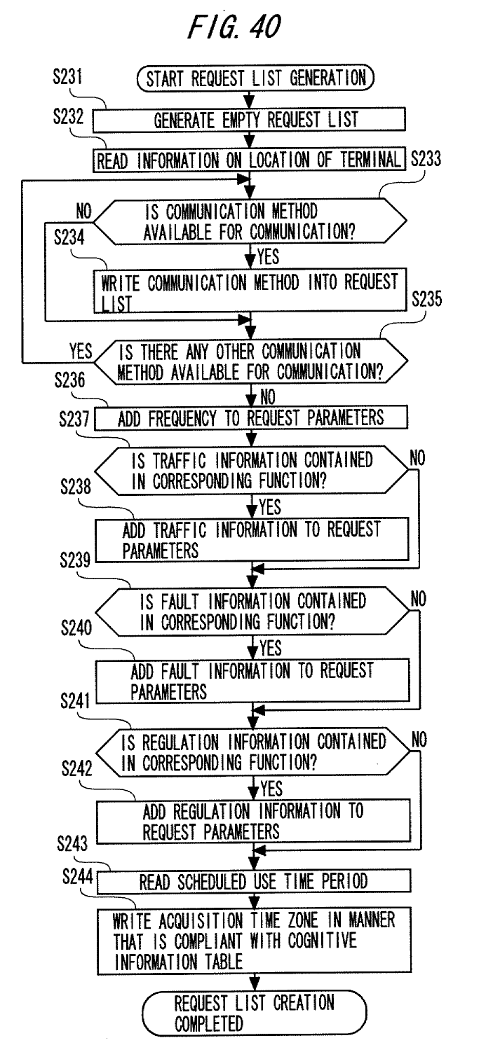

FIG. 40 is a flow chart illustrating an example of the processing procedures of the request list generation performed by the request list generating unit 408. The request list is generated through Steps S231 to S244 described below.

<Step S231> The request list generating unit 408 generates an empty request list.

<Step S232> Next, based on the terminal status 410 (FIG. 38), the request list generating unit 408 reads information on the current location of the mobile terminal 400.

<Steps S233, S234, and S235> Next, the request list generating unit 408 writes all the communication methods available for the mobile terminal 400 into the request list.

<Step S236> Next, the request list generating unit 408 adds the frequency to the request parameters in the request list.

<Steps S237 and S238> Next, the request list generating unit 408 refers to the terminal status 410, and, when the traffic information corresponds to the request parameters (the corresponding function of the terminal status 410 contains the traffic information), adds the traffic information to the corresponding function of the request list.

<Steps S239 and S240> Next, the request list generating unit 408 refers to the terminal status 410, and, when the fault information corresponds to the request parameters (the corresponding function of the terminal status 410 contains the fault information), adds the fault information to the corresponding function of the request list.

<Steps S241 and S242> Next, the request list generating unit 408 refers to the terminal status 410, and, when the regulation information corresponds to the request parameters (the corresponding function of the terminal status 410 contains the regulation information), adds the regulation information to the corresponding function of the request list.

<Step S243> Next, the request list generating unit 408 reads the scheduled use time from the user action contents.

<Step S244> The request list generating unit 408 performs writing of the acquisition time zone in a manner that is compliant with the format of the cognitive information table 210 generated by the cognitive information management unit 200. For example, in a case where a time is set on an hour basis in the cognitive information table 210, the request list generating unit 408 writes the acquisition time zone on an hour basis.

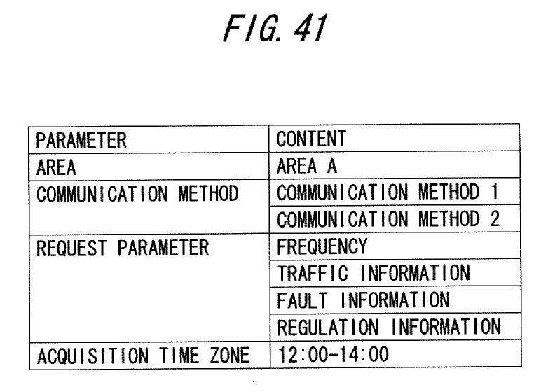

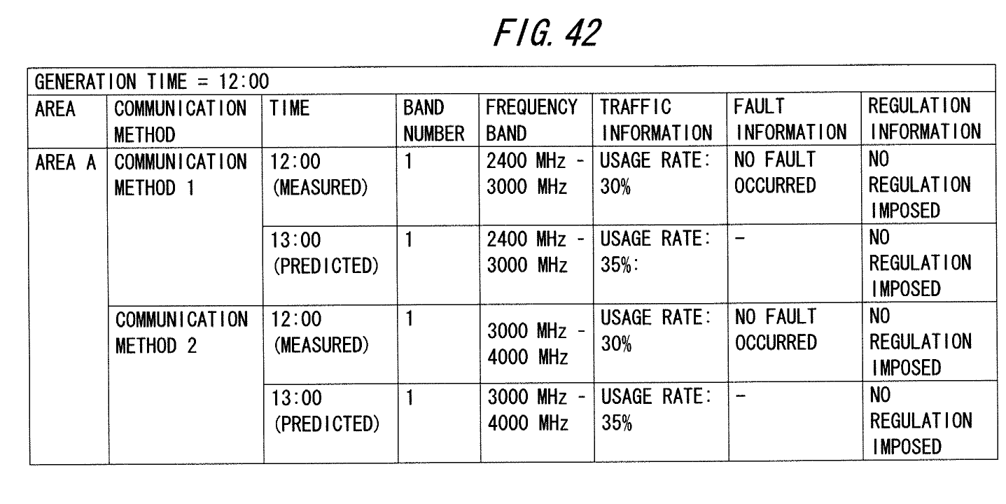

FIG. 41 illustrates a data format example of the request list that has been generated through the procedures. FIG. 41 illustrates a request list generated in a case where a voice call is performed for an hour from a time of 12:30 in the area A. The terminal status is similar to that of the above.

(Procedure (2))

The generated request list is transmitted from the radio processing unit 401A, and then transmitted, via the communication system 300 that has transmitted the initial beacon, to the cognitive information management unit 200.

### Operation 4

### Reception of Detailed List from Cognitive Information Management Unit, and Prioritization Based Thereon

The detailed list receiving unit 405 (FIG. 5) receives the detailed list transmitted from the cognitive information management unit 200 in response to the request list transmitted to the cognitive information management unit 200 in the operation 3, and then transmits the detailed list to the communication-method-and-frequency-band determining unit 409. Based on the parameters in the received detailed list, the communication-method-and-frequency-band determining unit 409 determines the priorities to be used in selecting the communication method and the frequency band for the respective communication methods/respective frequency bands. To give more details, the following procedures (1) and (2) are performed.

(Procedure (1))

The detailed list receiving unit 405 receives, via the radio processing unit 401A, the detailed list corresponding to the request list from the cognitive information management unit 200, and then transmits the detailed list to the communication-method-and-frequency-band determining unit 409. FIG. 42 illustrates an example of the received detailed list.

(Procedure (2))

Based on the parameters in the received detailed list, the terminal status 410, and the user action contents 411, the communication-method-and-frequency-band determining unit 409 determines the priorities to be used in selecting the communication method and the frequency band for the respective communication methods/respective frequency bands, and then writes the priorities into the priority list.

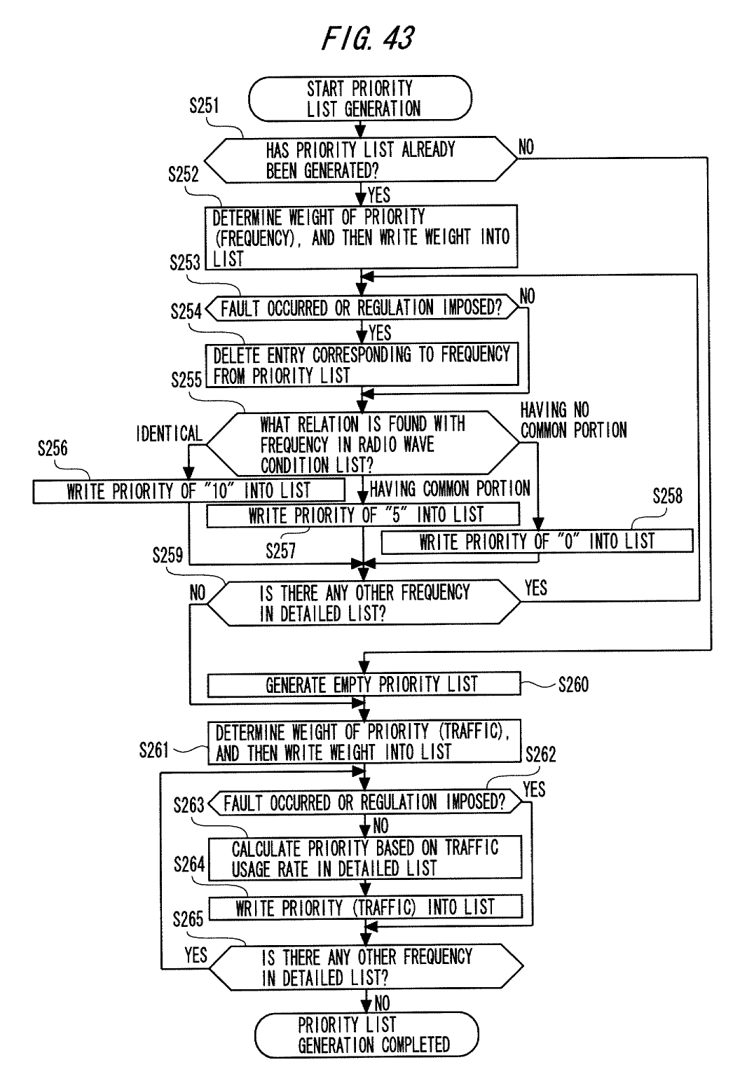

FIG. 43 is a flow chart illustrating an example of procedures of generating the priority list, which are executed by the communication-method-and-frequency-band determining unit 409 in this procedure (2). The generation procedures are as follows.

<Step S251> The communication-method-and-frequency-band determining unit 409 checks whether or not a priority list has already been generated. In a case where a priority list has been generated (S251: YES), the processing proceeds to Step S252, whereas in a case where a priority list has not been generated (S251: NO), the processing proceeds to Step S260.

A priority list already exists only when the mobile terminal 200 has recognized the surrounding radio wave condition, that is, in a case where the operation 2 has already been executed (in the case where the method B is executed).

<Step S252> The communication-method-and-frequency-band determining unit 409 determines the weight of the priority (frequencies), and then writes the weight into the priority list.

<Steps S253 and S254> When the priority list contains any frequencies whose fault information is “fault occurred” or whose regulation information is “regulation imposed” in the detailed list, the communication-method-and-frequency-band determining unit 409 deletes an entry corresponding to the frequencies from the priority list.

<Step S255> Next, the communication-method-and-frequency-band determining unit 409 makes comparison between one of the frequency bands of the detailed list (FIG. 42) and a frequency band of the radio wave condition list (FIG. 35) to thereby judge whether the frequency bands are identical, have a common portion, or have no common portion.

<Step S256> When one frequency band of the detailed list is the same as the frequency of the radio wave condition list, that is, the same as the frequency band recognized by the mobile terminal 400, the communication-method-and-frequency-band determining unit 409 writes a priority of “10” into the priority list.

<Step S257> When one frequency band of the detailed list has a common portion to the frequency band recognized by the mobile terminal 400, the communication-method-and-frequency-band determining unit 409 writes a priority of “5” into the priority list.

<Step S258> When one frequency band of the detailed list has no common portion to the frequency band recognized by the mobile terminal, the communication-method-and-frequency-band determining unit 409 writes a priority of “0” into the priority list.

<Step S259> When there are other frequency bands in the detailed list, the communication-method-and-frequency-band determining unit 409 repeatedly executes the operation of Steps S253 to S258 for all the other frequency bands. The operation from Steps S255 to S258 is not performed for a frequency band whose fault information is “fault occurred” or whose regulation information is “regulation imposed” (Step S253: NO). After the processing is finished for all the frequency bands in the detailed list, the communication-method-and-frequency-band determining unit 409 advances the processing to Step S261.

<Step S260> Because there is no priority list generated, the communication-method-and-frequency-band determining unit 409 generates an empty priority list.

<Step S261> Next, the communication-method-and-frequency-band determining unit 409 determines the weight of the priority (traffic).

<Steps S263 and S264> Next, the communication-method-and-frequency-band determining unit 409 calculates the priority (traffic) from the traffic usage rate of the detailed list, and then writes the priority into the priority list.

<Step S265> When there are other frequency bands in the detailed list, the processing of Steps S263 and S264 is repeatedly performed for all the other frequency bands. The communication-method-and-frequency-band determining unit 409 does not perform the operation of Steps S263 and S264 for a frequency band whose fault information is “fault occurred” or whose regulation information is “regulation imposed” (Step S262).

The calculation of the priority (traffic) of Step S263 is performed according to, for example, the following calculation expression.

(Priority(traffic))=(100−(traffic usage rate(%)))×0.1 <calculation expression>

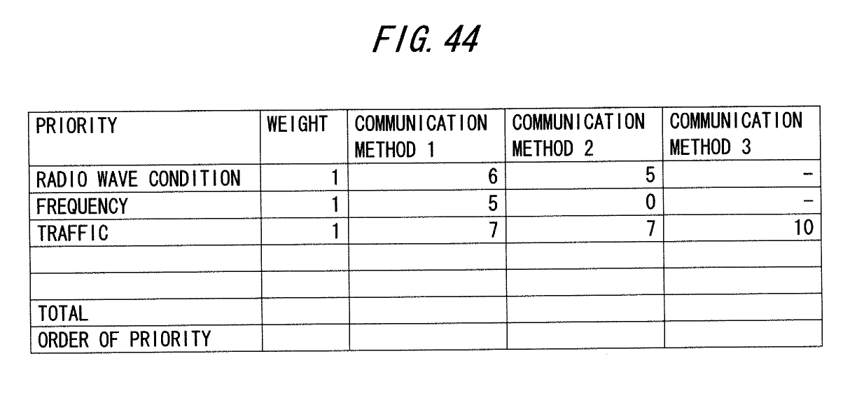

FIG. 44 is a table illustrating a data format example of the priority list generated through the processing illustrated in FIG. 43. In the case of the method A in which the mobile terminal 400 employs a processing method of not recognizing the surrounding radio wave condition, the priority of the radio wave condition is left empty. Further, with regard to the communication method (communication method #3 of FIG. 42) for which the mobile terminal 400 itself does not perform the recognition, the priorities (radio wave condition and frequencies) are assigned with no value.

### Operation 5

### Prioritization Based on Terminal Status and User Action Contents

Based on the terminal status 410 and the user action contents 411, the communication-method-and-frequency-band determining unit 409 can determine the priorities to be used in selecting the communication method and frequency band. Detailed procedures are described in the following (1) and (2).

(Procedure (1))

Based on the terminal status 410, the communication-method-and-frequency-band determining unit 409 determines the priorities to be used in selecting the communication method and frequency band, and then writes the priorities into the priority list. On this occasion, with regard to the terminal status (remaining battery level), priorities of the communication methods, which are set in advance for the remaining battery levels, are used.

For example, with regard to the communication methods #1 and #2, the priorities are defined in advance as follows.

(Example 1): communication method #1

Priority (battery)=10: remaining charge of not less than 70%, nor more than 100%

5: remaining charge of not less than 40%, but less than 70%

0: remaining charge of not less than 0%, but less than 40%

(Example 2): communication method #2 (example: a communication method having less battery consumption than the communication method #1)

Priority (battery)=0: remaining charge of not less than 70%, nor more than 100%

5: remaining charge of not less than 40%, but less than 70%

10: remaining charge of not less than 0%, but less than 40%

(Procedure (2))

Next, based on the user action contents 411, the communication-method-and-frequency-band determining unit 409 determines the priorities to be used in selecting the communication method/frequencies, and then writes the priorities into the priority list. With regard to the user action contents (service contents), priorities of the communication methods, which are defined in advance for service contents, are used. Examples of the priorities are as follows.

(Example 1) communication method #1 (example: when a long time service is desired)

Priority (service)=10: available both at present and in the future (predicted value)

0: unavailable in the future

(Example 2) communication method #2 (example: a communication method advantageous for communication on the move)

Priority (service)=0: voice call

5: packet communication

10: mobile communication

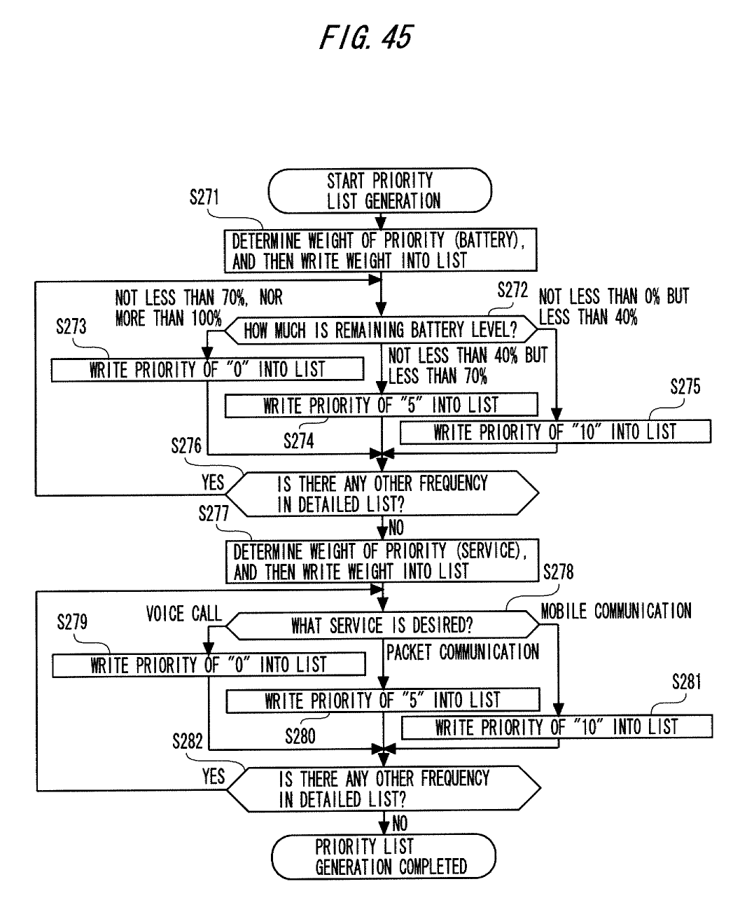

FIG. 45 is a flow chart illustrating a processing example of the priority list generation performed by the communication-method-and-frequency-band determining unit 409 based on the terminal status and the user action contents (service contents).

In the processing example illustrated in FIG. 45, a “method having less battery consumption” is employed with regard to the terminal status (remaining battery level), and a “method advantageous for communication on the move” is employed with regard to the user action contents (service contents).

When the processing of FIG. 45 is started, the communication-method-and-frequency-band determining unit 409 performs processing of determining the weight of the priority (battery) and writing the weight into the list (Step S271). Specifically, the communication-method-and-frequency-band determining unit 409 checks the remaining battery level contained in the terminal status 410 with respect to one of the frequency bands in the detailed list (Step S272).

On this occasion, when the remaining battery level is not less than 70%, nor more than 100%, the communication-method-and-frequency-band determining unit 409 writes the priority of “0” into the priority list (Step S273).

On the other hand, when the remaining battery level is not less than 40%, but less than 70%, the communication-method-and-frequency-band determining unit 409 writes the priority of “5” into the priority list (Step S274).

On the other hand, when the remaining battery level is not less than 0%, but less than 40%, the communication-method-and-frequency-band determining unit 409 writes the priority of “10” into the priority list (Step S275).

Next, when there are other frequency bands in the detailed list (radio wave condition list), the communication-method-and-frequency-band determining unit 409 performs the processing of Steps S272 to S275 for all the other frequency bands (Step S276).

After the writing processing of the priority (battery) is finished, the communication-method-and-frequency-band determining unit 409 performs processing of determining the weight of the priority (service) and writing the weight into the detailed list (Step S277). Specifically, with respect to one of the frequency bands in the detailed list, the communication-method-and-frequency-band determining unit 409 refers to the user action contents 411 to check what service content the user desires to receive (Step S278).

On this occasion, when the service content is the “voice call”, the communication-method-and-frequency-band determining unit 409 writes the priority of “0” into the priority list (Step S279).

On the other hand, when the service content is the “packet communication”, the communication-method-and-frequency-band determining unit 409 writes the priority of “5” into the priority list (Step S280).

On the other hand, when the service content is the “mobile communication”, the communication-method-and-frequency-band determining unit 409 writes the priority of “10” into the priority list (Step S281).

Next, when there are other frequency bands in the detailed list (radio wave condition list), the communication-method-and-frequency-band determining unit 409 performs the processing of Steps S278 to S281 for all the other frequency bands (Step S282). After the writing of the priorities (service) is finished for all the frequency bands, the processing of the priority list generation is finished.

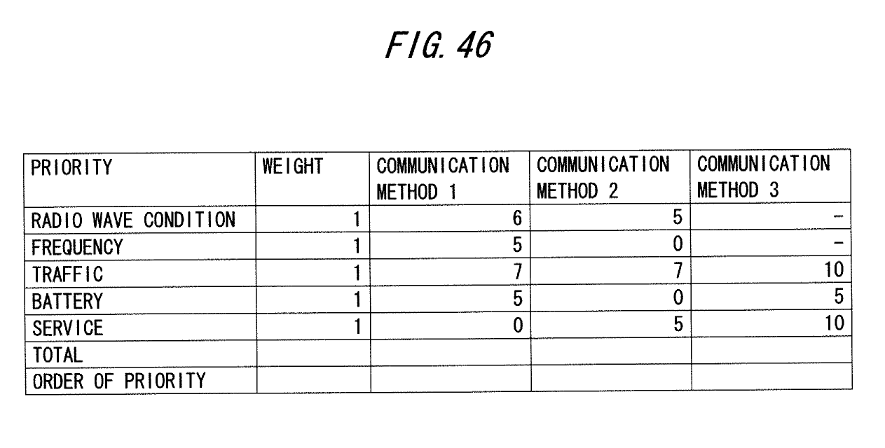

FIG. 46 is a table illustrating a data format example of the priority list that is generated through the operation 5 and contains the priorities set based on the remaining battery levels and the service contents.

### Operation 6

### Determination of Communication Method And the Frequency Band, and Changing of Communication Method

Based on the priority list generated through the operations 1 to 5, the communication-method-and-frequency-band determining unit 409 determines the communication-method-and-frequency-band that are actually to be used for communication. The determined communication-method-and-frequency-band are transmitted to the communication-method-and-frequency-band changing unit 406.

Further, with regard to the change in communication method, the data communication unit 407 is notified of the change. After that, communication is performed with the determined communication-method-and-frequency-band. To give more details, the following procedures (1) to (3) are performed.

(Procedure (1))

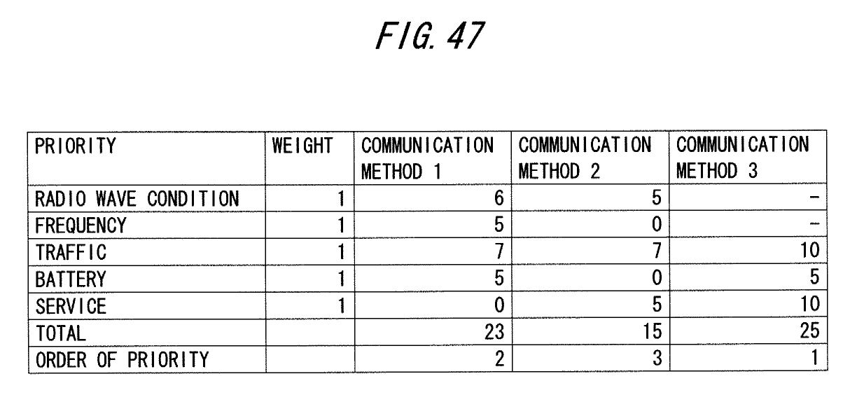

Based on the priority list, the communication-method-and-frequency-band determining unit 409 determines the communication-method-and-frequency-band that are actually to be used for communication. FIG. 47 is a table illustrating a reference example (priority list) for determining the communication-method-and-frequency-band, which is used by the determining unit 409 in the processing of determining the communication-method-and-frequency-band.

Here, in the table of FIG. 47, a weight of “1” is set for all the priorities. The weight may be changed depending on what kind of priority is desired to be prioritized. In the contents of the priority list illustrated in FIG. 47, a communication method to be determined (selected) by the determining unit 409 is the “communication method #3”, which has the largest weight.

(Procedure (2))

The determined communication-method-and-frequency-band are transmitted to the communication-method-and-frequency-band changing unit 406. According to an instruction from the communication-method-and-frequency-band changing unit 406, the radio processing unit 401A changes the frequency band and the allowable radio wave strength based on the determined contents.

(Procedure (3))

The determined communication-method-and-frequency-band are transmitted to the data communication unit 407 to change the communication method, and then a communication becomes ready to be started.

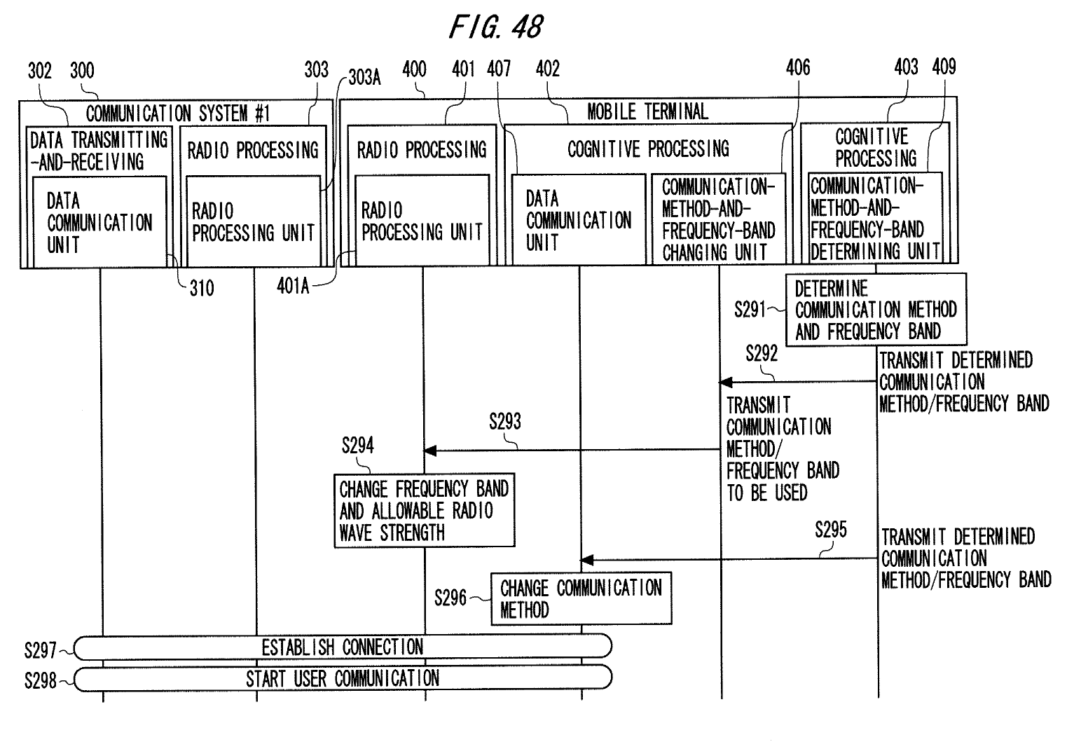

FIG. 48 is a sequence diagram illustrating an operational example related to the operation 6. In FIG. 48, the communication-method-and-frequency-band determining unit 409 of the mobile terminal 400 determines the communication-method-and-frequency-band (Step S291), and then transmits the determined contents (communication method and frequency band) to the communication-method-and-frequency-band changing unit 406 (Step S292).

The communication-method-and-frequency-band changing unit 406 transmits, along with a change instruction based on the determined contents, the determined contents to the radio processing unit 401A (Step S293). The radio processing unit 401A changes, in response to the change instruction, the use frequency band and the allowable radio wave strength based on the determined contents (Step S294).

Further, the communication-method-and-frequency-band determining unit 409 transmits the determined contents of the communication-method-and-frequency-band to the data communication unit 407 (Step S295). Based on the determined contents, the data communication unit 407 changes the communication method to be used by the mobile terminal 400 for communication (Step S296).

After that, a connection for communication is established between the changed communication system 300 (in this example, communication method #1) and the mobile terminal 400 (Step S297), and then, a user communication is started (Step S298).

<Flow of Actual Operation>

Next, description is given of an operational example of an actual operation of the mobile terminal 400. The basic operation has been described in the operations 1 to 6. Hereinbelow, there is described a flow of a case in which the mobile terminal 400 receives a long time service continuously.

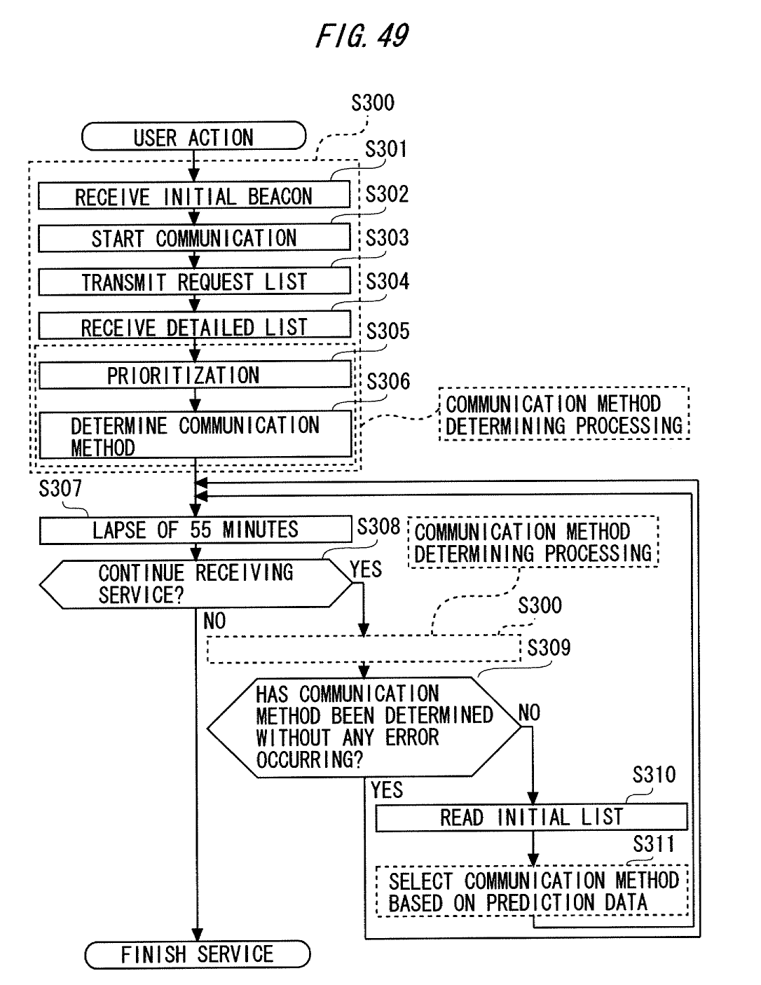

FIG. 49 is a flow chart illustrating a processing example of a case in which the mobile terminal receives a service continuously. In FIG. 49, the mobile terminal 400 performs communication method determining processing (Step S300: operations 1 to 6) including Steps S301 to S306.

In the communication method determining processing (S300), the mobile terminal 400 receives the initial beacon from a given communication system 300 (Step S301: operation 1), and then starts communication with the communication system 300 (Step S302: operation 2).

Next, the mobile terminal 400 transmits the request list toward the cognitive information management unit 200 (Step S303: operation 3), and then receives, via the communication system 300, the detailed list from the cognitive information management unit 200 (Step S304: operation 4).

Next, based on the detailed list, the mobile terminal 400 performs the prioritization (priority setting) for the communication methods available for the mobile terminal 400 (generation of priority list: Step S305: operation 5), and then determines the communication method and the frequency band based on the priority list (Step S306: operation 6). In this manner, a communication is started with the determined communication method and frequency band.

After that, when a specified period of time (for example, 55 minutes) has elapsed after starting the communication (Step S307), the mobile terminal 400 makes a query to the user as to whether or not to continue to receive the service. For example, the mobile terminal 400 displays the query to the display device. On this occasion, in a case where the user does not desire to continue the service (S308: NO), the service is finished when a unit for providing the service (in this example, one hour) is finished. Alternatively, the service may be finished immediately.

On the other hand, in a case where the user desires to continue the service (S308: YES), the mobile terminal 400 performs the communication method determining processing again (Step S300).

After that, in a case where the communication method has been determined without any error occurring (S309: YES), the mobile terminal 400 continues, for a specified period of time, a communication service that uses the newly-determined communication method (the processing proceeds to Step S307).

On the other hand, in a case where an error has occurred in the communication method determining processing (S309: NO), the initial list (data that has been used thus far for determining the communication method) is read again (Step S310), and then, the communication method is determined (selected) based on the prediction data in the detailed list (Step S311).

As described above, after a communication by using the communication method determined in the communication method determining processing is started, when there is a specified period of time (approximately five minutes) left before the unit for providing the service (one hour) elapses, the communication method determining processing is performed again if the user continuously receives the service that uses the communication method.

In a case where no error has occurred in the communication method determining processing performed again, provision of the service can be continued with the communication method that has been newly selected in that determining processing. On the other hand, in a case where an error has occurred, the information that has been used thus far is read again, and then, a communication method is selected based on the prediction data.

[Effects]

With the mobile terminal 400 according to the embodiment, after the initial beacon is received and after a communication is started, the detailed list corresponding to the request list is received from the cognitive information management unit 200, and, based on the contents of the detailed list, it is possible to perform the communication (receive the service) with an optimal communication method and an optimal frequency band.

### Modification Example

In the cognitive information distribution system according to the embodiment, the cognitive information that is utilized in order to realize efficient utilization of radio resources is managed by the cognitive information management unit 200 in an integrated manner, and is distributed from the cognitive information management unit 200 to each of the communication systems 300 and each of the mobile terminals 400. With this configuration, there may occur a case in which, due to an increased processing load on the cognitive information management unit 200 managing the cognitive information, the processing speed of the cognitive information distribution system according to the embodiment described above declines on the whole.

In view of this, in a cognitive information distribution system according to a modification example of this embodiment, the communication systems 300 each cache the cognitive information, and, in response to a request list from the mobile terminal 400, the communication systems 300 each generate a detailed list and return the detailed list. Such a distribution method for the cognitive information according to this modification example is largely classified into two types.

A first distribution type is a method in which the cognitive information management unit 200 detects an update of the cognitive information and voluntarily distributes specified pieces of the updated cognitive information to each of the communication systems 300, to thereby cause each of the communication systems 300 to cache the latest cognitive information. In the first distribution type, the latest cognitive information is always cached in each of the communication systems 300, and hence, in response to a request list from the mobile terminal 400, it is possible to generate and return a detailed list based on the cached cognitive information.

A second distribution type is a method in which the communication system 300 that relays a detailed list in exchanging the request list and the detailed list as in the embodiment described above caches the cognitive information based on the detailed list. In the second distribution type, the communication system 300 that has received the request list from the mobile terminal 400 needs to judge whether or not the cognitive information cached in its own device is the latest information, and transfers, when it is judged that the cognitive information is not the latest, the request list to the cognitive information management unit 200 or another communication system 300.

Hereinbelow, description is given of the cognitive information distribution system as the modification example of the embodiment for the respective distribution types of the cognitive information distribution system.

[System Configuration]

The system configuration of the cognitive information distribution system according to this modification example is the same as that of this embodiment described above. Accordingly, as in this embodiment described above, the cognitive information distribution system according to this modification example has the system configuration illustrated in FIG. 2.

Further, the cognitive information distribution system of this modification example is different from that of this embodiment described above in the function of the communication systems 300 that control the respective communication methods and in part of the function of the cognitive information management unit 200. In the second distribution type, there is a difference only in the function of the communication systems 300. Hereinbelow, description is given, for each distribution type, of the respective nodes having different functions from those of this embodiment described above. Description of the same function as in the embodiment described above is omitted.

<Cognitive Information Management Unit>

The processing configuration of the cognitive information management unit 200 is the same as that of this embodiment described above, which is illustrated in FIG. 3. In the case of the first distribution type according to this modification example, the process of the detailed list generating unit 205 is different from that of the embodiment described above. In the case of the second distribution type, it is only desired that the detailed list generating unit 205 have the same function as in the embodiment described above. Specifically, when the detailed list generating unit 205 according to the second distribution type has received, from the mobile terminal 400, a request list (see FIG. 28) desired for determining the communication method, the detailed list generating unit 205 generates a detailed list (see FIG. 29) corresponding to the contents of the request list based on the cognitive information table 210, and then transmits the detailed list to at least one of the communication systems #1 to #n via the IF-for-other-communication-method 203. Hereinbelow, description is given of the detailed list generating unit 205 according to the first distribution type of this modification example. Here, in the case of the first distribution type of this modification example, the detailed list generating unit 205 detects that the cognitive information table 210 has been generated or updated by the cognitive information table generating unit 209, and then transmits the cognitive information that has been changed with this update to each of the communication systems 300 via the IF-for-other-communication-method 203. On this occasion, the detection of update of the cognitive information table 210 may be implemented by notification from the cognitive information table generating unit 209.

The cognitive information to be transmitted to each of the communication systems 300 may be information regarding only the communication method (communication method 1, 2, or the like) corresponding to each of the communication systems 300, or alternatively, may be the entire information including the communication methods of the other communication systems. Further, among the information stored in the cognitive information table 210, information regarding specified fields alone may be transmitted. In this case, in the example illustrated in FIG. 20, for example, only the time, the frequency band, and the fault information may be transmitted. Further, in a case where only time information (measurement time and prediction time) is changed when compared with the previous generation, only the time information may be transmitted to each of the communication systems 300. Further, the distribution of the cognitive information from the cognitive information management unit 200 to each of the communication systems 300 may be performed by using the same format as the detailed list, or alternatively, may be performed by using a new message format.

<Communication Method (Communication System)>

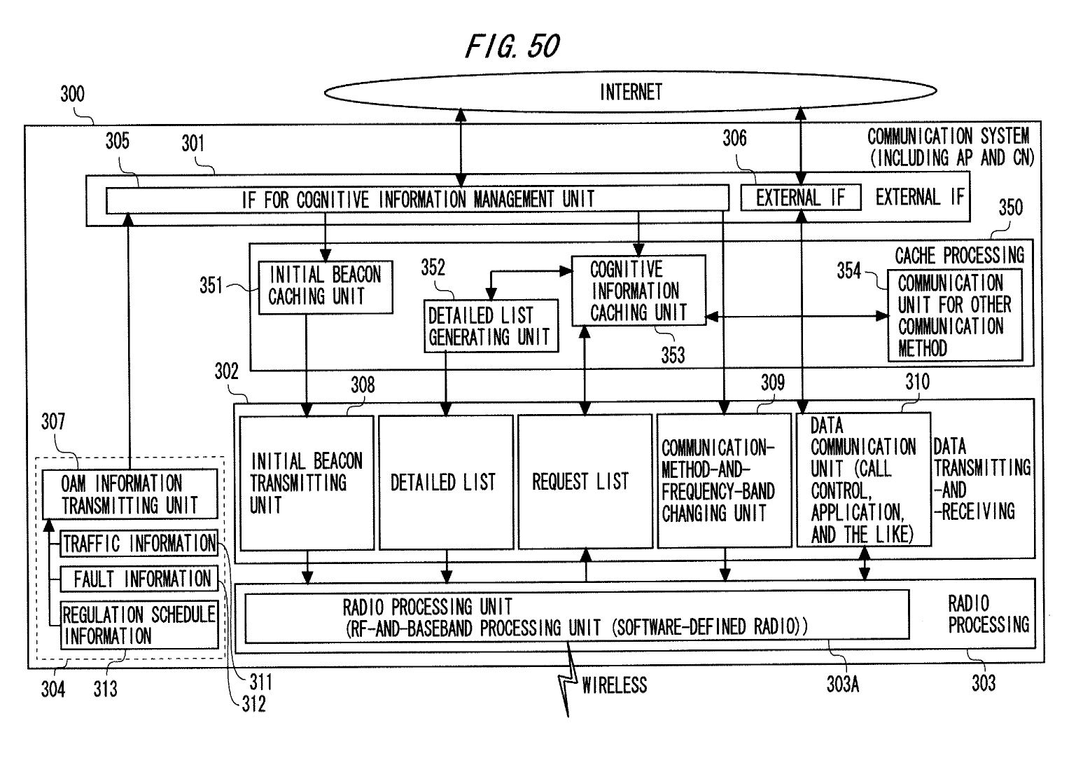

Hereinbelow, with reference to FIG. 50, description is given of the process of the cognitive information distribution system of this modification example. FIG. 50 is a diagram illustrating a processing block configuration example of each of the communication systems 300 (#1 to #n) according to the modification example. The communication system 300 functions as a device provided with a cache processing section 350 in addition to the external IF section 301, the data-transmitting-and-receiving section 302, the radio processing section 303, and the OAM section 304, which are described in the embodiment described above. The other processing units (sections) excluding the data-transmitting-and-receiving section 302 and the cache processing section 350 are the same as those of the embodiment described above, and hence description thereof is herein omitted.

In this embodiment described above, when a request list transmitted from the mobile terminal 400 has been received by the radio processing unit 303A, the data-transmitting-and-receiving section 302 transfers the request list to the IF unit 301, and, when a detailed list transmitted from the cognitive information management unit 200 has been received by the IF unit 301, the data-transmitting-and-receiving section 302 passes through the detailed list to the radio processing unit 303A.

When the data-transmitting-and-receiving section 302 according to this modification example has received, via the radio processing unit 303A, a request list transmitted from the mobile terminal 400, the data-transmitting-and-receiving section 302 transfers the request list to the cache processing section 350. On the other hand, the data-transmitting-and-receiving section 302 receives a detailed list serving as a response to the request list from the cache processing section 350, and then transfers the detailed list to the radio processing unit 303A. Further, the initial beacon transmitting unit 308 of the data-transmitting-and-receiving section 302 receives the initial beacon information from the cache processing section 350, and then transfers the initial beacon information to the radio processing unit 303A. The processing configuration of the data-transmitting-and-receiving section 302 is the same as that of the embodiment described above.

As illustrated in FIG. 50, the cache processing section 350 includes an initial beacon caching unit 351, a detailed list generating unit 352, a cognitive information caching unit 353, and a communication-unit-for-other-communication-method 354. Here, the communication-unit-for-other-communication-method 354 is undesired in a case where each of the communication systems 300 also caches the cognitive information regarding another communication system.

The cognitive information caching unit 353 caches specified information of the information stored in the cognitive information table 210 of the cognitive information management unit 200. The cognitive information caching unit 353 may perform caching with the use of a table having the same schema as that of the cognitive information table 210 (see FIG. 20). The cognitive information table 210 illustrated in FIG. 20 contains information with regard to each of the generation time (measured) and the time of prediction. However, the cognitive information caching unit 353 may perform caching in such a manner as to add information of a new generation time while keeping the previous information to some extent as well, or alternatively, may cache only the latest information by always performing overwriting update.

In the case of the first distribution type, the cognitive information caching unit 353 receives, via the IF-for-cognitive-information-management-unit 305, the cognitive information that is transmitted with an update of the cognitive information table 210 as a trigger, and then caches the received cognitive information. In the case of the first distribution type, the cognitive information cached in the cognitive information caching unit 353 is always the latest information. Accordingly, when the cognitive information caching unit 353 has received a request list from the radio processing unit 303A, the cognitive information caching unit 353 transmits the request list to the detailed list generating unit 352.

In a case where the cognitive information regarding another communication system (communication method) is not cached in the respective communication systems 300, the cognitive information caching unit 353 performs the following processing. Specifically, when the cognitive information caching unit 353 has received a request list from the data-transmitting-and-receiving section 302, the cognitive information caching unit 353 judges whether or not information regarding another communication method is contained in the desired parameters (see FIG. 28) contained in the request list. When it is judged that information regarding another communication method is contained, the cognitive information caching unit 353 transmits the request list to the communication-unit-for-other-communication-method 354. Subsequently, after receiving a detailed list serving as a response to the request list from the communication-unit-for-other-communication-method 354, the cognitive information caching unit 353 transmits the detailed list to the detailed list generating unit 352. Further, when the cognitive information caching unit 353 has received a request list from the communication-unit-for-other-communication-method 354, the cognitive information caching unit 353 transmits the request list to the detailed list generating unit 352 because the request list contains a request for information regarding its own communication method. When the cognitive information caching unit 353 has received a detailed list serving as a response to the request list from the detailed list generating unit 352, the cognitive information caching unit 353 transfers the detailed list to the communication-unit-for-other-communication-method 354.

In the case of the second distribution type, the cognitive information caching unit 353 receives a detailed list transmitted from the cognitive information management unit 200 or another communication system 300 via the IF-for-cognitive-information-management-unit 305 or the communication-unit-for-other-communication-method 354, and then caches the cognitive information contained in the detailed list thus received.

In the case of the second distribution type, when the cognitive information caching unit 353 has received a request list from the data-transmitting-and-receiving section 302, the cognitive information caching unit 353 judges whether or not the cognitive information that corresponds to the desired parameters (see FIG. 28) contained in the request list is cached, and whether or not the cached cognitive information is the latest. When it is judged that the latest cognitive information corresponding to the desired parameters contained in the request list is cached, the cognitive information caching unit 353 transfers the request list to the detailed list generating unit 352.

On the other hand, when it is judged that the latest cognitive information corresponding to the desired parameters contained in the request list is not cached, the cognitive information caching unit 353 transmits the request list to the communication-unit-for-other-communication-method 354 in a case where the desired parameters contain information regarding another communication method. When the cognitive information caching unit 353 has received a detailed list serving as a response to the request list from the communication-unit-for-other-communication-method 354, the cognitive information caching unit 353 newly caches the cognitive information contained in the detailed list, and also transmits the detailed list to the detailed list generating unit 352.

Further, when it is judged that the latest cognitive information corresponding to the desired parameters contained in the request list is not cached, and that the desired parameters contain information regarding its own communication method, the cognitive information caching unit 353 transmits the request list to the IF-for-cognitive-information-management-unit 305. When the cognitive information caching unit 353 has received a detailed list serving as a response to the request list from the IF-for-cognitive-information-management-unit 305, the cognitive information caching unit 353 newly caches the cognitive information contained in the detailed list, and also transmits the detailed list to the detailed list generating unit 352.

Here, for the judgment as to whether or not the cached information is the latest, any method may be employed. For example, the judgment as to whether or not the cognitive information is the latest may be made by previously storing an update interval used for the cognitive information table 210 of the cognitive information management unit 200 and making a comparison between the generation date/time of the currently-cached cognitive information and the update interval. Alternatively, only a notification indicating that the cognitive information table 210 has been updated may be received from the cognitive information management unit 200 to judge whether or not the cognitive information is the latest depending on the notification.

When a request list has been received from the communication-unit-for-other-communication-method 354, too, the cognitive information caching unit 353 operates in the same manner as in the case where a request list is received from the data-transmitting-and-receiving section 302, which has been described above. In this case, the cognitive information caching unit 353 receives a detailed list serving as a response to the request list from the detailed list generating unit 352, and then transfers the detailed list to the communication-unit-for-other-communication-method 354.

The communication-unit-for-other-communication-method 354 exchanges the request list and the detailed list with another communication system 300. As described above, when the communication-unit-for-other-communication-method 354 has received, from the cognitive information caching unit 353, a request list transmitted from the mobile terminal 400 toward its own communication system 300, because the request list contains a parameter for making a request for information regarding another communication method, the communication-unit-for-other-communication-method 354 transmits the request list toward a communication system corresponding to the request parameter. On the other hand, when the communication-unit-for-other-communication-method 354 has received a request list from another communication system 300, the communication-unit-for-other-communication-method 354 transmits the request list to the cognitive information caching unit 353, and then receives a detailed list serving as a response thereto from the cognitive information caching unit 353. The communication-unit-for-other-communication-method 354 returns the detailed list to a communication system that is the transmission source of the request list.

The detailed list generating unit 352 receives a request list from the cognitive information caching unit 353, and then generates a detailed list that is to serve as a response to the request list based on the information cached in the cognitive information caching unit 353. The method of generating a detailed list is the same as that of the detailed list generating unit 205 of the cognitive information management unit 200 according to the embodiment described above, and hence description thereof is herein omitted. When the detailed list generating unit 352 has generated a detailed list that is to serve as a response to a request list transmitted toward its own system, the detailed list generating unit 352 transmits the detailed list to the data-transmitting-and-receiving section 302. On the other hand, when the detailed list generating unit 352 has generated a detailed list that is to serve as a response to a request list transferred from another communication system, the detailed list generating unit 352 transmits the detailed list to the communication-unit-for-other-communication-method 354 via the cognitive information caching unit 353.

The initial beacon caching unit 351 receives, via the IF-for-cognitive-information-management-unit 305, the initial beacon information generated and transmitted by the initial beacon generating unit 204 of the cognitive information management unit 200. The initial beacon caching unit 351 caches the received initial beacon information. The initial beacon caching unit 351 transmits the cached initial beacon information to the initial beacon transmitting unit 308 at a specified timing. The subsequent processing of the initial beacon transmitting unit 308 is the same as in the embodiment described above.

### Operational Example

Next, description is given of operation of the cognitive information distribution system according to the modification example of this embodiment for the case of the first distribution type and the case of the second distribution type. The operation of the mobile terminal 400 is the same as in this embodiment described above, and hence, hereinbelow, description is given of operation related to the cognitive information management unit 200 and the communication system 300 on the network side.

<Case of First Distribution Type>

In the cognitive information distribution system according to this embodiment described above, the operation is classified into the following five operations as an operational example on the network side.

(Operation 1) Generation and Transmission of Information for Generating a Cognitive Information Table

(Operation 2) Generation of a Cognitive Information Table

(Operation 3) Transmission of the Initial Beacon

(Operation 4) Changing of the Frequency Band and the Like Based on the Communication-Method-and-Frequency-Band Change Information

(Operation 5) Provision of the Detailed List to the Mobile Terminal.

In the case of the first distribution type according to this modification example, among those operations 1 to 5, the “operation 5” is different from that of the embodiment described above, and an “operation 6” described below is newly added.

(Operation 6) Distribution of Updated Cognitive Information

Hereinbelow, description is given of details of the operations 5 and 6 performed in the case of the first distribution type.

<<Operation 6: Distribution of Updated Cognitive Information>>

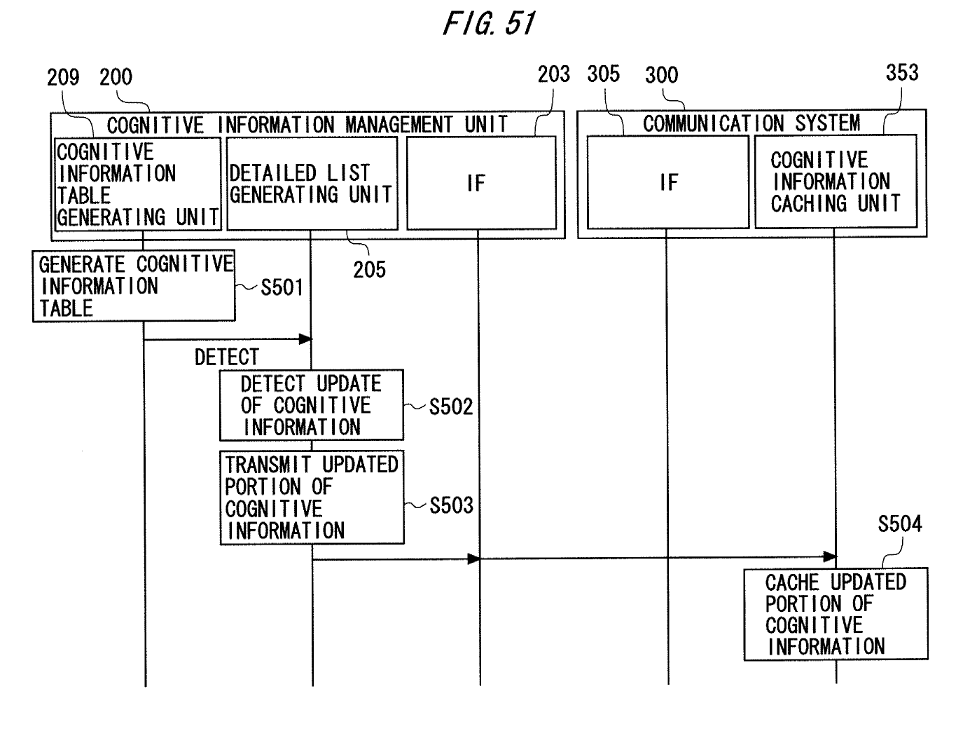

First, with reference to FIG. 51, description is given of the “operation 6” performed in the case of the first distribution type. FIG. 51 is a sequence diagram illustrating the “operation 6” of the cognitive information distribution system according to the first distribution type of this modification example.

In the first distribution type, when the cognitive information table 210 has been generated or updated by the cognitive information table generating unit 209 (S501), the detailed list generating unit 205 of the cognitive information management unit 200 detects this (S502). This detection may be implemented by utilizing notification from the cognitive information table generating unit 209 or by previously holding the update interval of the cognitive information table 210.

The detailed list generating unit 205 extracts, from the cognitive information table 210, the cognitive information changed by the update, and then transmits the updated cognitive information to each of the communication systems 300 (S503). The detailed list generating unit 205 may transmit the entire information (entire data in the cognitive information table 210) of the updated cognitive information to each of the communication systems 300, or alternatively, may transmit, to each of the communication systems 300, only the cognitive information that corresponds to the communication method thereof.

The communication systems 300 each receive the updated cognitive information transmitted from the cognitive information management unit 200 by using the IF-for-cognitive-information-management-unit 305. The cognitive information caching unit 353 receives the updated cognitive information from the IF-for-cognitive-information-management-unit 305, and then caches the cognitive information (S504). This enables each of the communication systems 300 to cache at least the latest information of the cognitive information regarding its own communication method.

<<Operation 5: Provision of Detailed List to Mobile Terminal>>

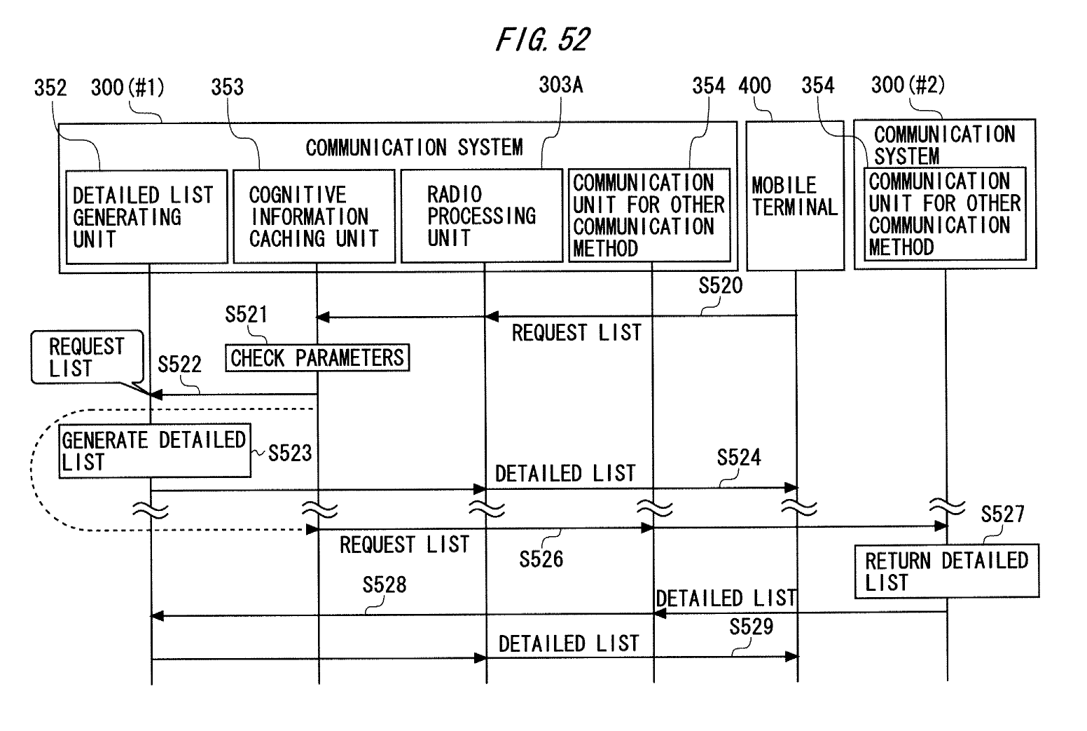

Next, with reference to FIG. 52, description is given of the “operation 5” performed in the first distribution type of this modification example. FIG. 52 is a sequence diagram illustrating the “operation 5” of the cognitive information distribution system according to the first distribution type of this modification example. Here, in FIG. 52, there are illustrated, as an example, the communication system 300 (#1) and the communication system 300 (#2) among the plurality of communication systems 300.

When a request for a detailed list has occurred in the mobile terminal 400, a request list is transmitted from the request list generating unit 408 to the communication system 300 (#1) with which wireless communication is established (S520). As illustrated in the example of FIG. 28, the request list contains the communication method, the frequency band, the traffic information, the fault information, the regulation information, the area information, and the like as parameters desired to be contained in a detailed list to be returned.

The radio processing unit 303A of the communication system 300 (#1) receives the request list, and then transmits the request list to the cognitive information caching unit 353. The cognitive information caching unit 353 checks the parameters contained in the request list (S521). When the communication method requested by a parameter contained in the request list is an own communication method, the cognitive information caching unit 353 transmits the request list to the detailed list generating unit 352 (S522).

The detailed list generating unit 352 acquires, from the cache of the cognitive information caching unit 353, information requested by the parameters contained in the request list, and then generates a detailed list (S523). The detailed list generating unit 352 transmits the detailed list to the mobile terminal 400 via the radio processing unit 303A (S524). In this manner, according to the first distribution type, the latest information is cached for the cognitive information regarding the own communication method in each of the communication systems 300, and hence a detailed list can be generated based on the latest cognitive information in each of the communication systems 300.

Here, in a case where communication methods requested by the parameters contained in the request list includes another communication method and only the cognitive information regarding the own communication method is cached, the cognitive information caching unit 353 transmits the request list to the communication-unit-for-other-communication-method 354 (S526). Based on the communication method requested by the parameter contained in the request list, the communication-unit-for-other-communication-method 354 transmits the request list to the communication system 300 (#2) controlling that communication method (S526).

Upon reception of the request list, the communication-unit-for-other-communication-method 354 of the communication system 300 (#2) causes the detailed list generating unit 352 of the own communication system 300 (#2) to generate a detailed list in the same manner as described above, and then returns the detailed list to the communication system 300 (#1), which is the transfer source of the request list (S527). The communication system 300 (#1) receives the detailed list by using the communication-unit-for-other-communication-method 354. When the detailed list generating unit 352 has received the detailed list from the communication-unit-for-other-communication-method 354 (S528), the detailed list generating unit 352 transmits the detailed list to the mobile terminal 400 via the radio processing unit 303A (S529).

Even in a case where each of the communication systems 300 caches the cognitive information regarding the own communication method as described above, according to this modification example, it is possible to acquire desired information from another communication system 300 without increasing the load on the cognitive information management unit 200.

<Case of Second Distribution Type>

In the case of the second distribution type according to this modification example, among the operations (operations 1 to 5), which are classified in this embodiment described above, the “operation 5” is different from that of the embodiment described above. Hereinbelow, description is given of details of “operation 5” performed in the case of the second distribution type.

<<Operation 5: Provision of Detailed List to Mobile Terminal>>

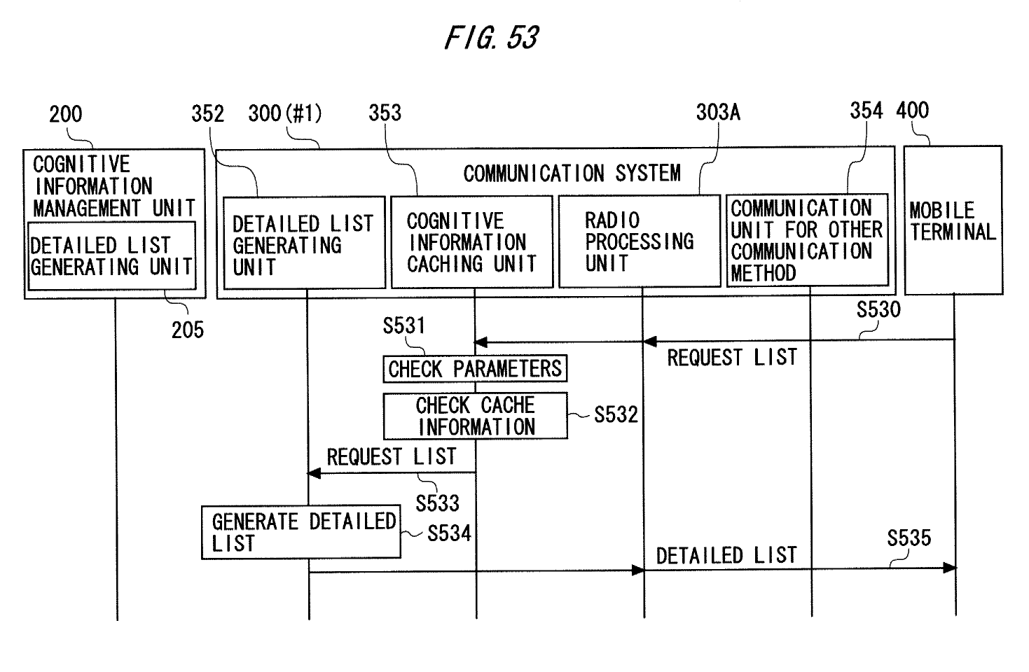

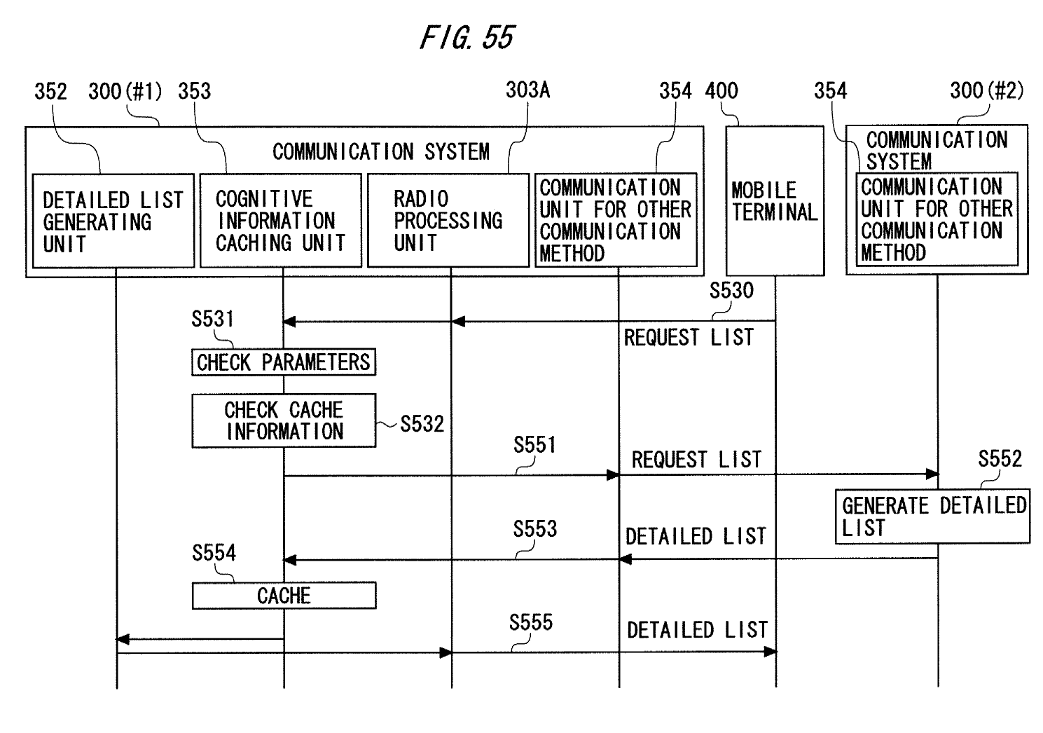

Next, with reference to FIGS. 53 to 55, description is given of the “operation 5” performed in the second distribution type of the modification example. FIGS. 53 to 55 are sequence diagrams each illustrating the “operation 5” of the cognitive information distribution system according to the second distribution type of this modification example. Here, in FIG. 55, there are illustrated the communication system 300 (#1) and the communication system 300 (#2) among the plurality of communication systems 300.

First, with reference to FIG. 53, description is given of the “operation 5” performed in the second distribution type of the modification example. When a request for a detailed list has occurred in the mobile terminal 400, a request list is transmitted from the request list generating unit 408 to the communication system 300 (#1) with which wireless communication is established (S530).

The radio processing unit 303A of the communication system 300 (#1) receives the request list, and then transmits the request list to the cognitive information caching unit 353. The cognitive information caching unit 353 checks the parameters contained in the request list (S531). First, the cognitive information caching unit 353 checks whether or not the own communication method is set in a communication method field of the parameters contained in the request list. When the own communication method is set in a communication method parameter of the request list, the cognitive information caching unit 353 further checks whether or not the latest information is cached for the information requested by the other parameters contained in the request list (S532).

Specifically, for example, in a case where a time at which the request list has been received is earlier than a time obtained by adding the update interval of the cognitive information of the cognitive information management unit 200, which is held in the communication system 300 (#1), to the generation time or measurement time (see FIG. 20) of the cached cognitive information, it is judged that the cached information is the latest. In another example, in a case where an update flag, which is set when a notification indicating an update of the cognitive information is received from the cognitive information management unit 200, is not set when the request list has been received, it is judged that the cached information is the latest.

When the cognitive information caching unit 353 has judged that the communication method parameters of the request list contain the own communication method and that the cached information is the latest information, the cognitive information caching unit 353 transmits the request list to the detailed list generating unit 352 (S533).

The detailed list generating unit 352 acquires, from the cache of the cognitive information caching unit 353, information requested by the parameters contained in the request list, and then generates a detailed list (S534). The detailed list generating unit 352 transmits the detailed list to the mobile terminal 400 via the radio processing unit 303A (S534). In this manner, according to the second distribution type, in a case where the latest information is cached in each of the communication systems 300 for the cognitive information requested by the mobile terminal 400, each of the communication systems 300 can generate a detailed list based on the latest cognitive information and return the detailed list instead of the cognitive information management unit 200.

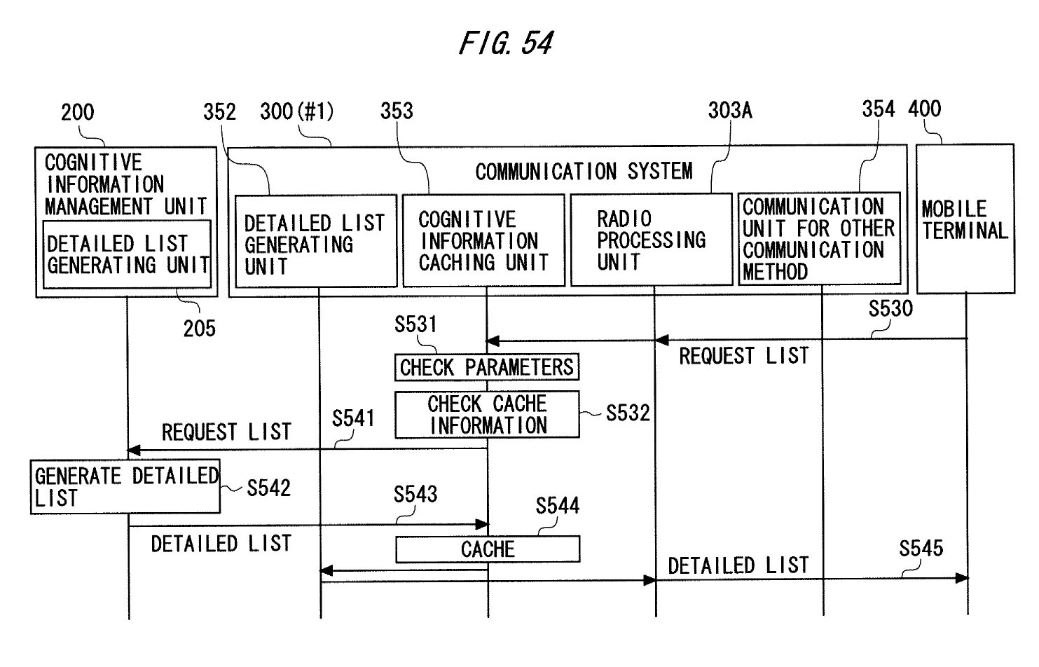

FIG. 54 illustrates operation performed in a case where it is judged, in Step S532 of the operational sequence of FIG. 53 described above, that the latest information is not cached for the cognitive information requested by the request list.

When it is judged by the cognitive information caching unit 353 of the communication system 300 (#1) that the latest information is not cached for the information requested by the other parameters contained in the request list (S532), the cognitive information caching unit 353 transmits the request list to the cognitive information management unit 200 (S541).

In the cognitive information management unit 200, the detailed list generating unit 205 receives the request list via the IF-for-other-communication-method 203. In response to the request list, the detailed list generating unit 205 generates a detailed list based on the cognitive information table 210 by using the same method as in this embodiment described above (S542). The detailed list generating unit 205 transmits the detailed list thus generated to the communication system 300 (#1) (S543).

The cognitive information caching unit 353 of the communication system 300 (#1) caches the cognitive information contained in the detailed list thus received (S544). Accordingly, at this point, the latest information is cached for the cognitive information contained in the detailed list in the communication system 300 (#1). The cognitive information caching unit 353 transmits the detailed list to the detailed list generating unit 352. The detailed list generating unit 352 transmits the detailed list thus received without any change to the mobile terminal 400 via the radio processing unit 303A (S545).

In this manner, according to the second distribution type, only when the cognitive information cached in the communication system 300 is not the latest, the request list is transferred to the cognitive information management unit 200. With this configuration, according to the second distribution type, it is possible to reduce the frequency of access to the cognitive information management unit 200.

FIG. 55 illustrates operation performed in a case where it is judged, in Step S531 of the operational sequence of FIG. 53 described above, that the communication method parameters of the request list contain another communication method.

In a case where it is judged by the cognitive information caching unit 353 of the communication system 300 (#1) that the communication method parameters of the request list contain another communication method (S531) and that the latest information is not cached for the cognitive information requested by the request list (S532), the cognitive information caching unit 353 transmits the request list to the communication-unit-for-other-communication-method 354. Here, in a case where each of the communication systems 300 caches only the cognitive information regarding the own communication method, the cognitive information caching unit 353 may transmit the request list to the communication-unit-for-other-communication-method 354 without executing Step S532. The communication-unit-for-other-communication-method 354 transmits the request list to the communication system 300 (#2) controlling a communication method that is set in the communication method parameters contained in the request list (S551).

Upon reception of the request list, similarly to the above, the communication-unit-for-other-communication-method 354 of the communication system 300 (#2) causes the detailed list generating unit 352 of the own communication system 300 (#2) to generate a detailed list (S552). The detailed list thus generated is returned to the communication system 300 (#1), which is the transfer source of the request list (S553).

The communication system 300 (#1) receives the detailed list by using the communication-unit-for-other-communication-method 354. The communication-unit-for-other-communication-method 354 transmits the detailed list to the cognitive information caching unit 353. The cognitive information caching unit 353 receives the detailed list from the communication-unit-for-other-communication-method 354, and then caches the cognitive information contained in the detailed list (S554). The cognitive information caching unit 353 transmits the detailed list to the detailed list generating unit 352. Here, in the case where each of the communication systems 300 caches only the cognitive information regarding the own communication method, the cognitive information caching unit 353 may transmit the detailed list to the detailed list generating unit 352 without executing Step S554.

The detailed list generating unit 352 transmits the detailed list transmitted from the cognitive information caching unit 353 to the mobile terminal 400 via the radio processing unit 303A (S555).

In this manner, according to the second distribution type of the modification example, even in a case where the cognitive information regarding another communication method is requested by a request list, it is possible for the own system to return a detailed list if the latest cognitive information satisfying the request is cached. Further, even in a case where the cognitive information regarding another communication method is requested by the request list and the latest cognitive information satisfying the request is not cached, it is possible to acquire desired information from another communication system 300 and return the detailed list without increasing the load on the cognitive information management unit 200.

### Operation and Effect of Modification Example

In the cognitive information distribution system of the modification example of this embodiment, part or all of the cognitive information managed by the cognitive information table 210 of the cognitive information management unit 200 in an integrated manner is cached in the cognitive information caching unit 353 of each of the communication systems 300.

In each of the communication systems 300, when a request (request list) for a detailed list desired for determining the communication method has been received from the mobile terminal 400, the detailed list generating unit 352 generates a detailed list requested by the request list based on the cognitive information cached in the cognitive information caching unit 353, and then, the detailed list is transmitted to the mobile terminal 400, which is the request source.

According to this modification example described above, compared to the configuration of this embodiment in which the cognitive information management unit 200 generates and returns a detailed list for every request list, it is possible to reduce the load on the cognitive information management unit 200. In addition, it is also possible to reduce traffic between the cognitive information management unit 200 and the respective communication systems 300. Therefore, while providing service that enables efficient frequency utilization among a plurality of communication methods, it is also possible to improve the processing speed (throughput) of the entire cognitive information distribution system that provides such service.

Further, in the modification example of this embodiment, there are utilized the first distribution type and the second distribution type as a method of distributing the cognitive information from the cognitive information management unit 200 to each of the communication systems 300, in other words, as a way to cache the cognitive information in each of the communication systems 300.

According to the first distribution type, the cognitive information management unit 200 detects an update of the cognitive information and voluntarily distributes specified pieces of the updated cognitive information to each of the communication systems 300. Therefore, each of the communication systems 300 always caches the latest cognitive information.

Specifically, according to the first distribution type, at least in the case where each of the communication system 300 has received a response of a request list from the mobile terminal 400 with regard to the own communication method, it is possible to generate a detailed list based on the cognitive information cached in the own communication system. With this configuration, only when the cognitive information table 210 of the cognitive information management unit 200 has been updated, it is possible to suppress the traffic between the cognitive information management unit 200 and the respective communication systems 300.

According to the second distribution type, each of the communication systems 300, which relays a detailed list in exchanging the request list and the detailed list between the cognitive information management unit 200 and the mobile terminal 400, caches the cognitive information contained in the detailed list. In the second distribution type, the cognitive information cached in the communication system 300 is not always the latest, and hence the cognitive information caching unit 353 judges whether or not the latest information is cached for the cognitive information requested by the request list. When it is judged that the latest information is cached for the cognitive information requested by the request list, a detailed list is generated and returned by the communication system 300. On the other hand, when the latest information is not cached for the cognitive information requested by the request list, the request list is transferred without any change from the communication system 300 to the cognitive information management unit 200, and then, a detailed list based on the latest cognitive information is returned from the cognitive information management unit 200. The communication system 300 caches the cognitive information contained in the detailed list transmitted from the cognitive information management unit 200, and also, the detailed list is transmitted to the mobile terminal 400, which is the request source.

Specifically, according to the second distribution type, in a case where there exists a communication system 300 unlikely to be required to connect to the mobile terminal 400 requiring a detailed list, unnecessary traffic does not occur between the cognitive information management unit 200 and that communication system 300. Therefore, it is possible to optimize the traffic as the entire cognitive information distribution system.

Further, in this modification example, such a configuration may be employed, in which each of the communication systems 300 does not cache the cognitive information regarding another communication method. In this case, in the communication system 300, when a request list regarding another communication method has been received, the communication-unit-for-other-communication-method 354 transfers the request list to another communication system 300. Then, the communication system 300 transmits, to the mobile terminal 400, a detailed list transmitted from the another communication system 300.

With this configuration, it is possible to reduce the amount of data of the cognitive information to be cached in each of the communication systems 300, and, in addition, the return of a detailed list in response to a request list can be implemented through the exchange among the communication systems 300. Therefore, it is possible to reduce the traffic between the cognitive information management unit 200 and the respective communication systems 300.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment has been described in detail, it should be understood that the various changes, substitutions, and alterations could be made hereto without departing from the spirit and scope of the invention.

1-12. (canceled)

13. A communication system that performs wireless communication with a mobile terminal by using at least one of a plurality of communication methods having a range in which available frequency bands overlap and that is connected, via a network, to an information distribution apparatus including a database generating unit to generate a database storing communication environment information regarding each of the plurality of communication methods and a distribution unit to distribute information included in the communication environment information, the communication system comprising:
a hold unit to hold the information included in the communication environment information, which is distributed from the distribution unit of the information distribution apparatus;
a first judgment unit to judge, when information distribution request from the mobile terminal is received, whether or not the information distribution request requests information regarding another communication method that is not used by the communication system itself among the plurality of communication methods;
a first transfer unit to transfer, when the first judgment unit judges that the information distribution request requests the information regarding the another communication method that is not used by the communication system itself, the information distribution request to another communication system that uses the another communication method;
a distribution information generating unit to generate distribution information corresponding to the information distribution request received from the mobile terminal based on the information held by the hold unit; and
an information transmitting unit to transmit, to the mobile terminal, the distribution information that is generated by the distribution information generating unit or that is received from the another communication system in response to the information distribution request transferred by the first transfer unit.

14. The communication system according to claim 13, further comprising:
a second judgment unit to judge whether or not the hold unit holds the information corresponding to the information distribution request received from the mobile terminal; and
a second transfer unit to transfer the information distribution request to the information distribution apparatus when the second judgment unit judges that the hold unit does not hold the information corresponding to the information distribution request, wherein:
the hold unit holds, when receiving, from the information distribution apparatus, distribution information being generated by extracting from the communication environment information stored in the database of the information distribution apparatus in response to the information distribution request transferred by the second transfer unit, information included in the distribution information; and
the information transmitting unit transmits, to the mobile terminal, the distribution information that is generated by the distribution information generating unit, that is received from the another communication system in response to the information distribution request transferred by the first transfer unit, or that is received from the information distribution apparatus in response to the information distribution request transferred by the second transfer unit.

15. The communication system according to claim 14, wherein:
the second judgment unit judges whether or not the information corresponding to the information distribution request among the information held by the hold unit is older than the information included in the communication environment information stored in the database of the information distribution apparatus; and
the second transfer unit transfers the information distribution request to the information distribution apparatus when it is judged by the second judgment unit that the information corresponding to the information distribution request is older than the information included in the communication environment information stored in the database of the information distribution apparatus.

16. (canceled)

17. The communication system according to claim 14, wherein
the hold unit holds, when receiving, from the another communication system, distribution information being generated based on the information included in the communication environment information which is distributed from the distribution unit of the information distribution apparatus in response to the information distribution request transferred by the first transfer unit, information included in the distribution information.

18. An information distribution method executed by an information processing apparatus that performs wireless communication with a mobile terminal by using at least one of a plurality of communication methods having a range in which available frequency bands overlap and that is connected, via a network, to an information distribution apparatus including a database generating unit to generate a database storing therein communication environment information regarding each of the plurality of communication methods and a distribution unit to distribute information included in the communication environment information, the information distribution method comprising:
holding in a hold unit the information included in the communication environment information, which is distributed from the distribution unit of the information distribution apparatus;
judging, when information distribution request from the mobile terminal is received, whether or not the information distribution request requests information regarding another communication method that is not used by the information processing apparatus itself among the plurality of communication methods;
transferring, when it is judged that the information distribution request requests the information regarding the another communication method that is not used by the information processing apparatus itself, the information distribution request to another information processing apparatus that uses the another communication method;
generating distribution information corresponding to the information distribution request received from the mobile terminal based on the information held in the hold unit; and
transmitting, to the mobile terminal, the generated distribution information or the distribution information that is received from the another communication system in response to the transferred information distribution request.
